(19) United States
(12) Patent Application Publication
(10) Pub. No.: US 2014/0098028 A1
(43) Pub. Date: Apr. 10, 2014

(54) FLEXIBLE APPARATUS AND CONTROL METHOD THEREOF

(71) Applicant: SAMSUNG ELECTRONICS CO., LTD., Suwon-si (KR)

(72) Inventors: Ji-yeon KWAK, Seoul (KR); Kyung-a KANG, Seoul (KR); Joon-kyu SEO, Suwon-si (KR); Sang-keun JUNG, Suwon-si (KR); Geun-ho LEE, Seongnam-si (KR)

(73) Assignee: SAMSUNG ELECTRONICS CO., LTD., Suwon-si (KR)

(21) Appl. No.: 13/646,331

(22) Filed: Oct. 5, 2012

(30) Foreign Application Priority Data
Oct. 4, 2012 (KR) 10-2012-0110339

(51) Int. Cl. G06F 3/041; G09G 5/00

(52) U.S. Cl. 345/173; 345/156

(57) ABSTRACT

A flexible apparatus is provided, which includes a display unit including displays a screen, a detecting unit which detects a user's input comprising a stretching of the display unit, and a control unit which controls the display unit so that an operation corresponding to the user's input is performed.

### CROSS-REFERENCE TO RELATED APPLICATIONS

This application claims priority from Korean Patent Application No. 10-2012-0110339, filed on Oct. 4, 2012, in the Korean Intellectual Property Office, the disclosure of which is incorporated herein by reference in its entirety.

### BACKGROUND

1. Field

Apparatuses and control methods consistent with exemplary embodiments relate to a flexible apparatus and a control method thereof, and more particularly, to a flexible apparatus capable of changing form thereof and a control method thereof.

2. Description of the Related Art

Newer types of electronic apparatuses are developed everyday thanks to advancements in the field of electronics. The display industry has witnessed the particularly wide distribution of the apparatuses so that display apparatuses, including televisions (TVs), personal computers (PCs), laptop computers, tablet PCs, mobile phones, and MP3 players, are used in almost every household.

In addition, to meet user needs for newer and more various functions, efforts are continuously made to develop newer types of electronic apparatuses. The “next-generation display” has been introduced according to these efforts. For example, a flexible apparatus has been introduced as a type of next-generation display. A flexible apparatus is a type of electronic apparatus which a user can change a shape of like one could with a paper sheet.

Along with the development of various types of flexible apparatuses, it has also became necessary to provide various types of input means.

### SUMMARY

One or more exemplary embodiments may overcome the above disadvantages and other disadvantages not described above. Also, any given exemplary embodiment is not required to overcome the disadvantages described above, and an exemplary embodiment may not overcome any of the problems described above.

One or more exemplary embodiments may provide a flexible apparatus which performs operations according to a user's input which the flexible apparatus perceives as an input means, and a control method thereof.

According to an aspect of an exemplary embodiment, a flexible apparatus may include a display unit including a screen, a detecting unit which detects a user's input comprising a stretching of the display unit, and a control unit which controls the display unit so that an operation corresponding to the user's input is performed, when the user's input is detected.

The detecting unit detects a user's gripping with respect to the flexible apparatus and a user's touch with respect to the display unit, and the control unit determines that a single stretching manipulation is made, when the user's gripping is detected in one area and a touch area formed on the display unit due to the user's gripping is moved.

The detecting unit may include a plurality of strain gauges disposed on an edge area of the flexible apparatus, and the control unit determines that a single stretching manipulation is made, if a tension is detected at one of the plurality of strain sensors.

If the single stretching manipulation is made, the control unit moves one or more objects displayed on the screen in a direction in which the single stretching manipulation was made to remove the one or more objects from the screen, and moves one or more new objects onto the screen from an area from which the one or more objects were removed in the direction in which the single stretching manipulation was made and displays the one or more new objects on the screen.

The detecting unit detects user's gripping with respect to the flexible apparatus and a user's touch with respect to the display unit, and the control unit determines that an overall stretching manipulation is made, if locations of a plurality of touch areas formed on the display unit gradually move away from each other in opposite directions.

The detecting unit may include a plurality of strain gauges disposed on an edge area of the flexible apparatus, and the control unit determines that an overall stretching manipulation is made, if a tension is detected by at least two of the plurality of strain gauges.

The control unit changes a mode of the screen if the overall stretching manipulation is made.

The control unit changes a display form of an object displayed on the screen if the overall stretching manipulation is made.

The control unit enlarges one or more objects displayed on the screen based on a preset ratio, if the overall stretching manipulation is made.

When the overall stretching manipulation is made, the control unit divides one or more objects displayed on the screen into a first half and a second half according to the direction in which the overall stretching manipulation is made, gradually spaces the first half and the second half from each other until the first half and the second half disappear off opposite sides of the screen, and displays one or more new objects in an area formed between the first half and the second half. According to an aspect of another exemplary embodiment, a control method of a flexible apparatus having a display unit may include detecting a user's input which comprises stretching the display unit, and performing an operation corresponding to the user's input.

The detecting may include detecting a user's gripping with respect to the flexible apparatus and a user's touch with respect to the display unit, and determining that a single stretching manipulation is made, if the user's gripping is detected at one area and a touch area formed on the display unit due to the user's gripping is moved.

The detecting may include determining that an overall stretching manipulation is made, if a tension is detected at one of a plurality of strain gauges disposed on an edge area of the flexible apparatus.

The performing may include, when the single stretching manipulation is made, moving one or more objects displayed on the screen in a direction in which the single stretching manipulation is made, removing the one or more objects off a first side of the screen, moving one or more new objects onto the from a second side of the screen, moving the one or more new objects in the direction in which the single stretching manipulation is made and displaying the one or more new objects on the screen.

The detecting may include detecting a user's gripping with respect to the flexible apparatus and a user's touch with respect to the display unit, and determining that an overall stretching manipulation is made, when a plurality of locations of a plurality of touch areas formed on the display unit due to the user's gripping are gradually moved apart from each other in opposite directions.

The detecting may include determining that an overall stretching manipulation is made, when a tension is detected at a plurality of strain gauges disposed on an edge area of the flexible apparatus.

The performing may include changing a mode of the screen when the overall stretching manipulation is made.

The performing may include changing a display form of an object displayed on the screen when the overall stretching manipulation is made.

The performing may include enlarging one or more objects displayed on the screen based on a preset ratio, when the overall stretching manipulation is made.

When the overall stretching manipulation is made, the performing may include dividing one or more objects displayed on the screen into a first half and a second half according to a the direction in which the overall stretching manipulation is made, and gradually moving the first half and the second half away from each other until the first half and the second half disappearing off opposite sides of the screen, and displaying one or more new objects on an area formed between the first half and the second half.

Thus, according to one or more exemplary embodiments, user convenience may be improved by enabling the user to control various operations of the flexible apparatus with various user manipulations.

### BRIEF DESCRIPTION OF THE DRAWINGS

The above and/or other exemplary aspects and advantages will be more apparent by the following description of certain exemplary embodiments with reference to the accompanying drawings, in which:

FIG. 1 is a block diagram of a flexible apparatus according to an exemplary embodiment;

FIG. 2 is a view provided to explain basic structure of a display unit of a flexible apparatus according to an exemplary embodiment;

FIGS. 3A-3D are views provided to explain arrangements of bend sensors according to exemplary embodiments;

FIGS. 4A-4C are views provided to explain a method for detecting a direction of bending using bend sensors which overlap each other according to an exemplary embodiment;

FIGS. 5 to 8 are views provided to explain a method for detecting stretching manipulation according to an exemplary embodiment;

FIGS. 9 and 10 are views provided to explain a method for determining a stretching manipulation according to an exemplary embodiment;

FIGS. 11 and 12 are views provided to explain a method for detecting a stretching manipulation according to an exemplary embodiment;

FIGS. 13 to 25 are views provided to explain an operation performed in response to an overall pulling gesture according to an exemplary embodiment;

FIGS. 26 and 27 are views provided to explain an operation performed in response to a single stretching manipulation according to an exemplary embodiment;

FIG. 28 is a detailed block diagram of a flexible apparatus according to an exemplary embodiment;

FIG. 29 is a view provided to explain a hierarchy of software stored at a storage unit according to an exemplary embodiment;

FIG. 30 is a flowchart provided to explain a control method of a flexible apparatus having a display unit according to an exemplary embodiment;

FIGS. 31A-31C illustrate constructions of flexible apparatuses according to one or more exemplary embodiments;

FIGS. 32A-32D, 33A-33C, 34A-34D, and 35A-35C are views provided to explain methods for detecting user manipulations input into a flexible apparatus according to one or more exemplary embodiments;

FIGS. 36 to 42 are views provided to explain an operation performed at a display apparatus in response to a user's manipulation according to an exemplary embodiment;

FIG. 43 is a view illustrating a constitution of a flexible apparatus operating in association with an external display apparatus according to another exemplary embodiment;

FIG. 44 is a view provided to explain an operation method of a flexible apparatus according to an exemplary embodiment;

FIG. 45 is a view provided to explain an implementation of a flexible apparatus according to an exemplary embodiment;

FIG. 46 is a view provided to explain an implementation of a flexible apparatus according to an exemplary embodiment; and

FIG. 47 is a flowchart provided to explain a control method of a flexible apparatus according to an exemplary embodiment.

### DETAILED DESCRIPTION OF EXEMPLARY EMBODIMENTS

Certain exemplary embodiments will now be described in greater detail with reference to the accompanying drawings.

In the following description, same drawing reference numerals are used for the same elements even in different drawings. The matters defined in the description, such as detailed construction and elements, are provided to assist in a comprehensive understanding of the present inventive concept. Accordingly, it is apparent that the exemplary embodiments can be carried out without those specifically defined matters. Also, well-known functions or constructions are not described in detail since they would obscure the invention with unnecessary detail.

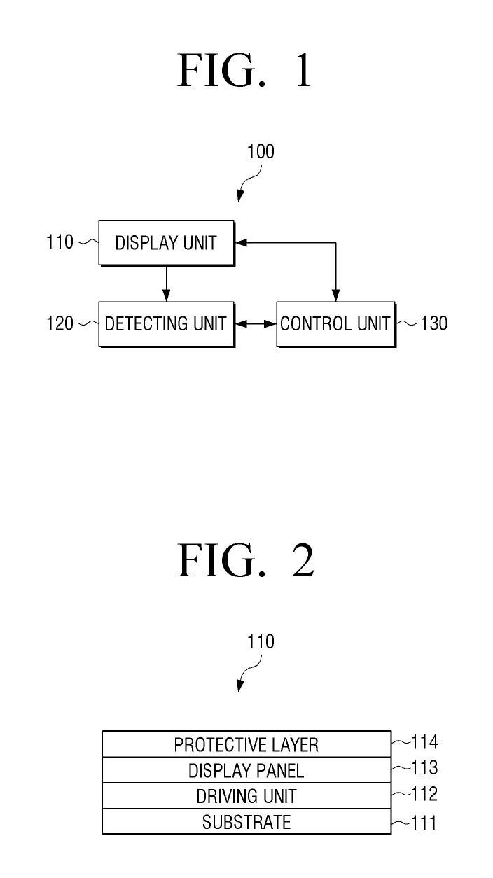

FIG. 1 is a block diagram of a flexible apparatus according to an exemplary embodiment. Referring to FIG. 1, the flexible apparatus 100 may include a display unit 110, a detecting unit 120 and a control unit 130.

The flexible apparatus 100 of FIG. 1 may be implemented in various types of portable apparatuses such as, for example, a mobile phone including a smartphone, a portable media player (PMP), a personal digital assistant (PDA), a tablet PC, or a global positioning system (GPS) apparatus. Further, the flexible apparatus 100 may be implemented as a stationary apparatus such as a monitor, a TV, or a kiosk, as well as a portable apparatus.

The display unit 110 displays a screen image. The flexible apparatus 100, including the display unit 110, is bendable. Accordingly, the display unit 110 is formed into a structure and also formed from a material that allows such bending. The detailed construction of the display unit 110 will be explained below with reference to FIG. 2.

FIG. 2 is a view provided to explain a basic structure of the display unit of the flexible apparatus according to an exemplary embodiment. Referring to FIG. 2, the display unit 110 may include a substrate 111, a driving unit 112, a display panel 113 and a protective layer 114.

The flexible apparatus 100 may be an apparatus which is bendable, foldable, and/or rollable, like a paper sheet. Depending on needs, the flexible apparatus 100 may maintain the display characteristics of a conventional flat display apparatus. Accordingly, the flexible apparatus 100 is formed on a flexible substrate.

To be specific, the substrate 111 may be plastic board (e.g., polymer film) which can vary its form by external pressure—i.e. which is flexible.

The plastic board has a structure in which a barrier coating is applied on both surfaces of a base film. The base film may be formed from any of various resins including, for example, polymide (PI), polycarbnite (PC), polyethyleneterephthalate (PET), polyethersulfone (PES), polyethylenenaphthalate (PEN), and fiber reinforced plastic (FRP). The barrier coating may be formed on opposite surfaces of the base film, and the barrier film may be an organic or inorganic layer, which enables the substrate as a whole to maintain the flexibility of the base film.

Meanwhile, the substrate 111 may be formed from a flexible material other than plastic board such as, for example, thin glass or metal foil.

The driving unit 112 operates to drive the display panel 113. To be specific, the driving unit 112 applies a driving voltage to a plurality of pixels of the display panel 113, and may be implemented as a silicon (Si) thin-film transistor (TFT), a low temperature poly silicon (LTPS) TFT, or an organic TFT (OTFT). The driving unit 112 may be implemented in any of various forms depending on the desired implementation of the display panel 113. By way of example, the display panel 113 may include an organic light emitting element including a plurality of pixel cells, and electrode layers coated on both surfaces of the organic light emitting element. The driving unit 112 may include a plurality of transistors corresponding to the respective pixel cells of the display panel 113. The control unit 130 applies an electric signal to a gate of each transistor to illuminate the pixel cell connected to the transistor. As a result, an image is displayed.

In addition to the organic light emitting diode, the display panel 113 may be implemented as an electroluminescent (EL) device, an electrophoretic display (EPD), an electrochromic display (ECD), a liquid crystal display (LCD), an active matrix LCD (AMLCD), or a plasma display panel (PDP). Herein, if an LCD is implemented, a separate backlight is used in consideration of the fact that the LCD cannot illuminate itself. If the backlight is not used, ambient light is used for the display of the LCD. Accordingly, in order to use an LCD display panel 113 without a backlight, the optimum conditions would be an outdoor environment or the like in which there is high luminosity.

The protective layer 114 operates to protect the display panel 113. By way of example, the protective layer 114 may include one or more materials such as ZrO, CeO2, or ThO₂. The protective layer 114 may be made into a transparent film to cover the entirety of the surface of the display panel 113.

Meanwhile, referring to FIG. 2, the display unit 110 may be implemented in the form of an electronic paper sheet. The e-paper sheet may be a display that incorporates traits of standard ink and is distinct from a typical flat display in terms of the fact that it uses reflective light. Meanwhile, the e-paper sheet may change a picture or text by using electrophoresis using twist ball or capsules.

Meanwhile, if the display unit 110 is formed from a transparent material, the flexible apparatus 100 may be implemented as a display apparatus which is bendable and which is transparent. For example, the substrate 111 may be formed from a polymer such as a transparent plastic, the driving unit 112 may be implemented as a transparent transistor, and the display panel 113 may be implemented as a transparent organic light emitting layer and transparent electrodes. As a result, the flexible apparatus 100 may be transparent.

The term “transparent transistor” as used herein may refer to a transistor in which a non-transparent silicon of an existent thin layer transistor is replaced by a transparent material such as zinc oxide, titanium oxide, or the like. Further, a transparent electrode may use a new material such as indium tin oxide or graphene. The term “graphene” as used herein refers to a material in which carbon atoms are linked to each other into a transparent, honeycomb-like planar structure. Additionally, the transparent organic light emitting layer may be formed from any of various materials.

As explained above, the display unit 110 may be formed from a flexible material to be able to bend into varied forms due to an externally-exerted force.

Meanwhile, the detecting unit 120 detects (or, senses) a bending of the display unit 110. As used herein, the term “bending” refers to a state in which the display unit 110 is bent. To this end, the detecting unit 120 may include one or more bend sensors arranged on one surface of the display unit 110 such as a front surface or a rear surface, or may include one or more bend sensors arranged on both surfaces of the display unit 110.

As used herein, the term “bend sensor” refers to a sensor which itself is bendable, and which has varying resistance values depending on a degree of bending. The bend sensor may be implemented in various forms such as, for example, an optical fiber bending sensor, a pressure sensor, or a strain gauge.

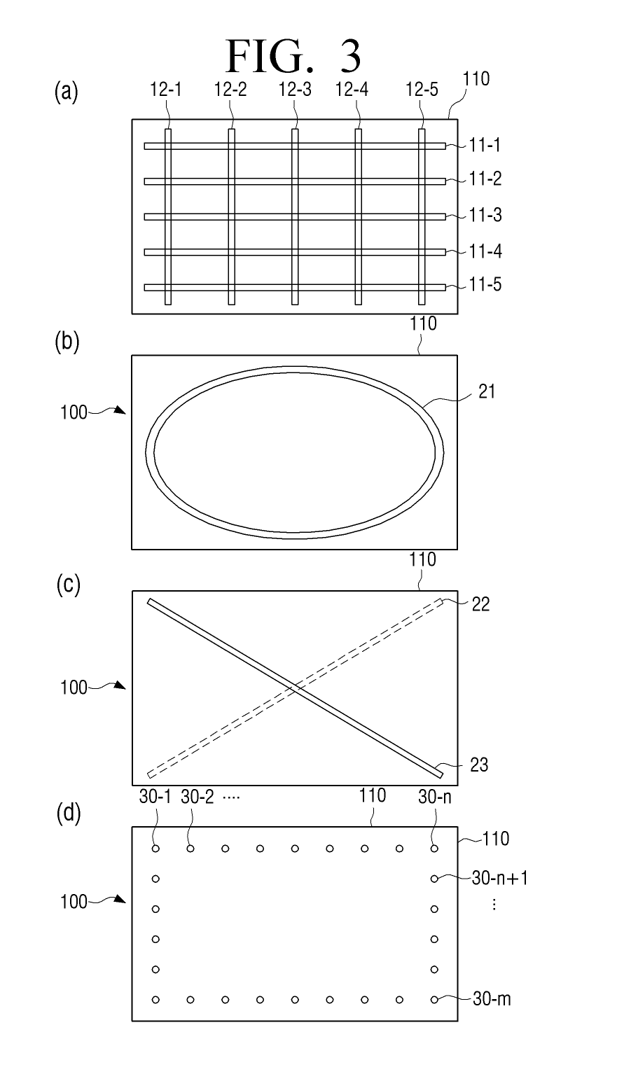

FIG. 3 is a view provided to explain an arrangement of bend sensors according to an exemplary embodiment.

FIG. 3A illustrates an example of a plurality of bar-shaped bend sensors arranged in a grid pattern in the display unit 110 in horizontal and vertical directions.

To be specific, the bend sensors may include bend sensors 11-1 to 11-5 arranged parallel to a first direction, and bend sensors 12-1 to 12-5 arranged parallel to a second direction which is perpendicular to the first direction. The respective bend sensors may be spaced from each other at predetermined intervals.

The arrangement of five bend sensors 11-1 to 11-5 and five bend sensors 12-1 to 12-5 in horizontal and vertical directions, as illustrated in FIG. 3A, is merely exemplary, and therefore, the number of the bend sensors and the length thereof may be varied depending on the size of the display unit 110. Additionally, the horizontal and vertical arrangement of the bend sensors is to enable the sensors to sense bending that may occur over the entire area of the display unit 110. Accordingly, if the display unit 110 is only partially flexible or requires the detection of bending in only a limited portion of the display unit 110, the bend sensors may be arranged in the corresponding portion only.

Further, in one exemplary embodiment illustrated in FIG. 3A, the bend sensors may be disposed on a front surface of the display unit 110. However, other examples are possible. For example, the bend sensors may be disposed on a rear surface of the display unit 110 or on both the front and rear surfaces of the flexible apparatus 100.

The shape, number and location of the bend sensors are variable. By way of example, one or more bend sensors may be connected to the display unit 110. One bend sensor may detect one bending data, or alternatively, may have a plurality of sensing channels to detect a plurality of bending data.

FIG. 3B particularly illustrates an example of an arrangement of a single bend sensor on one surface of the display unit 110. Referring to FIG. 3B, the bend sensor 21 is arranged in a circular pattern and may be disposed on the front surface of the display unit 110. However, various other examples are possible. For example, the bend sensor 21 may be disposed on a rear surface of the display unit 110, or in a closed loop having a polygonal shape such as a rectangle, or the like.

FIG. 3C illustrates an example in which two bend sensors are arranged to cross each other. Referring to FIG. 3C, a first bend sensor 22 may be arranged in a first diagonal direction on the first surface of the display unit 110, and the second bend sensor 23 may be arranged in a second diagonal direction on a second surface of the display unit 110.

In some exemplary embodiments, the bend sensors may be implemented in a line form. However, according to another exemplary embodiment, the detecting unit 120 may detect bending using a plurality of strain gauges.

FIG. 3D illustrates a plurality of strain gauges arranged on the display unit 110. A strain gauge detects deformation of the surface of a targeted object for measurement based on variation in resistance, using metal or a semiconductor material which has a resistance which varies depending on the force exerted thereon. Generally, a material like metal increases in resistance when it is extended in length under an externally-exerted force, and decreases in resistance when it is reduced in length. Accordingly, the strain gauge detects a bending of the display unit 110 based on detection of a variation in the resistance of the material of the strain gauge.

Meanwhile, referring to FIG. 3D, a plurality of strain gauges may be arranged on an edge of the display unit 110. The number of strain gauges may vary depending on the size or shape of the flexible apparatus 100.

Hereinbelow, a method will be explained of the detecting unit 120 detecting a bending of the display unit 110 using bend sensors or strain gauges arranged in a lattice pattern.

Each of the bend sensors may be an electroresistive sensor which utilizes an electric resistance, or a micro optical fiber sensor which utilizes a strain of optical fiber. For convenience of explanation, an exemplary embodiment will be explained below with reference to an example in which an electroresistive sensor is used as the bend sensor.

When the display unit 110 bends, the bend sensor(s) detect the bending on one or both surfaces of the display unit 110, according to which the bend sensor outputs a resistance value corresponding to the level of tension. That is, when an externally-exerted force causes the bend sensor to extend, the bend sensor outputs a resistance value that corresponds to the degree of extension.

Accordingly, the detecting unit 120 may determine a resistance value of the bend sensor using the voltage applied to the bend sensor, or an electric current flowing through the bend sensor, and may detect the bending of the display unit 110 using the resistance value output from the bend sensor. That is, the detecting unit 120 may detect that the display unit 110 is bent if the bend sensor outputs a resistance value other than that output when the display unit 110 is in its original state.

For example, referring to FIG. 3A, when the display unit 110 bends in a horizontal direction, the bend sensors 11-1 to 11-5 arranged parallel to the horizontal direction of the display unit 110 also bend, thereby outputting resistance values corresponding to the level of tension exerted thereto. Accordingly, the detecting unit 120 may detect that the display unit 110 is being bent in a horizontal direction when the bend sensors 11-1 to 11-5 output resistance values other than those of their original state. Similarly, the detecting unit 120 may detect a bending of the display unit 110 in a vertical perpendicular direction through the bend sensors 12-1 to 12-5 arranged parallel to the vertical direction, in the same manner as that used to detect the bending in horizontal direction. Furthermore, when the display unit 110 bends in diagonal direction, tension is applied to the bend sensors in both the horizontal and vertical directions, and therefore, it is also possible to detect the bending of the display unit 110 in the diagonal direction.

Additionally, the detecting unit 120 may detect bending of the display unit 110 through the use of strain gauges.

To be specific, when the display unit 110 bends, force is exerted to strain gauges disposed on the edge area of the display unit 110, and accordingly, the strain gauges output different resistance values depending on the force exerted thereto. Accordingly, based on the output values of the strain gauges, the detecting unit 120 may detect whether the display unit 110 is bent or not. To be specific, if the strain gauges output resistance values other than those of their original state, the detecting unit 120 may detect that the display unit 110 is being bent.

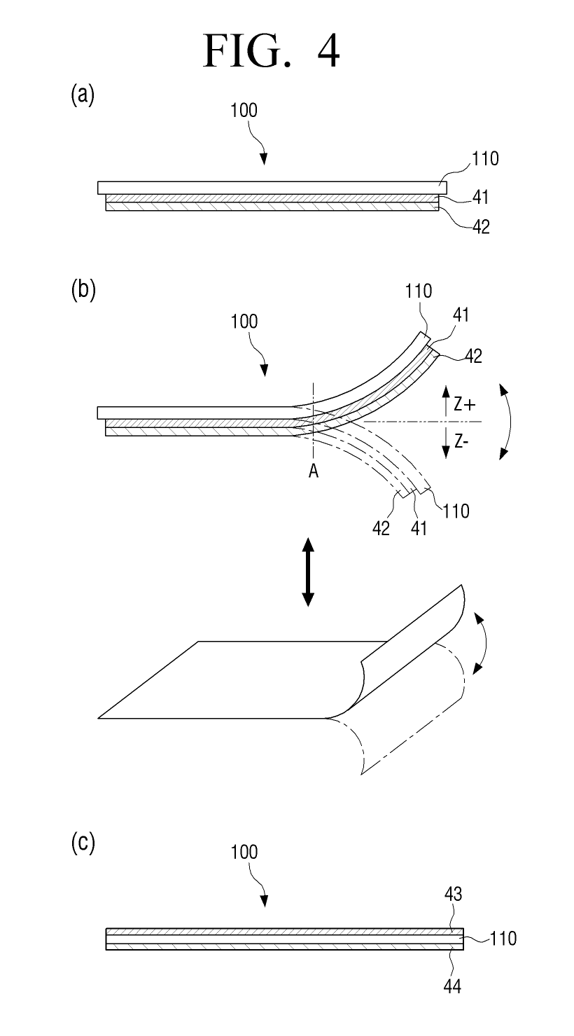

The bending of the display unit 110 may be categorized into Z+ and Z− directions, and the detecting unit 120 may detect the direction of bending of the display unit 110 in various manners. This will be explained in greater detail below with reference to FIG. 4.

FIGS. 4A-4C are views provided to explain a method for detecting a bending direction using overlapped bend sensors according to an exemplary embodiment.

The detecting unit 120 may detect the bending direction of the display unit 110. To this end, the detecting unit 120 may include a bend sensor.

For example, referring to FIG. 4A, the detecting unit 120 may include two bend sensors 41, 42, which overlap each other on one side of the display unit 110. Accordingly, when the display unit 110 bends in one direction, different resistance values are detected by an upper bend sensor 41 and a lower bend sensor 42 at the point of bending. As a result, by comparing the resistance values of the two bend sensors 41, 42 at the same point, the bending direction may be determined.

To be specific, if a right area (or left area) of the display unit 110 is bent in the z+ direction (see the solid line illustrated in FIG. 4B), at point A which corresponds to the bending line, a larger tension is exerted on the bend sensor 42 than that exerted on the bend sensor 41 located thereabove. On the contrary, if a right area (or left area) of the display unit 110 is bent in the z− direction (see the dotted line illustrated in FIG. 4B), a larger tension is exerted on the bend sensor 41 than on the bend sensor 42 located therebelow.

Accordingly, by comparing the resistance values corresponding to point A at the two bend sensors 41, 42, the detecting unit 120 may detect the bending direction. That is, with respect to the same point, if the resistance value output from the lower bend sensor is greater than the resistance value output from the upper bend sensor, the detecting unit 120 may detect that the display unit 110 is bent in the z+ direction. Alternatively, the detecting unit 120 may detect that the display unit 110 is bent in the z− direction, if the resistance value output from the upper bend sensor is greater than the resistance value output from the lower bend sensor located at the same point as the upper bend sensor.

Meanwhile, the aforementioned example assumes that a left or right side of the display unit 110 is bent. However, the detecting unit 120 may also detect a bending direction of the display unit 110 when a central area of the display unit 110 is bent. For example, if a resistance value output from the upper bend sensor is greater than a resistance value output from the lower bend sensor at a same point, the detecting unit 120 may detect that a central portion of the display unit 110 is bent convexly in z+ direction. On the contrary, if a resistance value output from the lower bend sensor is greater than a resistance value output from the upper bend sensor at a same point, the detecting unit 120 may detect that a central portion of the display unit 110 is bent convexly in z− direction.

Meanwhile, referring to FIGS. 4A and 4B, two bend sensors overlap each other and are both disposed on the same side of the display unit 110. Alternatively, the detecting unit 120 may include bend sensors disposed on opposite surfaces of the display unit 110 (FIG. 4C).

FIG. 4C illustrates an example in which two bend sensors 43, 44 are disposed on opposite surfaces of the display unit 110.

Referring to FIG. 4C, depending on the bending direction of the display unit 110, the bend sensor 43, arranged on a first surface of the display unit 110, and the bend sensor 44, arranged on a second surface of the display unit 110, output different resistance values from each other at the same point. To be specific, when a right area or left area of the display unit 110 bends in the z− direction, at a point corresponding to the bending line, stronger tension is applied to the bend sensor 43 on the first surface, while when a right area or left area of the display unit 110 bends in z+ direction, at the point corresponding to the bending line, stronger tension is applied to the bend sensor 44 on the second surface.

Accordingly, by comparing the resistance values of the two bend sensors 43, 44 corresponding to the same point, the detecting unit 120 may detect the bending direction of the right area or left area of the display unit 110. For example, if the resistance value output from the bend sensor 44 built in on the rear surface of the display unit 110 is larger than the resistance value output from the bend sensor 43 built in on the front surface of the display unit 110, the detecting unit 120 may detect that the right area or left area of the display unit 110 bends in the z+ direction. Further, if the resistance value output from the bend sensor 43 built in on the front surface of the display unit 110 is larger than the resistance value output from the bend sensor 44 built in on the rear surface of the display unit 110, the detecting unit 120 may detect that the right area or left area of the display unit 110 bends in the z− direction.

Meanwhile, the aforementioned example assumes that a left or right side of the display unit 110 is bent. However, the detecting unit 120 may also detect a bending direction of the display unit 110 when a central area of the display unit 110 is bent. For example, in a case where the central area of the display unit 110 is bent, if the resistance value output from the bend sensor built in on the front surface of the display unit 110 is greater than the resistance value output from the bend sensor built in on the rear surface of the display unit 110, at the same point, the detecting unit 120 may detect that the central area of the display unit 110 is bent convexly in z+ direction. Likewise, in a case where the central area of the display unit 110 is bent, if the resistance value output from the bend sensor built in on the rear surface of the display unit 110 is greater than the resistance value output from the bend sensor built in on the front surface of the display unit 110, at the same point, the detecting unit 120 may detect that the central area of the display unit 110 is bent convexly in z− direction.

As explained above, values detected by the two bend sensors vary depending on the bending direction, and the detecting unit 120 may thereby distinguish the bending direction according to the detected values.

Meanwhile, referring to FIGS. 4A to 4C, the bending direction may be detected using two bend sensors. However, in another exemplary embodiment, the bending direction may also be distinguished using strain gauges disposed on one or more surfaces of the display unit 110. For example, if a resistance value different from that of the original state is output from a strain gauge disposed on the front surface of the display unit 110, the detecting unit 120 may detect that the display unit 110 bends in the z+ direction. If a resistance value different from that of the original state is output from a strain gauge disposed on the rear surface of the display unit 110, the detecting unit 120 may determine that the display unit 110 bends in the z− direction. However, the above examples are written only for illustrative purposes, and other examples are also possible. For example, one or more strain gauges may be disposed on only surface of the display unit 110 to detect bending in both the z+ and the z− directions.

Further, the detecting unit 120 may detect the bending direction of the display unit 110 in a manner other than those explained above. By way of example, the detecting unit 120 may include an acceleration sensor, a gyro sensor, or a terrestrial magnetism sensor arranged on an edge area of the display unit 110, and may determine the bending direction of the display unit 110 based on a result of sensing made by one or more of the respective sensors.

For example, one or more acceleration sensors may be arranged on each edge of the display unit 110. An acceleration sensor operates to measure an acceleration and a direction of acceleration. To be specific, an acceleration sensor outputs a sensing value that corresponds to and acceleration of gravity which varies depending on a slope of the apparatus to which the sensor is attached.

Accordingly, acceleration sensors arranged on different edges of the display unit 110 output different values when the display unit 110 bends. Accordingly, the detecting unit 120 may detect the bending direction by using output values sensed at by respective acceleration sensors.

Meanwhile, the detecting unit 120 may determine a bending angle of the display unit 110.

To this end, the flexible apparatus 100 may store, in advance, predetermined resistance values output from various bend sensors or strain gauges at each of a plurality of bending angles angle. Accordingly, by comparing a resistance value output from a bend sensor or a strain gauge during the bending of the display unit 110 with the previously stored resistance values, the detecting unit 120 may determine the bending angle matching the detected resistance value.

Meanwhile, because the flexible apparatus 100 bends when the display unit 110 bends, detecting bending of the display unit 110 can be considered as detecting bending of the flexible apparatus 100. Further, if various sensors are provided to the flexible apparatus 100 to detect a change in the form of the display unit 110, the detecting unit 120 may determine the bending of the flexible apparatus 100 in the same manner as explained above with reference to FIGS. 3A-3D and 4A-4C. This will not be repeatedly explained below for the sake of brevity.

As aforementioned, the detecting unit 120 may detect bending of the display unit 110 according to one or more various methods. The aforementioned configuration of the sensors and sensing method may separately be applied to the flexible display apparatus 100, or may be combined with one another and then applied thereto. In the aforementioned exemplary embodiments, the detecting unit 120 determines bending of the display unit 110, but this is just an exemplary embodiment. In other words, the control unit 130 may receive a result of sensing by the sensor unit 120 and determine bending of the display unit 110.

The control unit 130 controls the overall operations of the flexible apparatus 100. In particular, the control unit 130 may determine bending of the display unit 110 based on the result of sensing by the sensor unit 120. That is, the control unit 130 may determine the bending state (that is, whether or not there is bending, the bending angle, and the bending direction etc.) of the display unit 110 using the resistance values output from one or more bend sensors, strain gauges, or acceleration sensors etc. This was explained in detail with reference to FIGS. 3A-3D and 4A-4C, and thus repeated explanation is to be omitted.

Meanwhile, the detecting unit 120 may detect a touch input by a user with respect to the display unit 110. For example, the detecting unit 120 may include various touch sensors (not illustrated) including resistive and/or capacitive sensors, and may detect a user's tough on the display unit 110 and transmit the result of the detection to the control unit 130.

Further, the detecting unit 120 may detect a user's gripping motion with respect to the flexible apparatus 100. The term the “user's gripping motion: as used herein refers to a motion of a user who grips the flexible apparatus 100 with one or more hands. To this end, the detecting unit 120 may include one or more touch sensors (not illustrated) or pressure sensors (not illustrated) on front and rear surfaces of the flexible apparatus 100.

That is, the detecting unit 120 may detect a touch input with respect to the front and rear surfaces of the flexible apparatus 100 through a touch sensor (not illustrated) and provide the result to the control unit 130. Accordingly, based on the result of detection at the detecting unit 120, the control unit 130 may determine that a user is gripping the flexible apparatus 100 if it is determined that the user is touching both the front and rear surfaces of the apparatus 100. Meanwhile, a user may touch the display unit 110 provided on the front surface of the flexible apparatus 100 and the rear surface of the flexible apparatus 100 when gripping the flexible apparatus 100, in which case the control unit 130 may determine the touch input to the display unit 110 as a touch input with respect to the front surface of the flexible apparatus 100.

Further, the detecting unit 120 may detect a pressure applied to the flexible apparatus 100 through a pressure sensor (not illustrated) and provides the result to the control unit 130. Accordingly, based on the result of a detection at the detecting unit 120, the control unit 130 may determine that the user grips the flexible apparatus 100 if pressure is detected on the flexible apparatus 100. If more than a preset pressure is detected as being exerted on the flexible apparatus 100, the control unit 130 may determine that the user grips the flexible apparatus 100.

Further, the detecting unit 120 may independently detect a pressure exerted on the front surface of the flexible apparatus 100 and a pressure exerted on the rear surface of the flexible apparatus. Accordingly, based on a result of the detection at the detecting unit 120, the control unit 130 may determine that a user grips the flexible apparatus 100 if pressure is exerted on both the front and rear surfaces of the flexible apparatus 100. Further, the control unit 130 may determine that a user grips the flexible apparatus 100 if more than a preset pressure is detected as being exerted on the front and rear surfaces of the flexible apparatus 100, respectively.

In the above-explained examples, the control unit 130 may determine whether a user grips the flexible apparatus 100 with one or two hands.

That is, if a touch input to the front and rear surfaces of only one area on the flexible apparatus 100 is detected, the control unit 130 may determine that a user grips the flexible apparatus 100 with one hand. Alternately, the control unit 130 may determine that a user grips the flexible apparatus 100 with only one hand, if a pressure exerted on only one area of the flexible apparatus 100 is detected.

If a touch input to the front and rear surfaces of a plurality of areas of the flexible apparatus 100 is detected, the control unit 130 may determine that a user grips the flexible apparatus 100 with two hands. Alternately, the control unit 130 may determine that a user grips the flexible apparatus 100 with both hands, if a pressure exerted on a plurality of areas of the flexible apparatus 100 is detected.

In the example explained above, the front and rear surfaces on which a touch input or a pressure is detected, may be opposite each other on opposite sides of the apparatus 100.

Additionally, the detecting unit 120 may detect a user input made by a user stretching the display unit 110. The terms “stretching” and “pulling)” may refer to a single stretching manipulation in which a user supports the flexible apparatus 100 with one hand and grips and stretches the display unit 110 with the other hand, or to an overall stretching manipulation in which a user grips both ends of the display unit 110 and stretches the display unit 110 with both hands.

A method for detecting a stretching manipulation according to an exemplary embodiment will be explained below with reference to accompanying drawings.

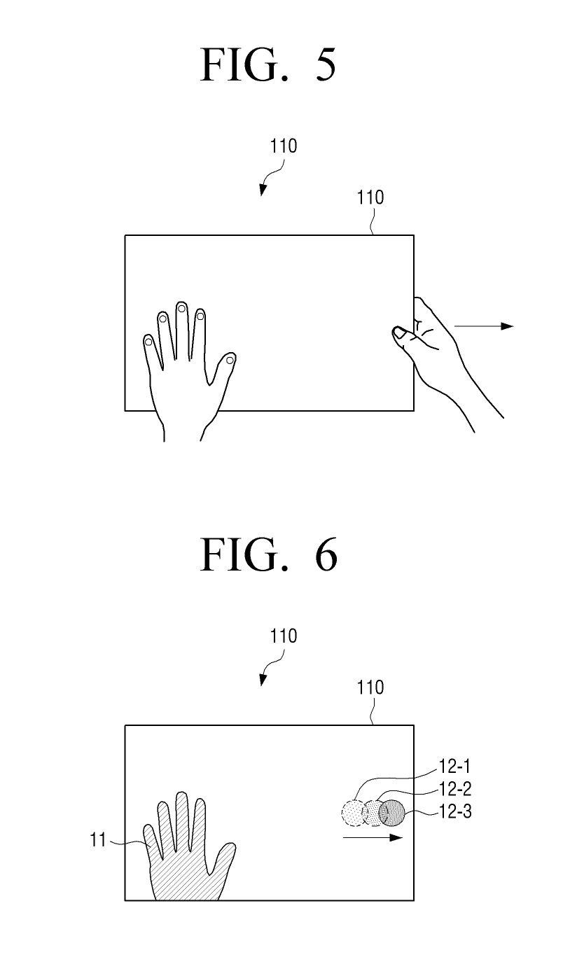

FIGS. 5 to 8 are views provided to explain a method for detecting a stretching manipulation according to an exemplary embodiment.

Referring to FIG. 5, the term “single stretching manipulation” as used herein refers to a gesture of a user who supports the flexible apparatus 100, resting on a floor or a table with one hand and stretches out the display unit with the other hand. That is, a force (or tension) in one direction is exerted on the display unit 110.

Meanwhile, because the display unit 110 remains unchanged under the externally-exerted force thereto, when the single stretching manipulation is made, the hand pulling away the display unit 110 is pushed to a direction of the tension. Accordingly, the area on the display unit 110 being touched is gradually moved toward the direction of tension by the hand gripping the flexible apparatus 100.

FIG. 6 illustrates the change in the area on the display unit 110 being touched in accordance with the input of the single stretching manipulation. Referring to FIG. 6, in response to the single stretching manipulation, the touch area (i.e. the area being touched) formed on the side of the hand pulling away the display unit 110 moves outward as illustrated in 12-1→12-2→12-3, while the touch area formed on the side of the hand supporting the flexible apparatus 100 remains still. Accordingly, based on the output values of the touch sensor sensing the touch on the display unit 110, the control unit 130 may determine the movement of the touch area and the direction of such movement of the touch area.

Accordingly, in a state of detecting user's grip on one area, if the touch area formed on the display unit 110 according to the user's grip is moved, the control unit 130 may determine that a single stretching manipulation is made.

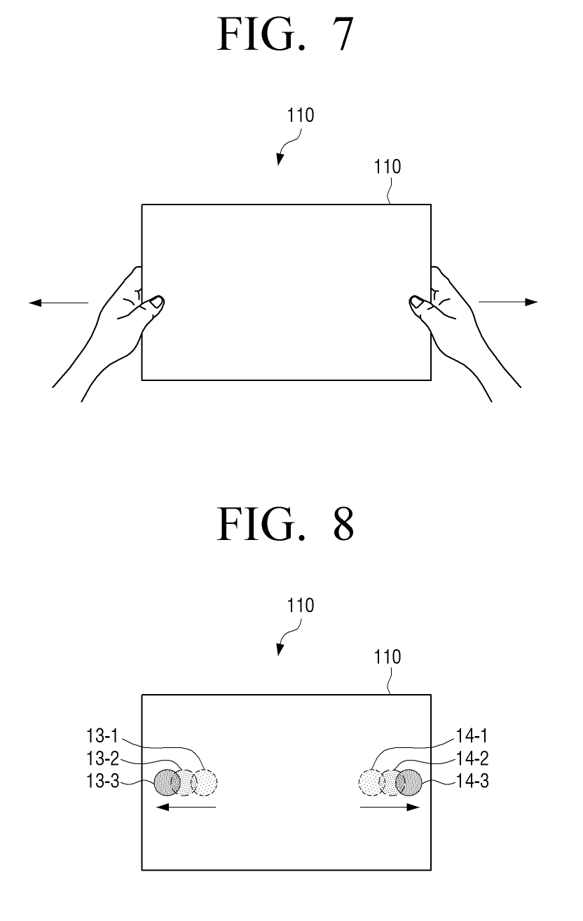

Meanwhile, referring to FIG. 7, the term “overall stretching manipulation” refers to a gesture of a user who grips the flexible apparatus 100 with both hands and pulls apart the flexible apparatus 100 in opposite directions. That is, the tension is applied to the flexible apparatus 100 in both directions.

As explained above, because the display unit 110 remains unchanged even under externally-exerted force, when the overall stretching manipulation is made, the two hands pulling apart the flexible apparatus 100 move away from each other in opposite directions. As a result, the touch areas formed on the display unit 110 by the user who grips the flexible apparatus 100, are gradually away from each other.

FIG. 8 illustrates a movement of the touch areas formed on the flexible apparatus 100 in accordance with the overall stretching manipulation. That is, referring to FIG. 8, in accordance with the input of overall stretching manipulation, the touch area formed on the display unit 110 by one hand of the user moves in the order of 13-1→13-2→13-3, and the touch area formed on the display unit 110 by user's other hand moves in the order of 14-1→14-2→14-3. Accordingly, the control unit 130 may determine movement of the touch areas and direction of such movement of the touch areas based on the output values of the touch sensors which sense the touch input to the display unit 110.

Accordingly, in a state of detecting a user's grip on a plurality of areas, the control unit 130 may determine that an overall stretching manipulation is made if the location of the plurality of touch areas formed on the display unit 110 according to the user's grip are gradually moved in opposite directions.

In one embodiment, the single and overall stretching manipulations may be determined based on the movement of the touch area(s) formed on the display unit 110. However, this is only for illustrative purposes. Accordingly, in another embodiment, the presence of the single and overall stretching manipulations may be determined based on a change of a location of the pressure exerted according to the user's gripping motion.

That is, the detecting unit 120 may detect the pressure exerted on the display unit 110 according to the user's gripping, and the control unit 130 may determine whether the single or overall stretching manipulation is made, based on the result of detection at the detecting unit 120.

For example, the detecting unit 120 may include a piezo film to output an electric signal corresponding to the exerted pressure, and the control unit 130 may determine the location of the pressure and direction in which the pressure is moved, using coordinates of the piezo film to which the electric signal is transmitted.

Accordingly, in a state of detecting the user's grip on one area, if the location of the pressure exerted on the display unit 110 by the user's gripping is moved, the control unit 130 may determine that the single stretching manipulation is made. In a state of detecting the user's grip on a plurality of areas, if the locations of the pressure exerted on the display unit 110 by the user's gripping are gradually moved in opposite directions to each other, the control unit 130 may determine that the overall stretching manipulation is made.

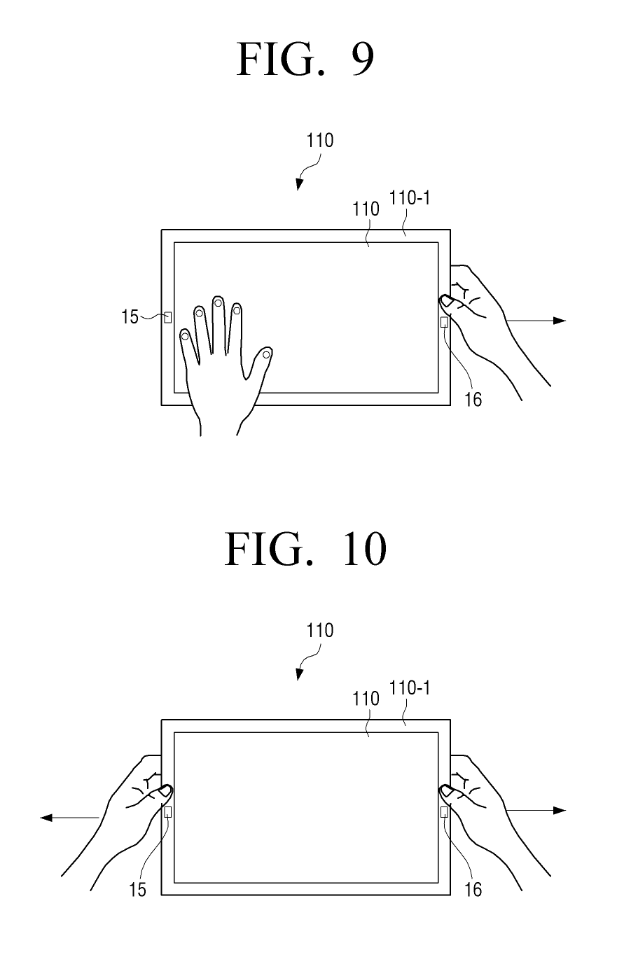

In one embodiment, the presence of a stretching manipulation is determined based on the input by the user who pulls apart the display unit 110. However, this is only for illustrative purposes. Accordingly, in another embodiment, the presence of stretching manipulation may be determined based on the input by the user who pulls apart the flexible apparatus 100 itself. For example, the user may pull on the flexible apparatus 100 by the edges, i.e., by the bezel areas on the outer boundaries of the display unit 110. This will be explained in detail below with reference to FIGS. 9 and 10.

FIGS. 9 and 10 are views provided to explain a method for determining stretching manipulation according to an exemplary embodiment.

The detecting unit 120 may include a plurality of strain gauges (not illustrated) arranged on an edge area of the flexible apparatus 100. A strain gauge is used to measure the strained state of the flexible apparatus 100. The term “strain' as used herein refers to an elongation of an object when a force is exerted in an outward direction parallel to a central axis of the object.

For example, the strain gauge may be implemented as an optical fiber sensor utilizing optical fiber technology, or nano sensor utilizing nano material, but is not limited thereto. An optical fiber sensor utilizes the property of the optical fiber by which varies the refractive index or length of the fiber in accordance with the straining of the optical fiber lattice with a periodically-varying refractive index of optical fiber core, and thus the optical fiber can be used to detect the degree of strain by measuring a wavelength of the light reflected from the optical fiber lattice. Further, a nano sensor utilizes the principle of a nano material which electrically changes a property thereof in accordance with a compression or straining of the material, and thus the nano sensor can be used to detect the degree of strain by measuring the load (i.e., force) exerted on the nano material.

By way of example, referring to FIGS. 9 and 10, the strain gauges 15, 16 may be arranged on edges of the flexible apparatus 100, i.e., on a bezel area 110-1 at an outer boundary of the display unit 110. The bezel area 110-1 may be formed from a resilient material such as urethane, silicone rubber, or elastic rubber so as to be able to recover its original state after being deformed by an externally-applied force. Of course, the bezel area 110-1 may be formed from any of a number of materials with appropriate elasticity and resiliency.

If a user supports the display unit 110 or the bezel area 110-1 with one hand and grips and pulls away the bezel area 110-1 with the other hand, tension is exerted on the strain gauge 16 disposed on the bezel area 110-1 which is gripped by the other hand of the user, and the corresponding area is stretched in a direction of the force. Accordingly, when one of the plurality of strain gauges detects tension, the control unit 130 may determine that a single stretching manipulation is made.

Although the presence of a stretching manipulation may be detected using strain gauges as explained above in certain embodiments, this is only for illustrative purposes. Accordingly, other examples are possible. For example, a stretching manipulation may be detected using pressure sensors which may be arranged on the bezel area. In this case, the detecting unit 110 may include a plurality of pressure sensors disposed on the edge area of the flexible apparatus 100.

Accordingly, in a state of detecting a user's gripping on one edge area of the flexible apparatus 100, if a location where the pressure by the user's gripping is exerted is moved, the control unit 130 may determine that a single stretching manipulation is made. In a state of detecting user's gripping on a plurality of edge areas of the flexible apparatus 100, if locations where the pressure by the user's gripping is exerted are gradually moved in opposite directions, the control unit 130 may determine that an overall stretching manipulation is made.

As explained above with reference to FIGS. 5 to 10, the flexible apparatus 100 may be stretched in a horizontal direction. However, the same detecting manner may be applied when the flexible apparatus 100 is stretched in a vertical direction. Accordingly, the control unit 130 may detect the presence of a stretching manipulation in a vertical direction when the touch area formed on the display unit 110 or when a detected pressure moves in the vertical direction. Further, the control unit 130 may detect the stretching manipulation in the vertical direction using one or more strain gauges particularly arranged in the vertical direction among strain gauges arranged on the edge area of the flexible apparatus 100. It is also possible to detect a stretching manipulation in a diagonal direction in the manner explained above.

The flexible apparatus 100 is flexible, such that it is able to change its form freely according to a force exerted thereto and also has resilience such that it is able to recover its original flat state. The control unit 130 utilizes such properties of the flexible apparatus 100 to determine whether the stretching manipulation is made or not based on the pressure exerted on the display unit 110 when the display unit 110 is returned to its original state from the bent state.

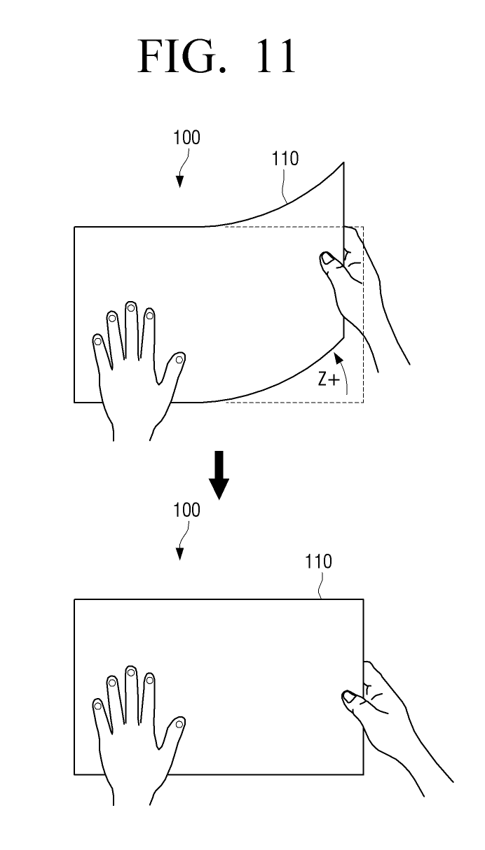

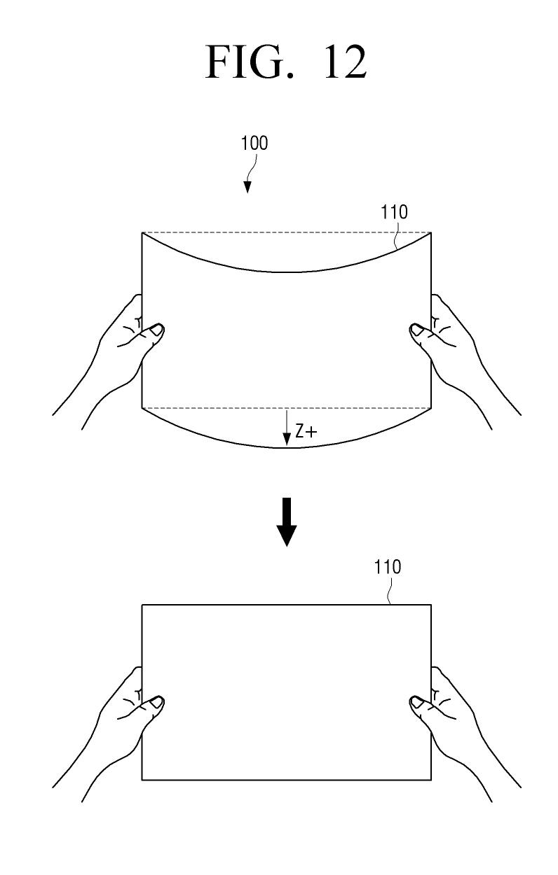

This will be explained in greater detail below with reference to FIGS. 11 and 12.

FIGS. 11 and 12 are views provided to explain a method for detecting a presence of a stretching manipulation input according to an exemplary embodiment.

To be specific, the control unit 130 does not determine that a stretching manipulation is input if force is exerted to return the deformed display unit 110 back to flat state.

That is, the control unit 130 does not determine that a stretching manipulation is input, if force is exerted to return to the original state of the display from the deformed state. The control unit 130 determines that a stretching manipulation is input only when recovery of the bent display unit 110 to the flat state is followed by an input of a force exceeding a predetermined size to the display unit 110 in flat state.

That is, the control unit 130 may determine that a single stretching manipulation is made, when recovery of one edge area of the display unit 110 from the bent state back to the original flat state is followed by detection of more than a preset pressure at the one area of the display unit 110 gripped by the user. The term “preset pressure” as used herein refers to a minimum pressure that is necessary to return the bent display unit 110 back to flat state, and this may be set differently depending on the material of the display unit 110.

By way of example, referring to FIG. 11, it is assumed that a right-side edge area of the display unit 110 is bent to Z+ direction. The control unit 130 may determine that a single stretching manipulation is made, when the recovery of the display unit 110 back to the flat original state is followed by a detection of more than a preset pressure on the right edge area of the display unit 110 gripped by the user. Although bending in Z+ direction is explained above as an example, one will understand that determining an input of single stretching manipulation is also possible, when the recovery of the display unit 110 bent state in Z− direction back to original flat state is followed by application of more than a preset pressure.

The control unit 130 may determine that an overall stretching manipulation is made, when recovery of center area of the display unit 110 from the bent state back to the original flat state is followed by detection of more than a preset pressure at opposite sides of the display unit 110 gripped by the user. The term “preset pressure” as used herein refers to a minimum pressure that is necessary to return the bent display unit 110 back to a flat state, and this may be set differently depending on the material of the display unit 110.

By way of example, referring to FIG. 12, it is assumed that both the left and right sides of the display unit 110 are bent in the Z− direction (i.e. a center area of the display unit 110 is bent in the Z+ direction). The control unit 130 may determine that an overall stretching manipulation is made, when the recovery of the display unit 110 back to the flat original state is followed by a detection of more than a preset pressure on the left and right edge areas of the display unit 110 gripped by the user. Although bending of the edges in the Z− direction is explained above as an example, one will understand that determining an input of overall stretching manipulation is also possible, when the recovery of the display unit 110, having edges bent in Z− direction, back to original flat state is followed by application of more than a preset pressure.

Meanwhile, the control unit 130 may determine a frequency of inputting stretching manipulations to the flexible apparatus 100 based on the result of detection at the detecting unit 120.

That is, if a movement of a location of a touch area as sensed at a touch sensor; or a movement of a location of a pressure as sensed at a pressure sensor; or a detection of a tension at a strain gauge is not followed by an output of a separate sensed value from touch sensor, pressure sensor, or the strain gauge, the control unit 130 may determine that a stretching manipulation is input once. That is, the control unit 130 does not count an input of a stretching manipulation, when the exertion of a force (pressure or tension) on the flexible apparatus 100 is followed by successive exertions of force, and determines that the stretching manipulation is input only one time, if the user does not exert force anymore once he or she pulls away the flexible apparatus 100.

Meanwhile, the control unit 130 controls the overall operation of the flexible apparatus 100. That is, the control unit 130 may determine an input of a user's manipulation which corresponds to a gesture of stretching the display unit 110, based on the result of detection at the detecting unit 120. This has been explained above with reference to FIGS. 5 to 12.

Further, the control unit 130 may perform a corresponding operation in response to the user's input, if it is determined that the user's input corresponds to a gesture of stretching the display unit 110. That is, the control unit 130 may operate differently depending on whether a single stretching manipulation is input or whether an overall stretching manipulation is input, and operations corresponding to the respective gestures made by the user will be explained in detail.

### <Operations According to Overall Stretching Gesture>

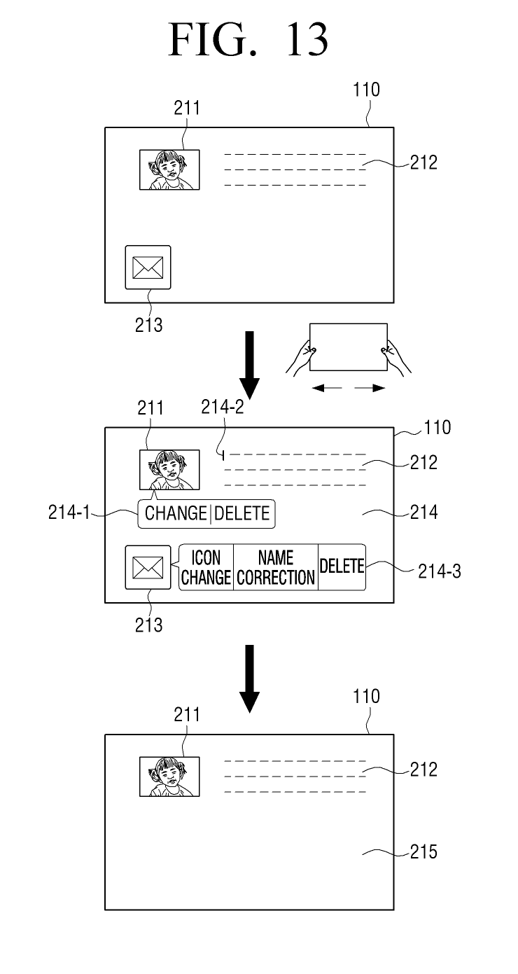

FIGS. 13 to 25 are views provided to explain operations performed in response to an overall pulling gesture according to an exemplary embodiment.

The flexible apparatus 100 may additionally include a storage unit (not illustrated) to store at least one application installed on the flexible apparatus 100, and the control unit 130 may control the apparatus 110 so that at least one of a plurality of applications stored on a storage unit (not illustrated) is driven so that an executed screen thereof appears on a display unit 110.

The control unit 130 may change a screen mode in response to the overall stretching manipulation. To be specific, the control unit 130 may display an edit mode screen in which it is possible to edit a screen displayed on the display unit 110, when the overall stretching manipulation is input. The user may then edit a screen displayed on the display unit 110 by inputting touch manipulations on the edit mode screen.

For example, referring to FIG. 13, if an overall stretching manipulation is input in a state in which a plurality of objects 211, 212, 213 are displayed on the display unit 110, an edit mode screen 214, to enable editing of the respective objects, is displayed. The term “object” as used herein may include all the items displayable on the display unit 110 such as an icon, an image, a text or a photo. To be specific, a GUI element 214-1 to change or delete the image 211, a cursor 214-2 to correct text, or a GUI element 214-3 to change an icon 213, or correct or delete names, may be displayed. Other than the specific examples mentioned above, many GUI elements may be variously implementable for display on the edit mode screen. After that, when the user selects “delete” from among the GUI elements 214-3, a screen 215, from which icon 213 has been removed, is displayed on the display unit 110.

If the overall stretching manipulation is made, the control unit 130 may control the display unit 110 so that a home screen is displayed. The term “home screen” as used herein may refer to a screen that includes at least one icon representing an application installed on the flexible apparatus 100. If the currently displayed screen on the display unit 110 is an executing screen that appears in response to driving an application, the control unit 130 may stop driving the application currently displayed on the display unit 110 in order to display the home screen. However, this is explained for illustrative purposes only, and accordingly, the control unit may change the currently-displayed screen on the display unit 110 into the home screen without stopping driving the application.

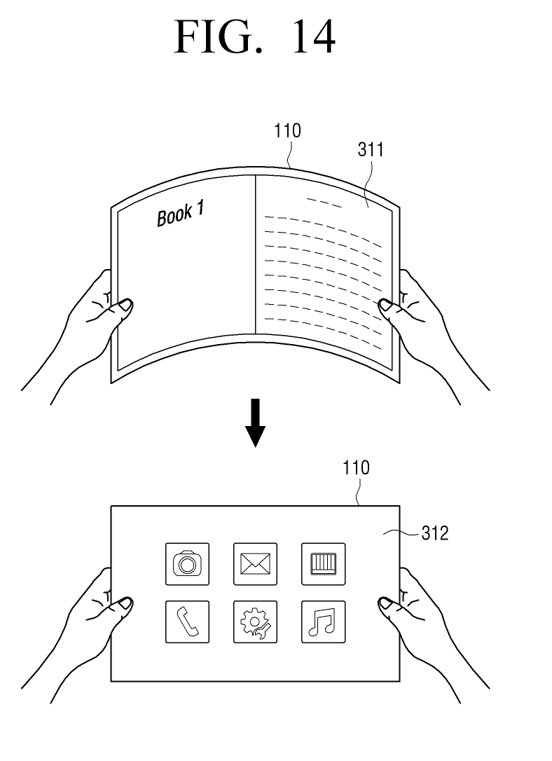

For example, referring to FIG. 14, it is assumed that an executing screen 311 is displayed on the display unit 110 in accordance with the driving of an e-book application. When the edges of the display unit 110, which were bent in the Z+ direction, are returned to the flat state by more than a preset pressure, the home screen 312 may appear.

The control unit 130 may also change a displayed form of an object displayed on the screen in response to the overall stretching manipulation. That is, the control unit 130 may control the display unit 110 so that the number of objects increases, or the size of objects changes, or the objects may move in predetermined direction, in response to the overall stretching manipulation.

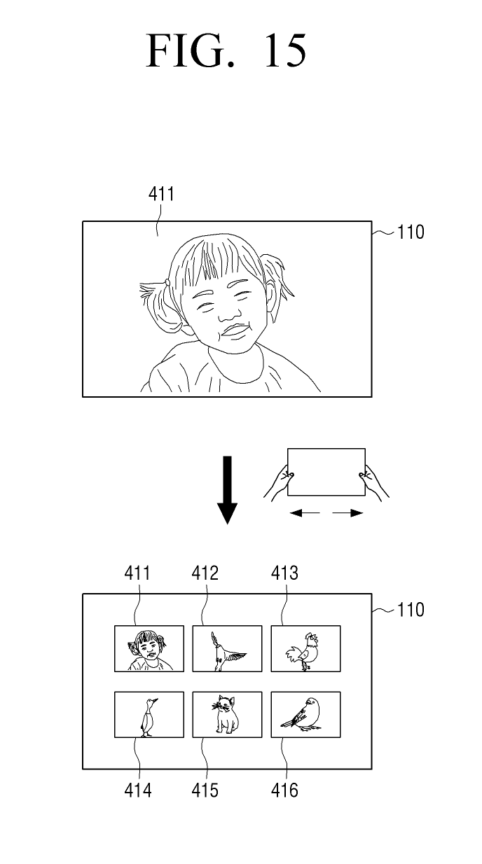

For example, referring to FIG. 15, if the overall stretching manipulation is made in a state that an image 411 is displayed on the display unit 110, the image 411 is displayed on the display unit 110 in a reduced size along with other images 412 to 416. The images 411 to 416 may be pre-stored images of the flexible apparatus 100, or those that are received from an external server (not illustrated).

The control unit 130 may control the display unit 110 so that the number of displayed objects changes according to the force exerted to the display unit 110. To be specific, when the user grips and pulls on the display unit 110, the control unit 130 may increase the number of displayed objects in proportion to the force exerted on the display unit, based on moving distance of the touch areas formed on the display unit 110, the pressure exerted on the display unit 110, or moving distance of the pressure.

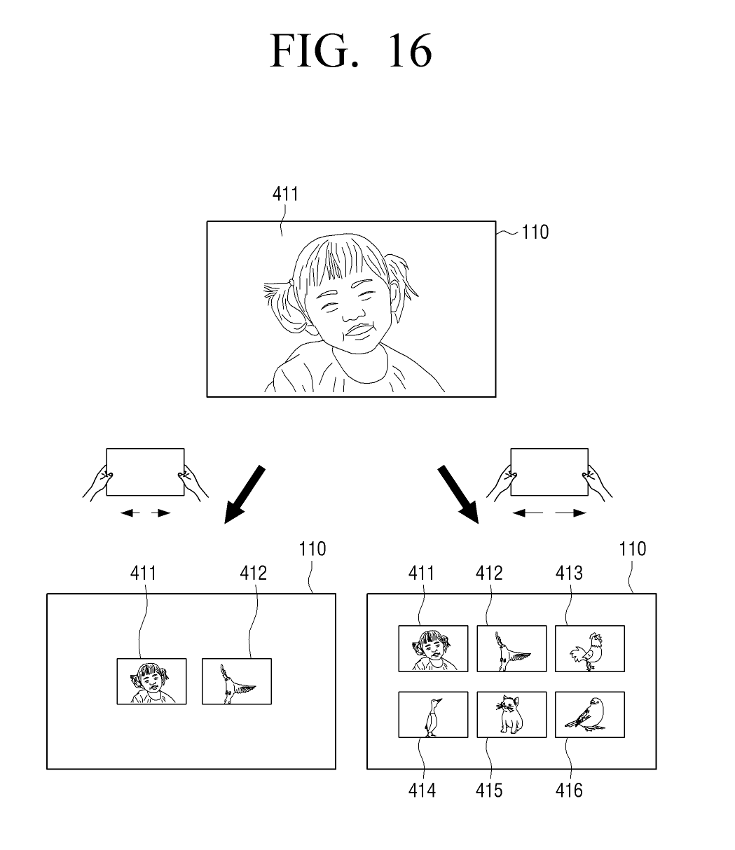

For example, referring to FIG. 16, when the overall stretching manipulation is made, two images 411, 412 may be displayed in response to an overall stretching manipulation in which a relatively weaker force is exerted on the display unit 110, while six images 411 to 416 may be displayed in response to an overall stretching manipulation in which a relatively stronger force is exerted on the display unit 110.

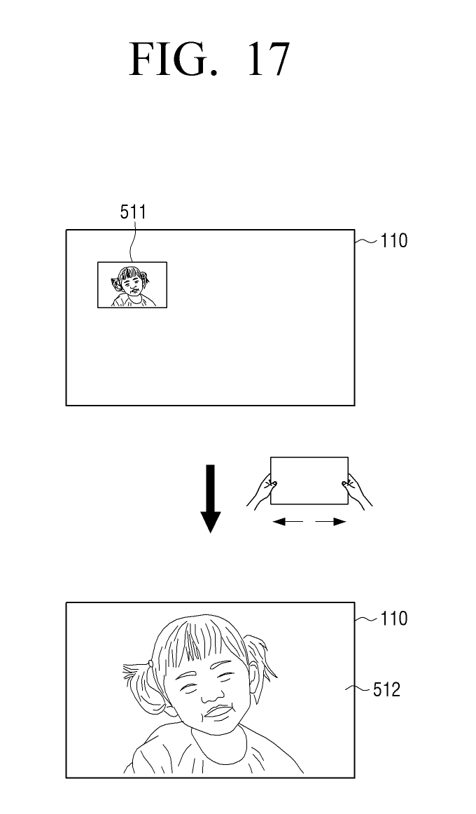

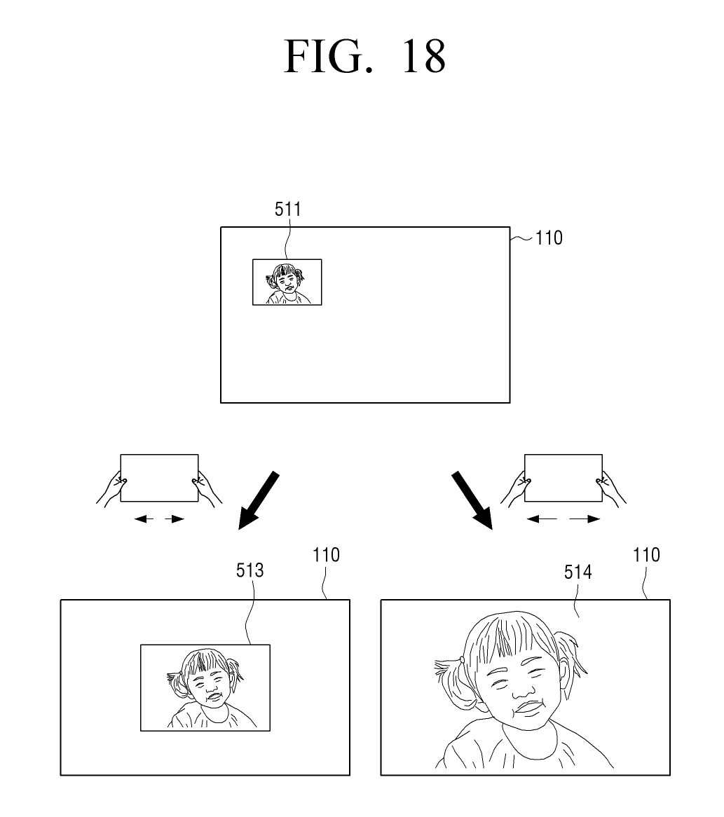

Meanwhile, referring to FIG. 17, when the overall stretching manipulation is made in a state in which an image 511 is displayed on the display unit 110, the size of the image 511 may be gradually enlarged so that the image 511 may be displayed on the display unit 511 in a full-view state 512.

The control unit 130 may adjust the size of the enlarged object according to the force exerted on the display unit 110. To be specific, the control unit 130 may adjust the size of the enlarged object in proportion to the force exerted on the display unit 110.

For example, referring to FIG. 18, the image 514 is enlarged to a size greater than the image 513, when the force exerted on the display unit 110 in the overall stretching manipulation is relatively weaker than the force exerted in the overall stretching manipulation to enlarge to the size of the image 514.

Meanwhile, in the embodiment explained above, a corresponding object is enlarged and displayed when an overall pulling gesture is made in a state that the object is displayed. However, in a state in which a plurality of objects is displayed, the control unit 130 may control to enlarge and display only the object selected by the user. In this particular example, the user may select the object displayed on the display unit 110 by touching on the same, and the control unit 130 may tick or highlight the touched object to distinguish the touched object from the others.

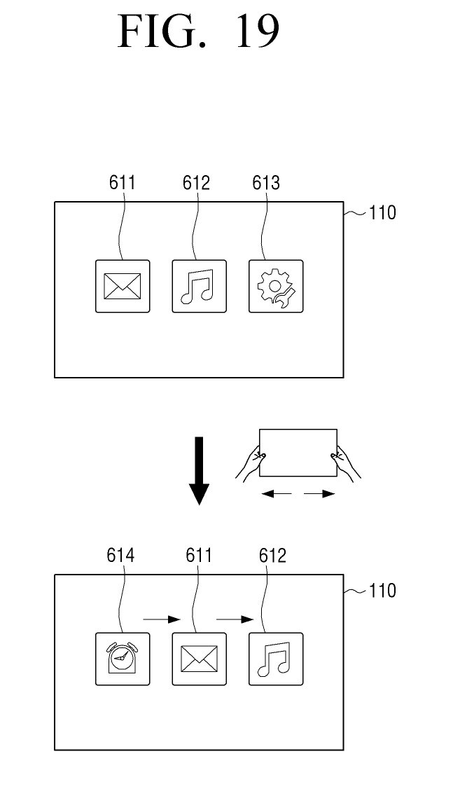

In another example, referring to FIG. 19, a plurality of icons 611, 612, 613 may be arranged in a horizontal direction and displayed on the display unit 110. Accordingly, when the overall stretching manipulation is made, the displayed icons 611, 612, 613 are moved in a predetermined direction (e.g., to the right) and displayed. Accordingly, a new icon 614, which has not been displayed on the display unit 110 before the input of the overall stretching manipulation, appears and is moved along with the other icons 611, 612, 613 in the predetermined direction. The control unit 130 may control the moving velocity of the icons or objects according to the force exerted on the display unit 110. That is, the control unit 130 may increase the moving velocity of the objects in proportion to the force exerted on the display unit 110.

Alternately, when the overall stretching manipulation is made, the control unit 130 may enlarge the screen displayed on the display unit 110 to a preset ratio and display the resultant screen. The control unit 130 may enlarge the screen displayed on the display unit 110 in proportion to the force exerted on the display unit 100 and display the resultant screen.

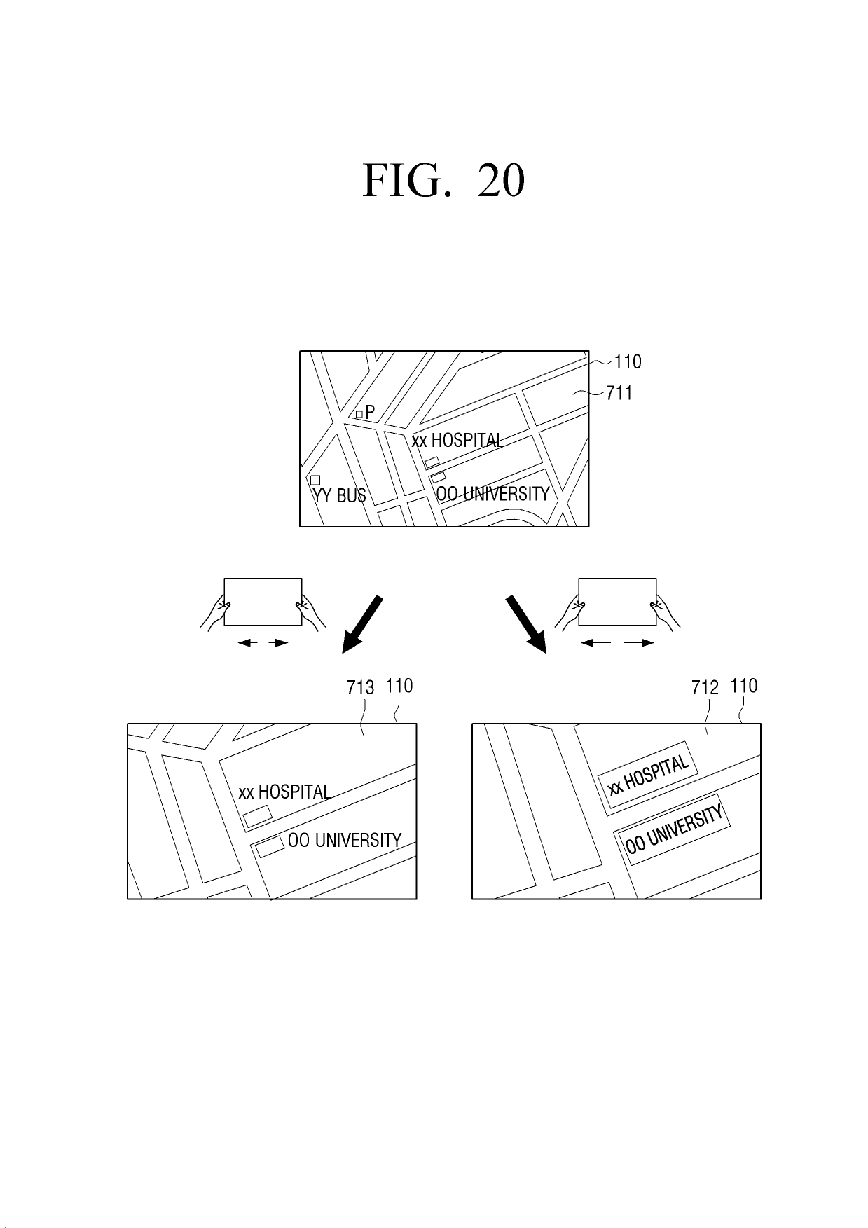

For example, referring to FIG. 20, if the overall stretching manipulation is input in a state in which a map screen 711 is displayed on the display unit 110, an area displayed at a center of the display unit 110 may be enlarged and displayed. The map screen 712 is thus enlarged greater than the map screen 713 is, when the force exerted on the display unit 110 to enlarge the map screen 712 is relatively weaker than the force exerted as the overall stretching manipulation to enlarge the map screen 713.

When the overall stretching manipulation is input, the screen may be divided into two areas according to the direction of the overall stretching manipulation and then the two divided areas may be gradually moved away from each other until the areas disappear, during which new screen may be displayed in between the disappearing areas. The control unit 130 may control the speed at which the areas are moved so that the divided areas are moved in response to the overall stretching manipulation in proportion to the force exerted on the flexible apparatus 100. Accordingly, as the exerted force becomes greater, the divided areas are moved faster to the ends of the display unit 100, to eventually disappear, and the new screen appears faster.

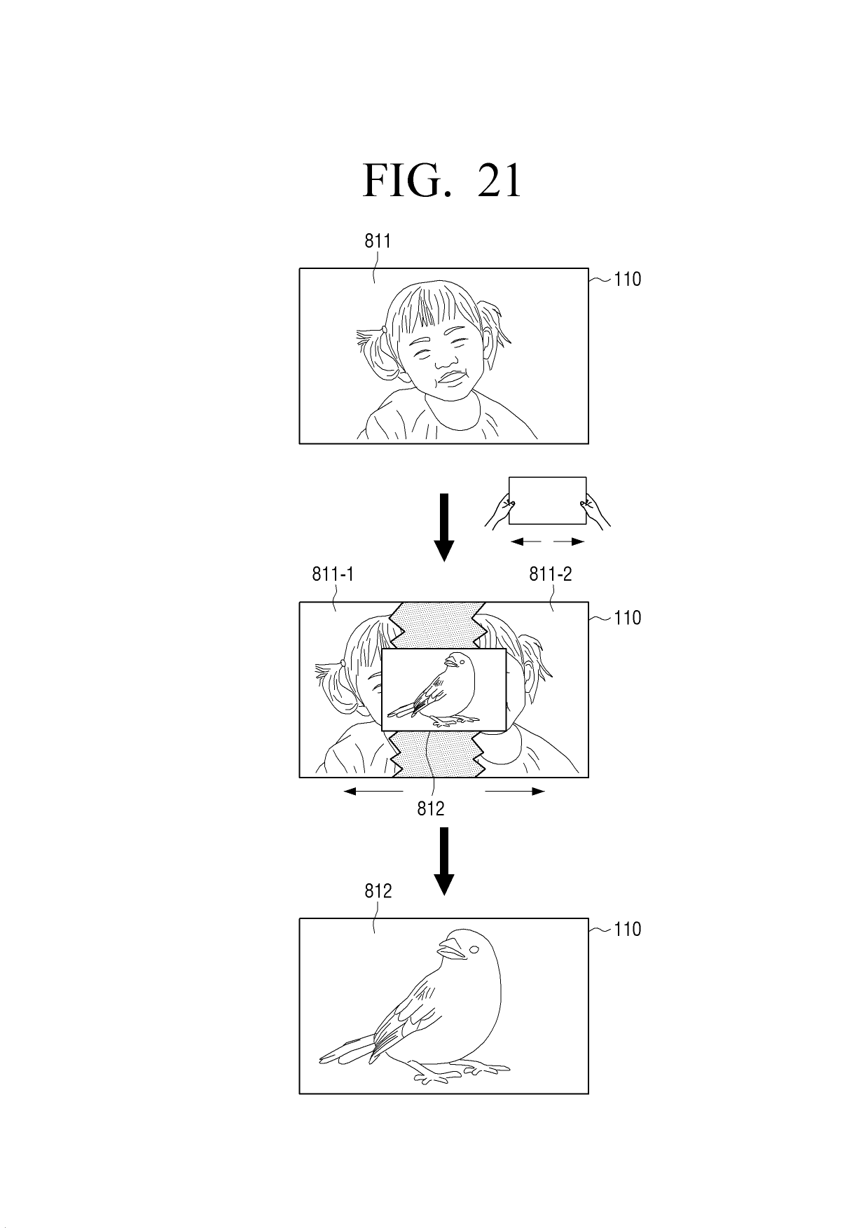

For example, referring to FIG. 21, the overall stretching manipulation is input in a horizontal direction in a state that an image 811 is displayed on the display unit 110. In this example, the displayed image 811 is divided into halves and moved to opposite sides in the horizontal direction of the display unit 110 and are removed from the display unit 110. New image 812 appears in between the divided images 811-1, 811-2, and gradually increases in size until the new image 812 is displayed on the display unit 110 in a full-view state. The images 811, 812 may be images previously stored in the flexible apparatus 100 or images received from an external server (not illustrated).

In response to the overall stretching manipulation, the control unit 130 may also display a feedback effect corresponding to the overall stretching manipulation on the display unit 110.

That is, the control unit 130 may provide a feedback effect corresponding to the overall stretching manipulation by displaying a preset graphic effect on the screen.

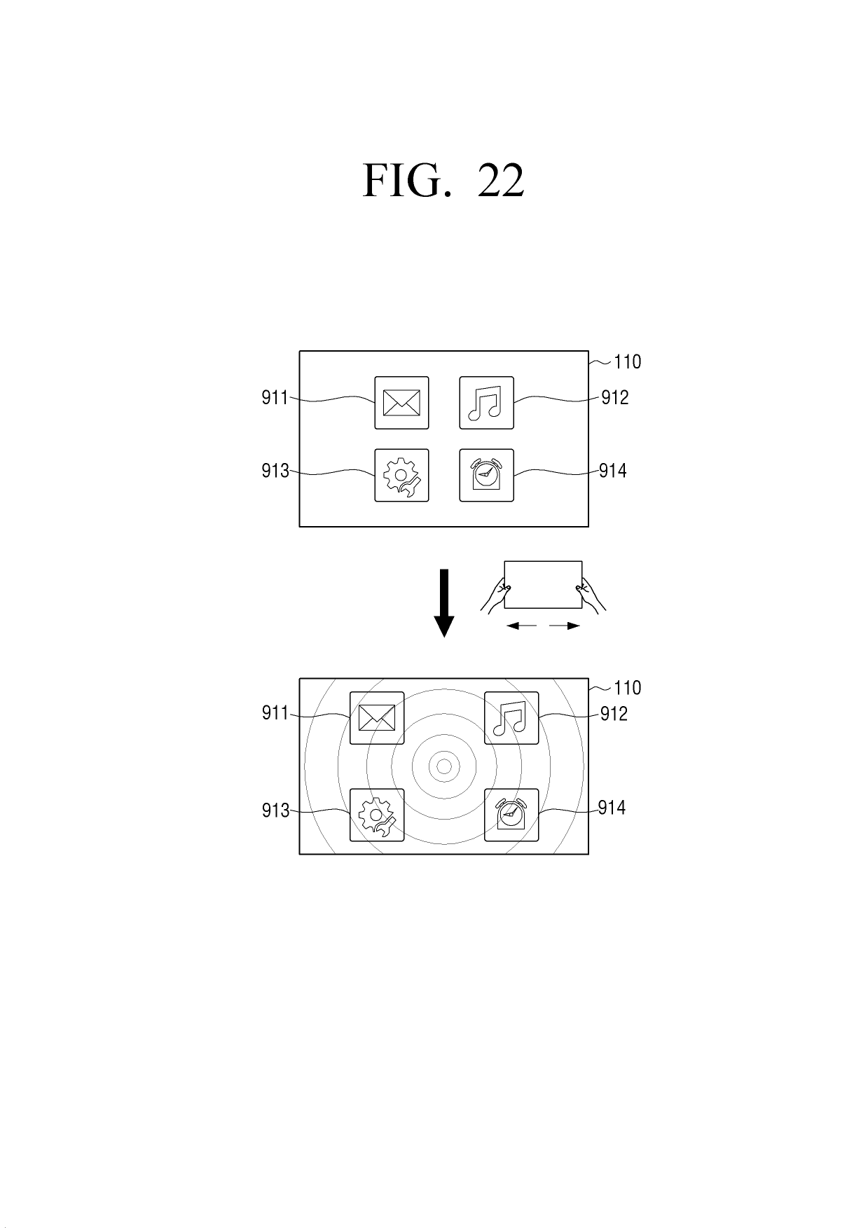

For example, referring to FIG. 22, the overall stretching manipulation is input in a state in which a plurality of icons 911, 912, 913, 914 are displayed. Accordingly, a wave-shaped graphic effect 920 is sequentially generated from the center of the display unit 110 and gradually increases in size toward the edges of the display. The wave-shaped graphic effect 920 disappears from the screen as each wave moves of the edge of the screen. Accordingly, the respective icons 911, 912, 913, 914 are overlapped with the wave-shaped graphic effect 920 and may appear as though floating on water.

Alternately, the control unit 130 may provide a feedback effect corresponding to the overall stretching manipulation by enlarging the size of the object displayed on the display unit 110 in the direction in which the overall stretching manipulation is input. The object may have a 3D shape. The control unit 130 may adjust the size of the enlarged object according to the force exerted on the display unit 110 when the overall stretching manipulation is input. To be specific, the control unit 130 may control the display unit 110 so that the size of the object increases in proportion to the force exerted on the control unit 130.

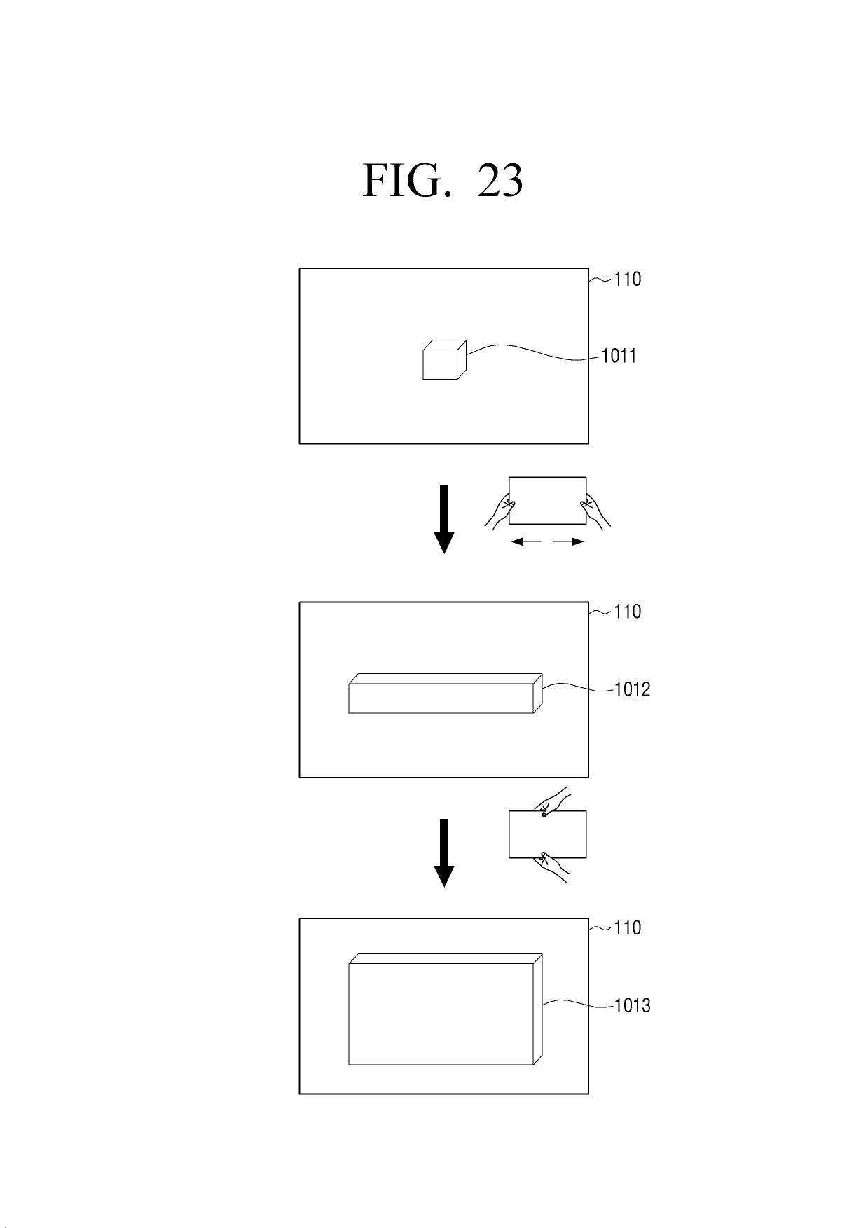

By way of example, referring to FIG. 23, the overall stretching manipulation is generated in a horizontal direction in a state in which a 3D shape 1011 is displayed on the display unit 110. In this example, a 3D shape 1012, which has been enlarged in the horizontal direction, may be displayed. Likewise, a 3D shape 1013, which is enlarged in the vertical direction, may be displayed when the overall pulling gesture is input in the vertical direction.

The control unit 130 may adjust the speed at which the content currently played on the display unit 110 is played back, when the overall stretching manipulation is input in a state in which the content is being played back.

The control unit 130 may control so that the speed of playing varies depending on the force exerted on the displayed unit 110 to input the overall stretching manipulation. To be specific, the control unit 130 may increase the speed of playing in proportion to the force exerted on the display unit 110 to input overall stretching manipulation, or decrease the speed of playing in proportion to the force exerted on the display unit 110 to input the overall stretching manipulation.

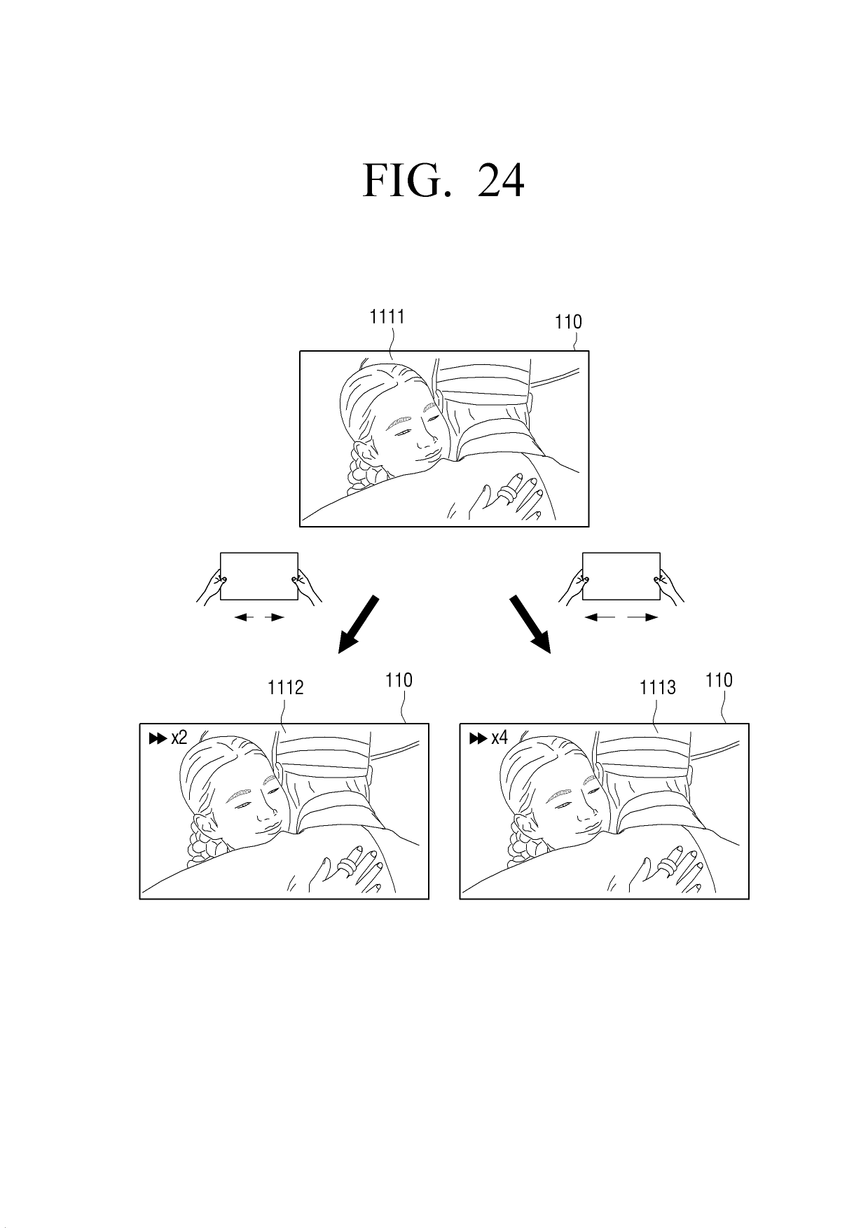

For example, referring to FIG. 24, it is assumed that the overall stretching manipulation is input in a state in which a content A playback screen 1111 is displayed on the display unit 110 in accordance with the driving of a video playback application. The speed of displaying the screen may be faster when a stronger force is exerted on the display unit 110 than when a relatively weaker force is exerted (see screens 1112, 1113).

The control unit 130 may also control so that the speed of playing may vary depending on the duration the overall stretching manipulation is maintained. That is, the control unit 130 may increase or decrease the speed of playing in proportion to the duration of maintaining the overall stretching manipulation. The overall stretching manipulation is input in a state in which a content A playback screen 1111 is displayed on the display unit 110 in accordance with the driving of a video playback application.

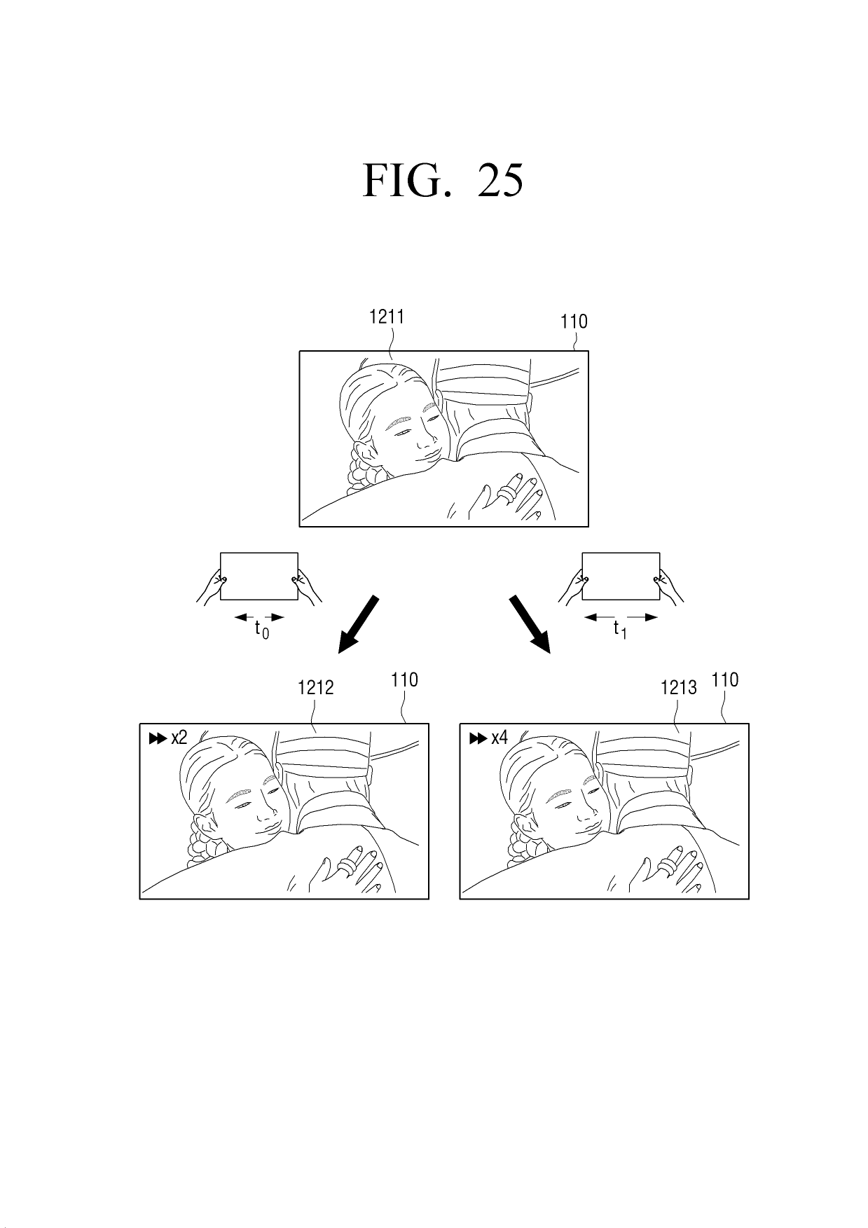

For example, referring to FIG. 25, it is assumed that the overall stretching manipulation is input in a state that a content B playback screen 1211 is displayed on the display unit 110 in accordance with driving of a video playback application. The speed of displaying the screen may be faster when the duration of inputting the overall stretching manipulation is longer (see screens 1212, 1213).

<Operation in Accordance with a Single Stretching Gesture>

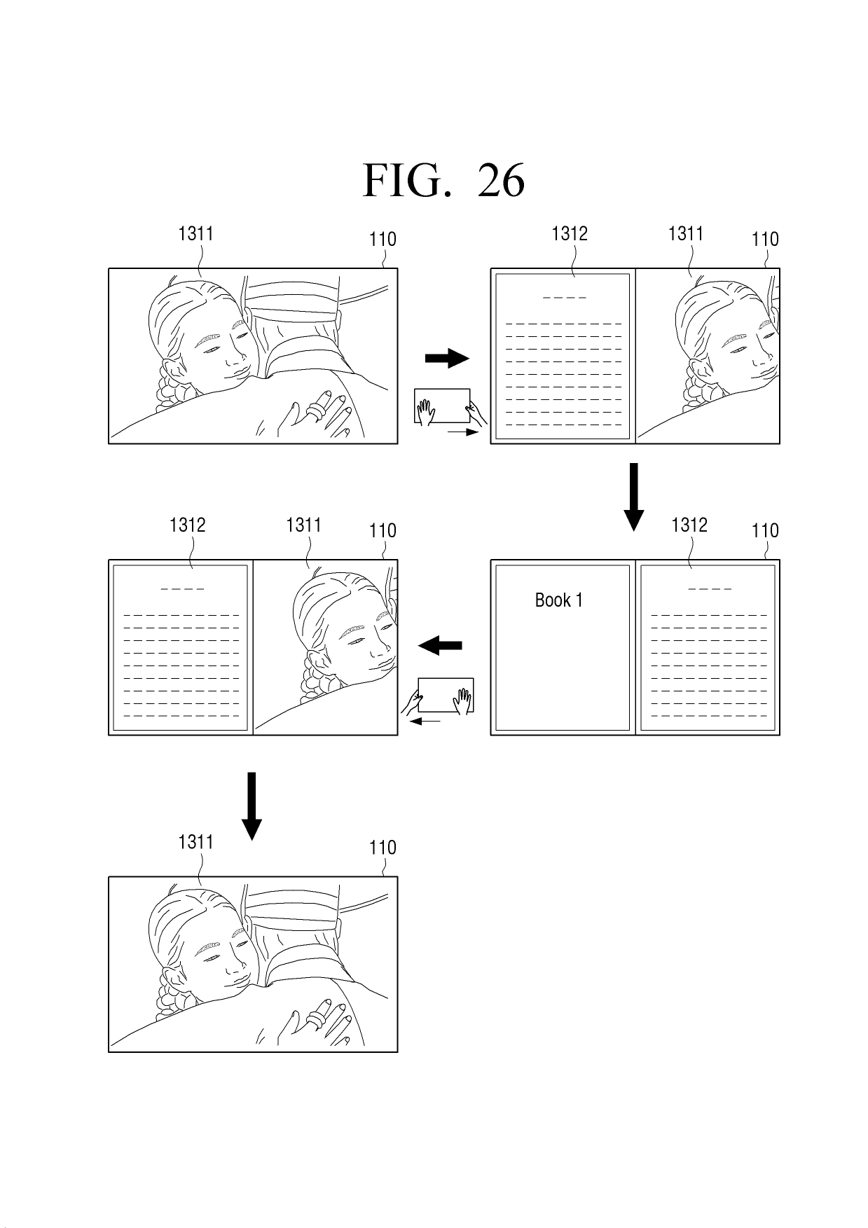

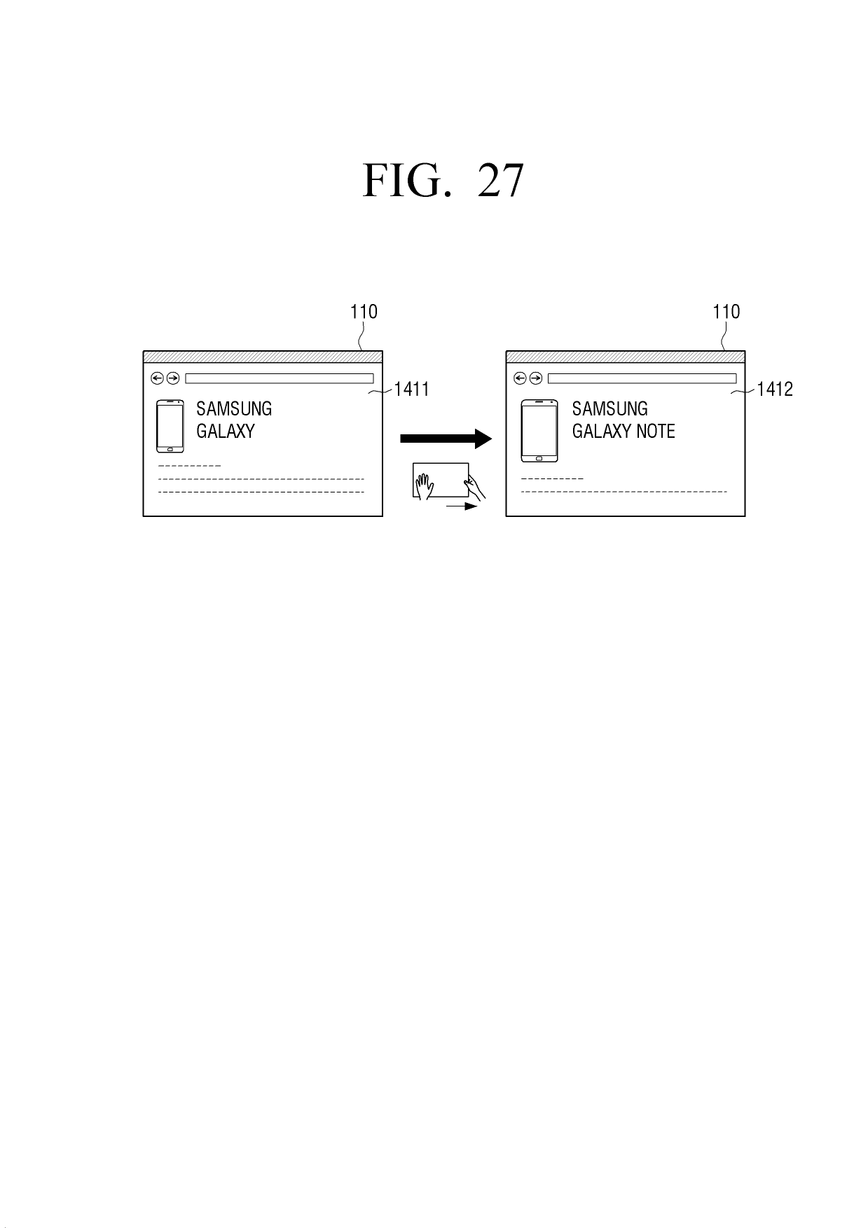

FIGS. 26 and 27 are views provided to explain an operation performed in response to a single stretching manipulation in accordance with an exemplary embodiment.

In response to a single stretching manipulation, the control unit 130 may move the screen to in the direction in which the single stretching manipulation is made to remove the same, and move a new screen into position in the direction in which the single stretching manipulation is made to display the same. The new screen may be an executing screen of one of a plurality of currently-driven applications. That is, the new screen may be an executing screen of one of the applications driven in multitasking mode.

For example, referring to FIG. 26, a single stretching manipulation is input in a rightward direction in a state that a content A playback screen is displayed on the display unit 110 according to driving of a video playback application. In this case, the content A playback screen 1311 may move and disappear in the rightward direction, and another currently-driven application, i.e., an e-book 1 screen 1312 may newly appear from left side according to the driving of an e-book application, and move to the rightward direction to be displayed.

If a single stretching manipulation is made in a leftward direction in a state in which the e-book 1 screen 1312 is displayed, the e-book 1 screen 1312 moves and disappears to the leftward direction, and the content A playback screen 1312 may move from the right to the left side and be displayed in accordance with driving of the video playback application.

As explained above with reference to certain exemplary embodiments, the executing screens regarding different applications may be moved and displayed depending on the single stretching manipulation as input. However, this is only for illustrative purposes. Accordingly, different executing screens provided by one application may be moved and displayed according to the input of single stretching manipulation.

For example, referring to FIG. 27, a plurality of web pages may be executed according to the driving of an application, and in response to a single stretching manipulation in rightward direction which is input in a state in which one 1421 of the web pages is displayed on the display unit 110, the web page 1421 may move and disappear to the rightward direction and another web page 1422 may newly move from the left side and be displayed on the display unit 110.

In a similar example, if a single stretching manipulation is input in a state in which an object, such as an image or a text, is displayed on the display unit 100, the displayed object may move and disappear toward a direction in which the single stretching manipulation is input, and a new object may newly appear and move to be displayed in response to the single stretching manipulation.

If a single stretching manipulation is made, the control unit 130 may enlarge or reduce the size of an object selected by the user in a direction in which the single stretching manipulation is made. As used herein, the term “object” may refer to an image, text or an icon.

To be specific, a single stretching manipulation may be made in a state in which the user keeps inputting the touching manipulation with respect to an object displayed on the display unit 110. In this case, the selected object may be enlarged or reduced in size in a direction in which the single stretching manipulation is made. For example, if a single stretching manipulation is input in a leftward direction in a state in which an image is selected, the control unit 130 may enlarge the selected image in the leftward direction and display the same.

In the above-explained example, the control unit 130 may reduce or enlarge the selected object in proportion to the force exerted to input the single stretching manipulation. For example, the control unit 130 may enlarge the object to a greater size, if the single stretching manipulation is made with relatively greater force than when the single stretching manipulation is made with relatively weaker force.

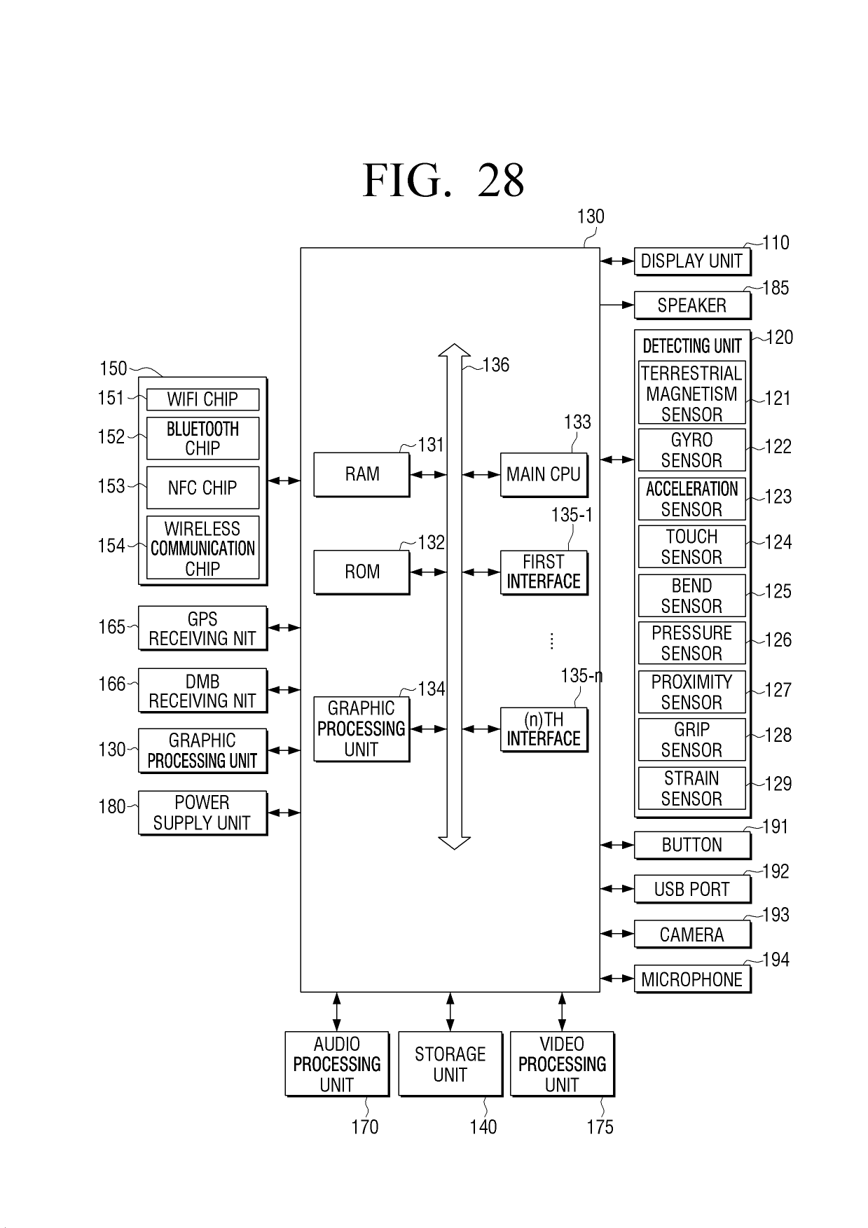

FIG. 28 is a detailed block diagram of a flexible apparatus according to an exemplary embodiment. Referring to FIG. 28, the flexible apparatus 100 may additionally include a storage unit 140, a communicating unit 150, a GPS receiving unit 165, a digital multimedia broadcasting (DMB) receiving unit 166, an audio processing unit 170, a video processing unit 175, a power unit 180, a speaker 185, a button 191, a universal serial bus (USB) port 192, a camera 193, or a microphone 194, in addition to the components illustrated in FIG. 1.

The detecting unit 120 may include one or more of a terrestrial magnetism sensor 121, a gyro sensor 122, an acceleration sensor 123, a touch sensor 124, a bend sensor 125, a pressure sensor 126, a proximity sensor 127, a grip sensor 128, or a strain gauge 129. In addition to the bending gesture, the detecting unit 120 may detect various other manipulations including, for example, touching, rotating, tilting, pressing, or accessing the flexible apparatus.

The terrestrial magnetism sensor 121 is provided to detect the state of rotation and a direction of moving of the flexible apparatus 100. The gyro sensor 122 is provided to detect an angle of rotation of the flexible apparatus 100. While both of the terrestrial magnetism sensor 121 and the gyro sensor 122 may be provided, only one of these is necessary in order to detect a state of rotation of the flexible apparatus 100.

The acceleration sensor 123 is provided to detect the degree of tilting of the flexible apparatus 100. Additionally, the acceleration sensor 123 may be used to detect the bending characteristics including direction or area of bending.

The touch sensor 124 may be capacitive or resistive. The capacitive touch sensor utilizes a dielectric material coated on the surface of the display unit 110, in which touch coordinates are calculated by detecting small electricity excited by a human body touching the surface of the display unit 110. The resistive touch sensor uses two electrodes, in which upper and lower electrodes contact each other at a point of the screen touched by the user to detect current flowing thereto and touch coordinates are thereby calculated. As explained above, the touch sensor 124 may be implemented in any of various forms.

The bend sensor 125 may be implemented in any of various forms and may be provided in various numbers to detect a bending status of the display unit 110. The construction and operation of the bend sensor 125 will not be repeatedly explained below and reference is instead made to the above explanation.

The pressure sensor 126 detects the pressure exerted on the flexible apparatus 100 when the user inputs a touching or bending manipulation, and provides the detected result to the control unit 120. The pressure sensor 116 may include a piezo film embedded in the display unit 110 to output electric signal corresponding to the pressure. Meanwhile, in the embodiment illustrated in FIG. 28, the touch sensor 124 and the pressure sensor 126 may be separately provided from each other. However, in another embodiment and particularly when the touch sensor 124 is a resistive touch sensor, the resistive touch sensor may operate also as the pressure sensor 126.

The proximity sensor 127 is provided to detect a motion approaching the sensor 127 without directly contacting the surface of the display. The proximity sensor 127 includes a high frequency oscillating type of sensor which forms a high frequency magnetic field to detect as current induced due to a magnetic field which varies in accordance with an approach to an object, a magnetic type which utilizes magnet, a capacitance type which detects a varying of a capacitance in accordance with an approach to a target object, or other various forms of sensors.

The grip sensor 128 is provided to detect user's gripping with respect to the flexible apparatus 100 or the display unit 110. To be specific, the grip sensor 128 may be implemented as a pressure sensor or a touch sensor arranged on a front and/or a rear surface of the flexible apparatus 100 to detect the user's gripping.

The strain gauge 129 is provided to detect a user's manipulation when the user pulls on the flexible apparatus 100. As explained above, the strain gauge 129 may be an optical fiber sensor or a nano sensor. Further, the flexible apparatus 100 may include a tensile spring (not illustrated) disposed on an edge area of the flexible apparatus 100 to detect the user's pulling manipulation according to the extension of the tensile spring.

The control unit 130 analyzes various detected signals obtained by the detecting unit 120 to determine the user's intention, and performs an operation or operations that suit the determined intention. That is, as explained above, the control unit 130 may determine if there is bending of the flexible apparatus 100 or the display unit 110, the user's grip or the stretching manipulation based on the detected result of the detecting unit 120 and may perform one or more corresponding operations.

Furthermore, the control unit 130 may perform a control operation according to any of various inputting methods including, for example, a touching manipulation, a motion input, a voice input or a button input. The touching manipulation may include various types of manipulations including, for example, a simple touch, a tap, a touch and hold, move, a flick, a drag and drop, a pinch in or a pinch out.

For example, the control unit 130 may execute an application stored in the storage unit 140 to construct an executing screen thereof and to display the same. The control unit 130 may also play back various contents stored in the storage unit 140. As used herein, the term “content” may refer to various multimedia content such as images, texts, photos, or videos. The control unit 130 may also perform communication with external devices via the communicating unit 150.

The communicating unit 150 is provided to communicate with various types of external devices according to various types of communication methods. The communicating unit 150 may include a WiFi chip 151, a Bluetooth chip 152, a near field communication (NFC) chip 153, or a wireless communication chip 154.

The WiFi chip 151, the Bluetooth chip 152, and the NFC chip 153 perform communication using WiFi, Bluetooth, and NFC, respectively. Among these, the NFC chip 153 operates using NFC using 13.56 MHz among various radio-frequency identification (RF-ID) bands such as 135 kHz, 13.56 MHz, 433 MHz, 860˜960 MHz, or 2.45 GHz. If a WiFi chip 151 or a Bluetooth chip 152 is used, connection information such as service set identification (SSID) or session key may be transmitted and received to be used for connecting communication before various information is actually transmitted and received. The control unit 130 may communicate with external devices (not illustrated) using one or more of the WiFi chip 151, the Bluetooth chip 152 and the NFC chip 153. By way of example, the control unit 130 may perform operations to connect to an external device (not illustrated) according to the Bluetooth communication protocol to transmit or receive content to or from the external device (not illustrated).

The wireless communication chip 154 refers to a chip which performs communication according to one of various communication standards including Institute of Electrical and Electronics Engineers (IEEE) standards, Zigbee, 3rd Generation (3G), 3rd Generation Partnership Project (3GPP), Long Term Evolution (LTE), etc. The control unit 130 may perform communication with the external server (not illustrated), such as a content providing server, a web server, or a mail server, using the wireless communication chip 154. For example, the control unit 130 may access a web server using the wireless communication chip 154 and receive various web page screens.

The GPS receiving unit 165 is provided to receive a GPS signal from a GPS satellite, and calculate a current location of the flexible apparatus 100.

The DMB receiving unit 165 is provided to receive and process a DMB signal.

The power unit 180 is provided to supply electricity to the components of the flexible apparatus 100. The power unit 180 may be implemented in a form that includes a cathode capacitor, a positive electrode, an electrolyte, a negative electrode and an anode capacitor and a cladding portion covering the same. The power unit 180 may be implemented as a secondary battery which is chargeable and dischargeable. The power unit 180 may be implemented in a flexible form to enable it to be bent along with the flexible apparatus 100. In this case, the components such as capacitor, electrode, electrolyte, and the cladding may be formed from flexible material. The shape and material of the power unit 180 will be separately explained below in greater detail.

The audio processing unit 170 is provided to process audio data. The audio processing unit 170 may perform various processing of audio data such as decoding, amplification, or noise filtering.

The video processing unit 175 is provided to process video data. The video processing unit 175 may perform various image processing of the video data such as decoding, scaling, noise filtering, frame rate converting, resolution converting, etc.

The display unit 110 may display various screens or objects according to control of the control unit 130. For example, the control unit 130 may process signals of the various images received from the external server (not illustrated) or the external device (not illustrated) or stored in the storage unit 140 in the audio processing unit 170 and the video processing unit 175 into suitable forms for processing by the display unit 110 so that the images are displayed on the display unit 110. Further, the control unit 130 may display a user interface (UI) screen on the display unit 110 to receive a user's command.

The speaker 185 is provided to output various notifying sound or voice messages as well as audio data processed by the audio processing unit 170.

The button 191 may be one of various types of buttons such as a mechanical button, a touchpad, or a wheel that is disposed on a predetermined area on a front, a side or a rear surface of an outer part of the main body of the flexible apparatus 100. Through the button 191, various user manipulations to control the operation of the flexible apparatus 100, such as power on/off command or the like, may be input.

The USB port 192 is where a USB memory or a USB connection is connected so that various contents may be received from or transmitted to the external devices.

The camera 193 is provided to capture still images or video images according to a user's control. A plurality of cameras 193 including one or more front cameras and rear cameras may be used.

The microphone 194 is provided to receive sound including user's voice and to convert the received sound into audio data. The control unit 130 may use the user's voice input though the microphone 194 in a call process, or convert the same into audio data and store it in the storage unit 140.

If the camera 193 or the microphone 194 is provided, the control unit 130 may perform a control operation according to the user's voice input through the microphone 194 or the user's motion which is perceived through the camera 193. That is, the flexible apparatus 100 may operate in a motion control mode or a voice control mode.

For example, in a motion control mode, the control unit 130 activates the camera 193 to photograph the user, and tracks changes in the user's motion and perform controlling operations such as power on/off. In a voice control mode, the control unit 130 may operate in a voice recognition mode in which the control unit 130 may analyze a user voice input through a microphone and perform control operations according to the analyzed user voice.

Other than the above, various external input ports may be additionally provided for connection to external terminals such as a headset, a mouse, or a LAN.

The above-explained operations of the control unit 130 may be implemented according to a program stored in the storage unit 140. The storage unit 140 may store operating system (O/S) software to drive the flexible apparatus 100, various applications, data input or set in the executing of an application, or data such as content.

The control unit 130 controls the overall operation of the flexible apparatus 100 using the programs stored in the storage unit 140.

The control unit 130 includes a random-access memory (RAM) 131, a read-only memory (ROM) 132, a main central processing unit (CPU) 133, a graphic processing unit 134, a first to (n)th interfaces 135-1˜135-n, and a bus 136.

The RAM 131, the ROM 132, the main CPU 133, and the first to (n)th interfaces 135-1˜135-n may be connected to each other via the bus 136.

The first to (n)th interfaces 135-1˜135-n may be connected to the components explained above. One of the interfaces 135-1˜135-n may be a network interface which is connected to an external device via network.

The main CPU 133 accesses the storage unit 140 and performs booting using the operating system (O/S) stored in the storage unit 140. The main CPU 133 also performs various operations using the programs, contents or data stored in the storage unit 140.

The ROM 132 stores command language set for the system booting. When electricity is supplied in response to a turn-on command, the main CPU 133, according to the command language stored on the ROM 132, copies the stored O/S of the storage unit 140 onto the RAM 131 and executes the O/S to boot the system. When booting is completed, the main CPU 133 copies the application programs of the storage unit 140 onto the RAM 131, and executes the application programs copied onto the RAM 131 to perform various operations.

The graphic processing unit 134 constructs various screens according to control of the main CPU 133. To be specific, the graphic processing unit 134 may display a screen as illustrated in FIGS. 13 to 27. The graphic processing unit 134 calculates a display status value with respect to the screen. The term “display status value” may refer to an attribute value such as a coordinate value of a location at which an object is to be displayed on the screen, or shape, size or color of the object. When the display status value is calculated, the graphic processing unit 134 performs rendering based on the calculated result to generate a screen.

The constitution of the flexible apparatus according to one exemplary embodiment is illustrated in FIG. 28. However, various other embodiments may be implemented. For example, some of the components illustrated in FIG. 28 may be omitted or varied, and it is also possible that other components are added.

As explained above, the control unit 130 may perform various operations by executing the programs stored in the storage unit 140.

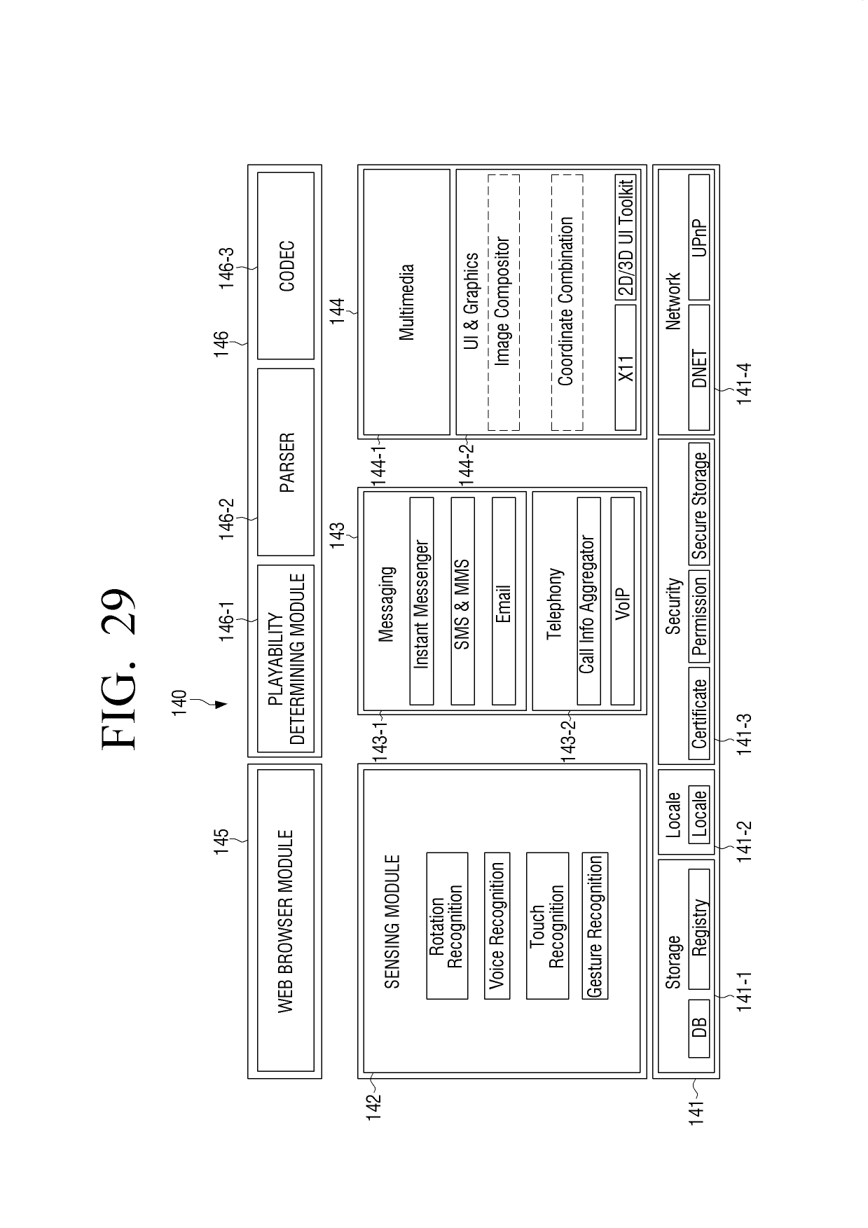

FIG. 29 is a view provided to explain a software hierarchy stored in the storage unit. Referring to FIG. 29, the storage unit 140 may include a base module 141, a sensing module 142, a communicating module 143, a presentation module 144, a web browser module 145, and a content processing module 146.

The base module 141 processes signals transmitted from the respective hardware of the flexible apparatus 100 and transmits the signals to the upper layer modules.

The base module 141 may include a storage module 141-1, a location-based module 141-2, a security module 141-3, and a network module 141-4.

The storage module 141-1 is a program module which manages a database (DB) or registry. The main CPU 133 may access the database in the storage unit 140 using the storage module 141-1 to read various data. The location-based module 141-2 is a program module which supports the location-based service in association with hardware such as a GPS chip, or the like. The security module 141-3 is a program module that supports certification, permission, and secure storage of hardware, and the network module 141-4 supports network connection and includes DNET module or universal plug and play (UPnP) module.

The sensing module 142 is provided to manage and use information obtained through external input and from one or more external devices. The sensing module 142 includes a rotation recognition module, a voice recognition module, a touch recognition module, and a gesture recognition module. The rotation recognition module is a program that calculates an angle of rotation and a direction of rotation using the sensed values obtained by a sensor such as the terrestrial magnetism sensor 121, or the gyro sensor 122. The voice recognition module is a program to analyze a voice signal, collected by the microphone 194, to extract user's voice; the touch recognition module is a program to detect touch coordinates using the information obtained by the touch sensor 124; and the gesture recognition module is a program to recognize a user's gesture by analyzing an image photographed by the camera 194.

The communicating module 143 is provided to implement external communication. The communicating module 143 may include a messaging module 143-1 such as a messenger program, a short message service (SMS) and a multimedia message service (MMS) program, or an e-mail program, and a telephone module 143-2 including a call info aggregator program module, or a VoIP module.

The presentation module 144 is provided to construct a display screen. The presentation module 144 includes a multimedia module 144-1 to play back and output content, and a UI & graphic module 144-2 to perform graphic processing. The multimedia module 144-1 may include a player module, a camcorder module, or a sound processing module. Accordingly, the presentation module 144 performs operations of playing back contents to generate screen and sound and playing the same. The UI & graphic module 144-2 may include an image composition module which combines images, a coordinate combining module which combines and displays coordinates on a screen on which an image is to be displayed, an X11 module which receives an event from the hardware, or a 2D/3D user interface (UI) toolkit which provides tools to construct 2D or 3D UIs.

The web browser module 145 accesses a web server by performing web browsing. The web browser module 145 may include a web view module, a download agent module, which performs downloading, a bookmark module, a WebKit module, or various other modules.

The content processing module 146 is software that processes the content stored in the storage unit 140. A playability determining module 146-1 is a program which operates with an algorithm of comparing playability information with the content attribute. A parser 146-2 and a codec 146-3 are software that are provided to the video processing unit 175 for content processing. The parser 146-2 is generally implemented as software, while the codec 146-3 may be implemented as software or hardware.

Other than those mentioned above, additional application modules such as a navigation service module or a game module may be further provided.

The program modules illustrated in FIG. 29 may be partially omitted, modified or added depending on the type and characteristics of the flexible apparatus 100. For example, if a smartphone is implemented as the flexible apparatus 100, an electronic book application, a game application and other utility programs may be further provided. Further, some of the program modules illustrated in FIG. 29 may be omitted.

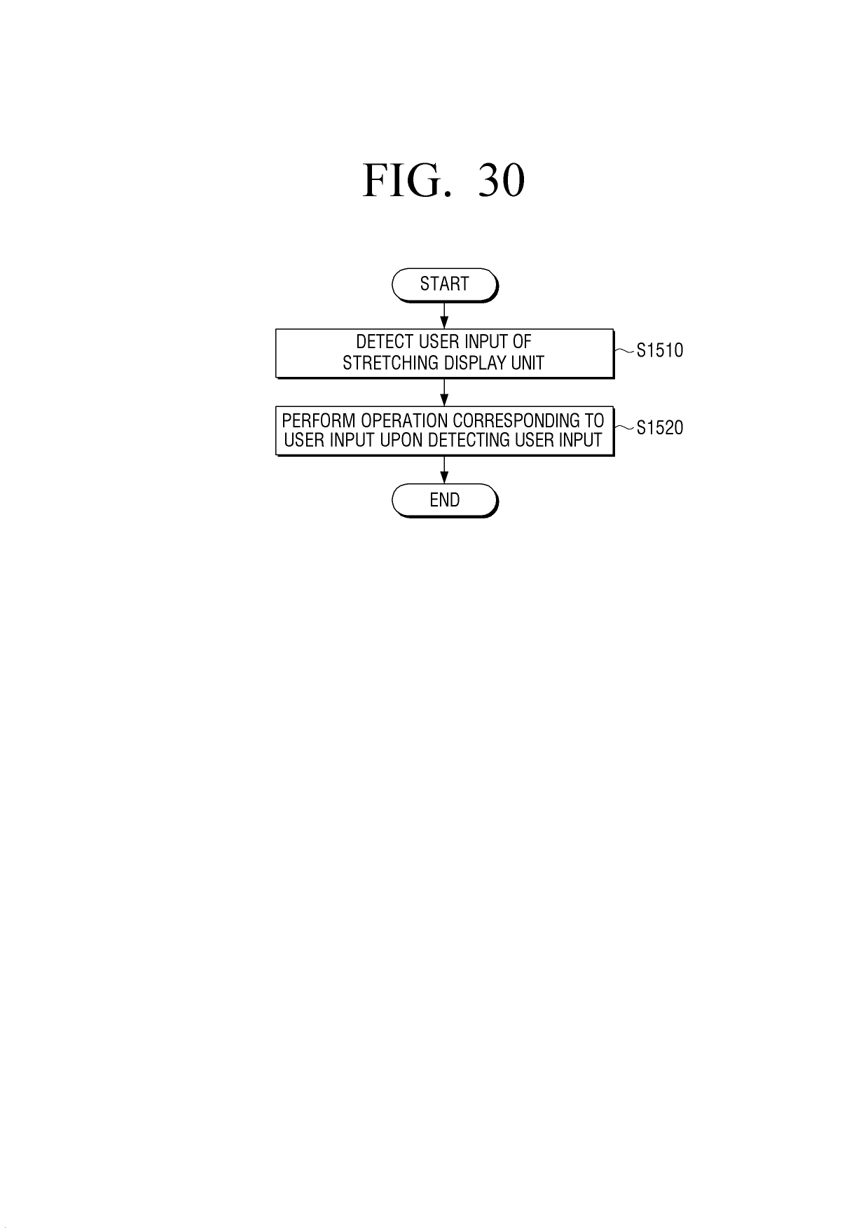

FIG. 30 is a flowchart provided to explain a control method of a flexible apparatus having a display unit according to an exemplary embodiment.

First, at S1510, a user input which stretches the display unit is detected.

That is, the user's gripping of the flexible apparatus and user's touching of the display unit are detected. Specifically, when a user's grip is detected in only a single location. and the location of the touch area moves, it may be determined that a single stretching manipulation is made. Further, if one of the plurality of strain gauges disposed on the edge of the flexible apparatus detects a tension force, it may be determined that the single stretching manipulation is made.

When a plurality of touch areas are formed on the display unit in response to the user's grip, and the plurality of touch areas are moved gradually in opposite directions, it may be determined that an overall stretching manipulation is made. Further, if a plurality of strain gauges disposed on the edge area of the flexible apparatus detect tension force, it may be determined that the overall stretching manipulation is made.

At S1520, if a user input is detected, one or more operations corresponding to the user input is performed.

To be specific, if a single stretching manipulation is detected, the screen displayed on the display unit may be moved in the direction of the single stretching manipulation and may be made to disappear off an edge of the screen while a new screen may appear from an opposite edge of the screen and may then be moved in the direction of the single stretching manipulation. This is explained above mainly with reference to FIGS. 26 and 27.

Alternately, a mode of the screen may be changed when an overall stretching manipulation is made.

The display form of an object included in the screen may be changed when an overall stretching manipulation is made.

The screen displayed on the display unit may be enlarged at a preset rate and displayed, when an overall stretching manipulation is made.

When an overall stretching manipulation is made, the screen displayed on the display unit may be divided into halves so that the divided areas may be gradually spaced apart from each other to be finally removed, while a new screen may appear on an area defined between the divided areas.

The above is explained in detail above with reference to FIGS. 13 to 25.

Further, a non-transitory computer readable medium may be provided, which stores thereon a program to execute a control method as described herein according to an exemplary embodiment in a sequential manner.

The non-transitory computer readable medium may refer to a medium which is capable of storing data semi-permanently and reading the data by a device, rather than a medium such as a register, cache, or memory which stores the data for a short period of time. To be specific, the applications or programs explained above may be stored on the non-transitory computer readable medium and provided, and the non-transitory computer readable medium may include, for example, a CD, a DVD, a hard disk, a Blu-ray disk, a USB, a memory card, or a ROM.

Further, although a bus is not specifically illustrated in the accompanying block diagram, one will understand that communication among the respective components of the flexible apparatus may be conducted via a bus. Further, the flexible apparatus may additionally include a processor such as a CPU, or a microprocessor to perform the above-explained operations.

In the particular exemplary embodiments explained above, operations may be conducted in response to a stretching of the flexible apparatus. Alternatively, the corresponding operation of the flexible apparatus may be performed in response to various other types of user manipulations and this will be explained in detail below.

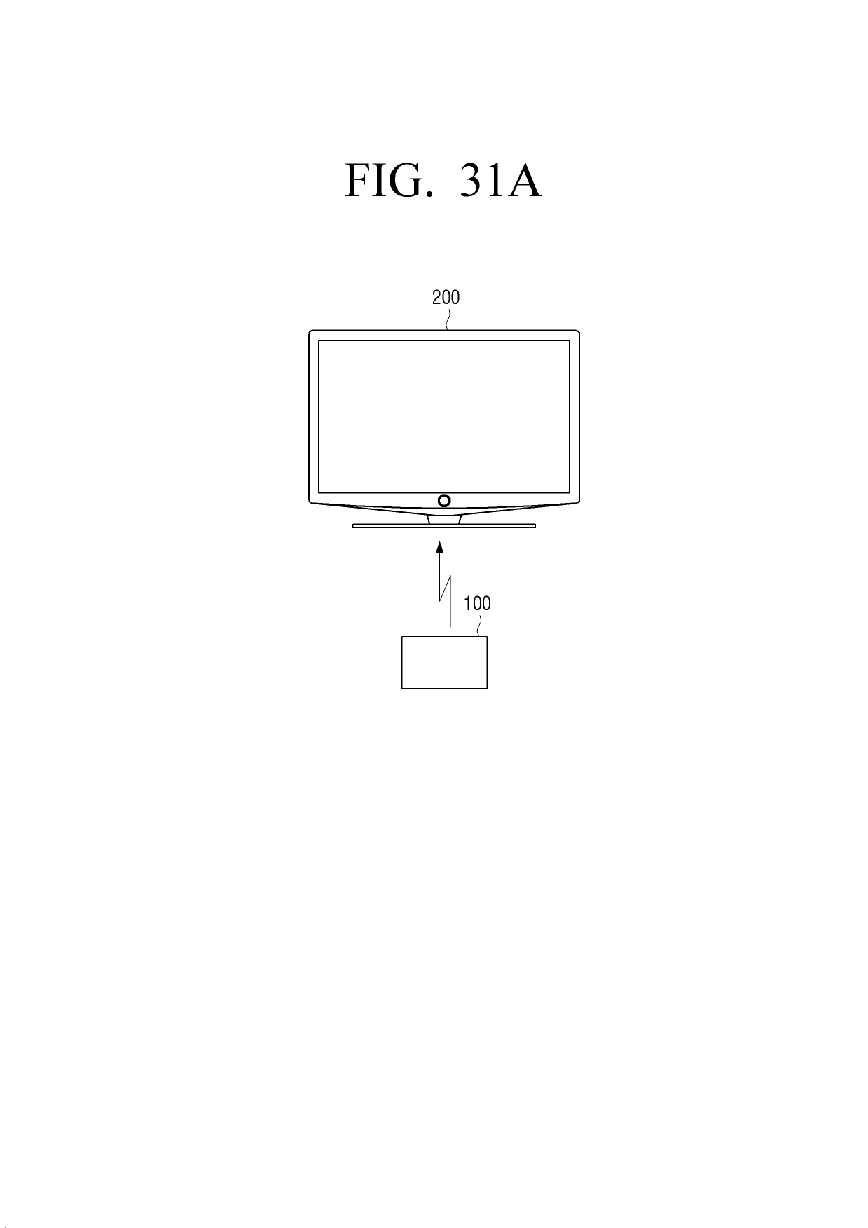

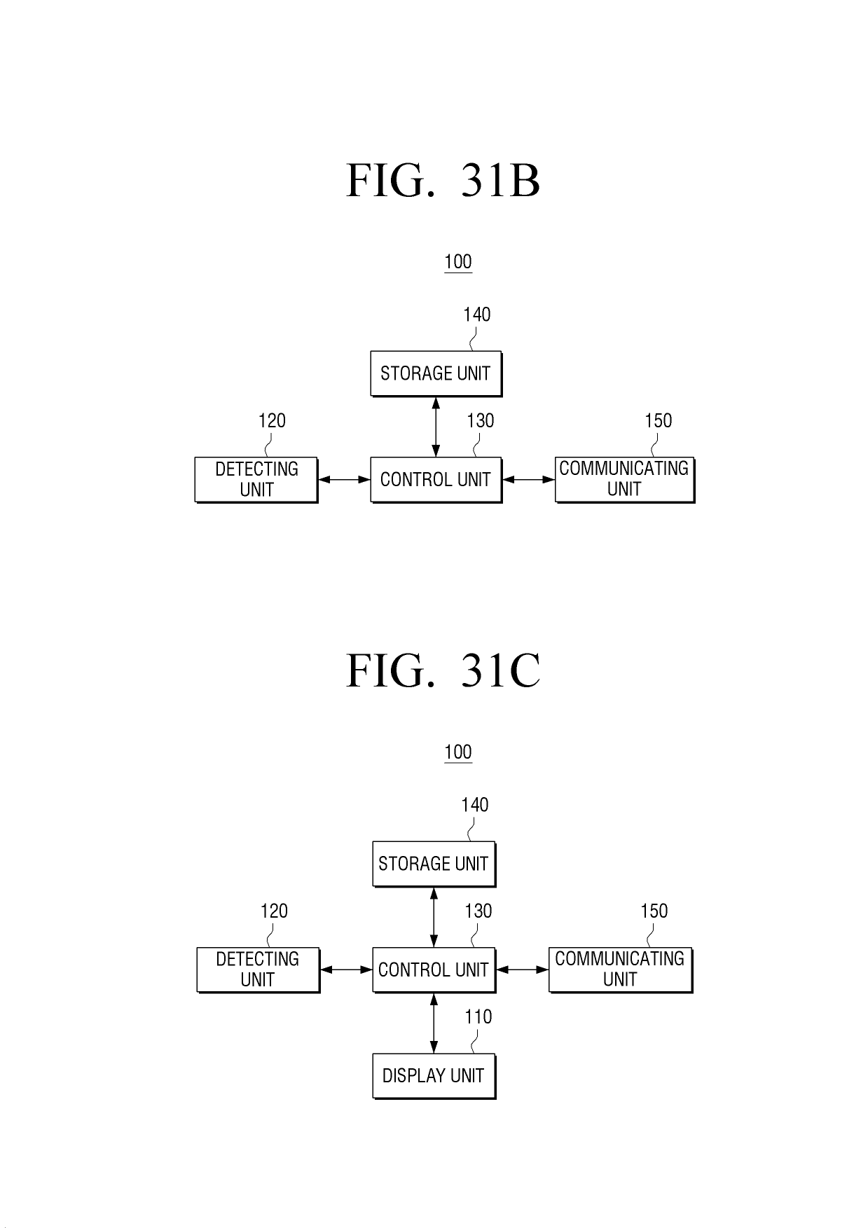

FIGS. 31A-31C illustrate constructions of flexible apparatuses according to an exemplary embodiment.

Referring to FIG. 31A, the flexible apparatus 100 may be connected to the display apparatus 200 in a wired or wireless manner. As explained above, the flexible apparatus 100 may be formed from a flexible material. The flexible apparatus 100 may be particularly formed from a material with resiliency (or elasticity) such as urethane, silicone rubber, or elastic rubber so as to be deformed in response to an externally-exerted force and returned to the original state. The flexible apparatus 100 may be formed from other material with resiliency and recovery force in addition to urethane, silicone rubber or elastic rubber.

The display apparatus 200 may be implemented as a general display apparatus which is non-flexible. For example, the display apparatus 200 may be a TV, a smartphone, a tablet, an e-frame, a monitor, a billboard or other types of display apparatuses.

It is possible to operate the flexible apparatus with a remote control apparatus intended to control the display apparatus 200. In response to a user's manipulation to control the display apparatus 200, the flexible apparatus 100 may transmit a control signal to the display apparatus 200 corresponding to an input user manipulation.

The flexible apparatus 100 may detect user manipulations such as stretching, pushing, squashing, or stroking or petting, and transmit a corresponding signal to the display apparatus 200. The flexible apparatus 100 may transmit a signal (a control signal) corresponding to the respective detected user's manipulations, or alternatively, may send a converted signal (control information) which is converted from a signal corresponding to the detected user's manipulation into a control command to control the display apparatus 200. This depends on whether the calculation to obtain control information from the detected signal is performed by the flexible apparatus 100 or the display apparatus 200.

The flexible apparatus 100 and the display apparatus 200 may communicate with each other by various methods of communication including, for example, Bluetooth (BT), infrared (IR), WiFi, personal area network (PAN), local area network (LAN), wide area network (WAN), wired input/output, USB, or the like. For example, if the flexible apparatus 100 and the display apparatus 200 communicate with each other by BT, the two may operate in association with each other through Bluetooth pairing. The detailed techniques related to the Bluetooth pairing are already well known in the art and therefore, will not be explained in detail below.

In response to a control signal from the flexible apparatus 100, the display apparatus 200 performs one or more operations corresponding to the control signal. The control signal may be implemented as an IR signal, or a communication signal which is transmitted through an interface such as Bluetooth, NFC, WiFi, Zigbee, or serial interface.

Meanwhile, referring to the constitution of the display unit 110 of FIG. 1, the flexible apparatus 100 may include only the flexible substrate, i.e., a form which does not include components to support a display function. That is, referring to FIG. 31B, the flexible apparatus 100 may omit the display unit 110, but may include the detecting unit 120, the control unit 130 and the storage unit 140, and may separately include a communicating unit 150 to perform communication with the display apparatus 200.

The storage unit 140 may store a command corresponding to the user's manipulation. Accordingly, on detecting a stretching, pushing, squashing or stroking or petting through the detecting unit 120, the control unit 130 may determine a command corresponding to the detected user's manipulation from the storage unit 140, and may generate a control signal corresponding to the command and transmit the same to the display apparatus 200 via the communicating unit 150. As explained above, a command corresponding to a gesture such as pushing, squashing or stroking or petting may be stored on the storage unit 140.

Accordingly, the control unit 130 transmits a control signal corresponding to the user's manipulation detected through the detecting unit 120 to the display apparatus 200, and may control the display apparatus 200 to perform an operation corresponding to the user's manipulation. In one embodiment, the flexible apparatus 100 may transmit only the sensed signal to the display apparatus 200 and the display apparatus 200 may generate the corresponding control signal based on the received detected signal.

In the particular embodiment explained above, the flexible apparatus 100 may omit the display unit 110. However, in another embodiment and referring to FIG. 31C, the flexible apparatus 100 may include the display unit 110 in addition to the detecting unit 120, the control unit 130, the storage unit 140 and the communicating unit 150. In this case, the display unit 110 may be formed from a flexible material and the detailed constitution thereof is explained above with reference to FIG. 2. Depending on desired characteristics, the display unit 110 may be formed from non-flexible material such as the same material as that of a conventional flat display unit.

The respective components illustrated in FIGS. 31B and 31C will be explained below, in which repeating parts will not be explained in detail for the sake of brevity.

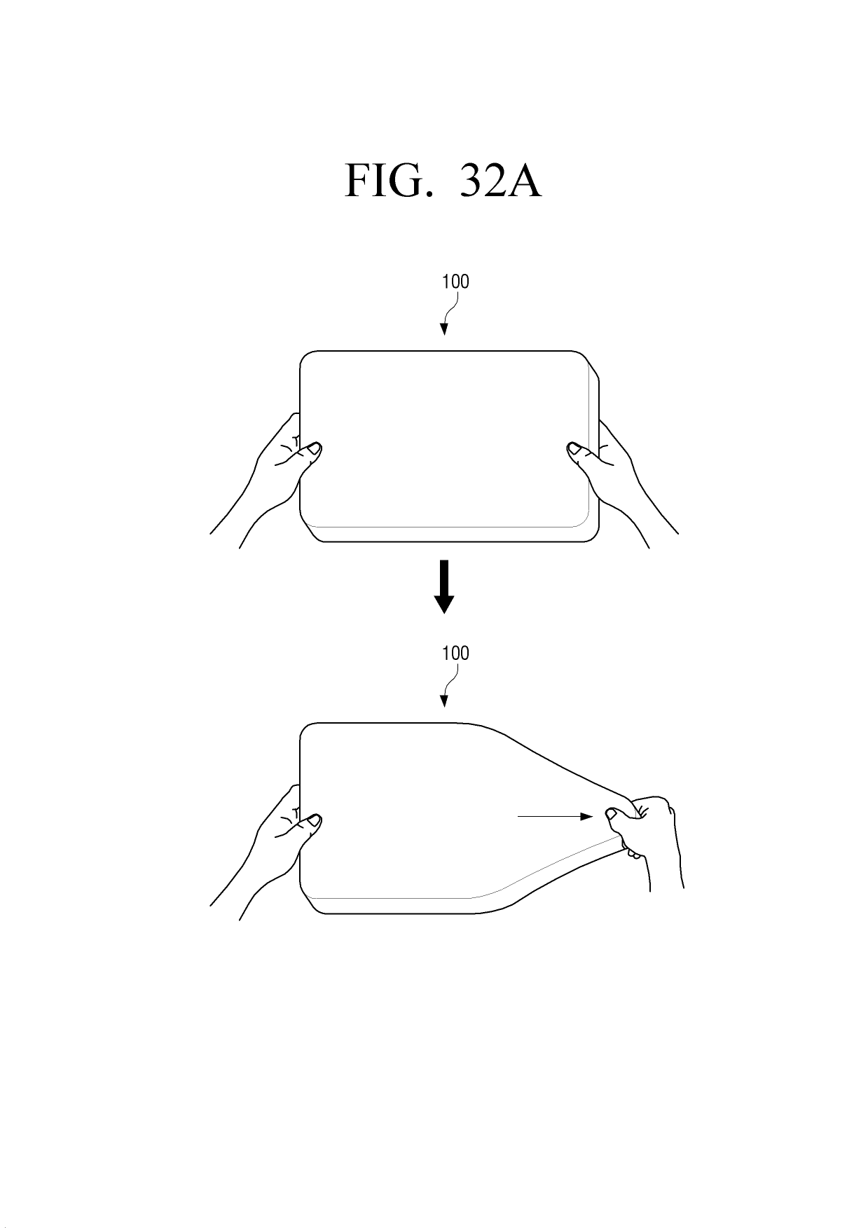

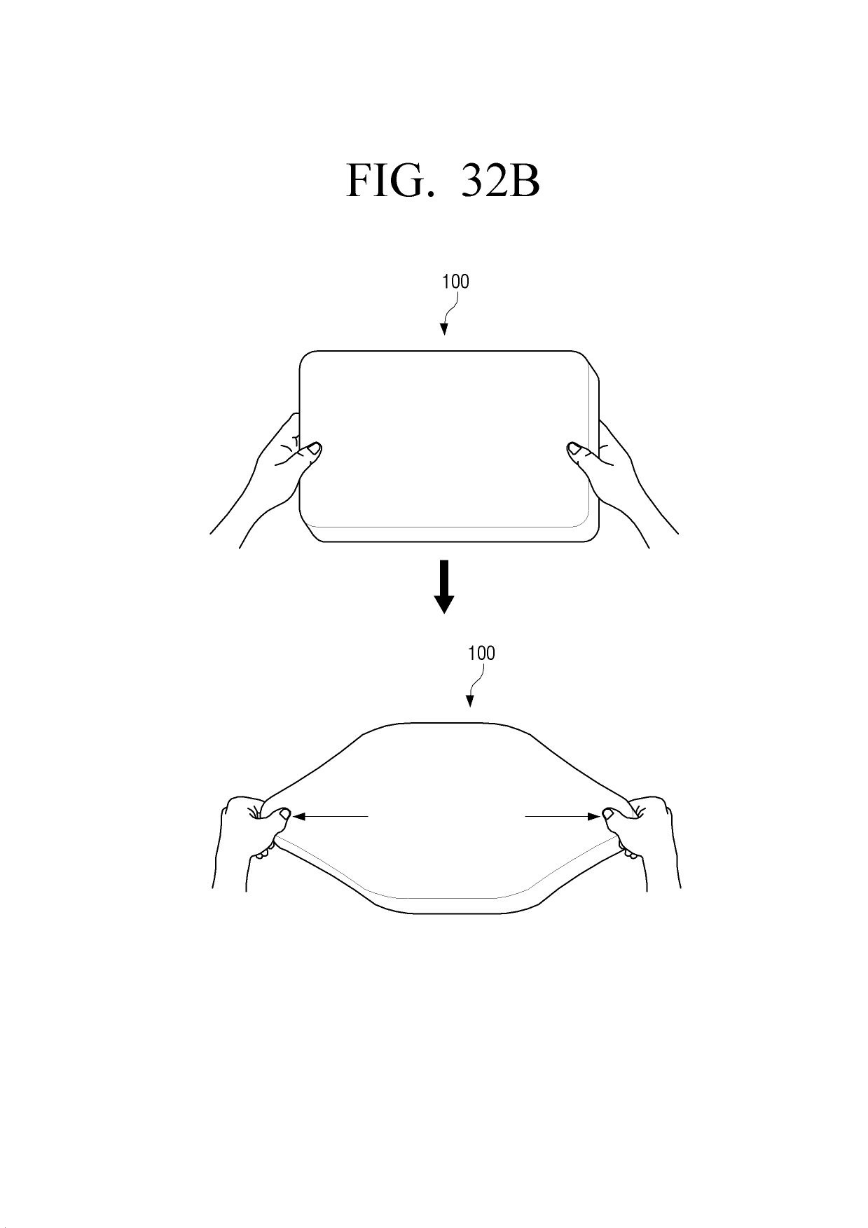

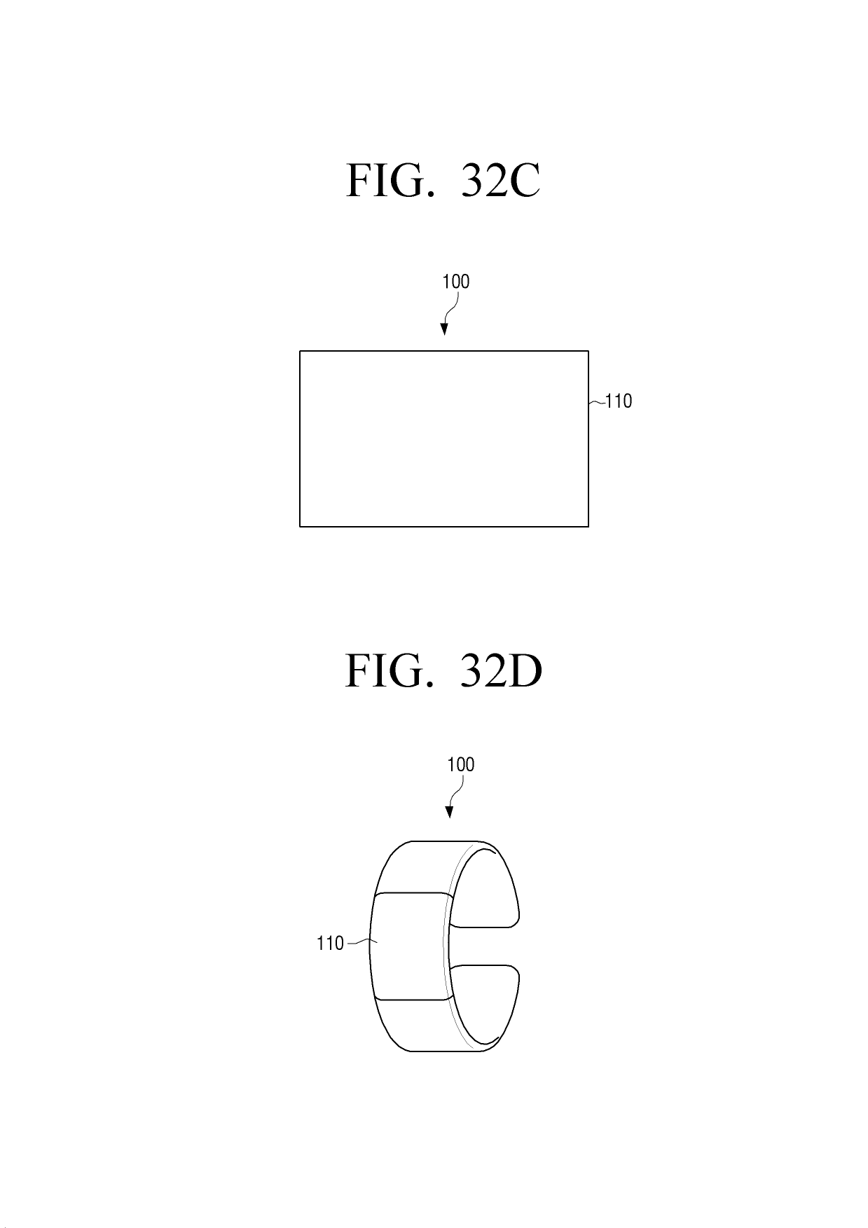

The detecting unit 120 may detect a user's manipulation made with respect to the flexible apparatus 100. To be specific, the detecting unit 120 may detect a stretching, pushing, squashing and stroking or petting of the apparatus 100. The method for detecting user's manipulation will be explained in greater detail below with reference to FIGS. 32 to 34.

FIGS. 32A-32D, 33A-33C, and 34A-34D are views provided to explain methods for detecting a user manipulations made with respect to the flexible apparatus. For convenience of explanation, the methods for detecting user manipulations will be explained according to the implemented form of the flexible apparatus 100.

First, FIGS. 32A-32D are provided to explain a method for detecting a user's stretching manipulation input with respect to the flexible apparatus 100. The stretching may be made as the user pulls on the flexible apparatus 100 and may be a single stretching manipulation in which the user grips and pulls the flexible apparatus 100 with one hand, or may be an overall stretching manipulation in which the user grips and pulls the flexible apparatus 100 with two hands.

Accordingly, referring to FIGS. 32A and 32B, if the flexible apparatus 100 is implemented as a solid figure such as a cylinder, cube or the like and does not have a function of displaying a screen, the control unit 130 may determine whether the flexible apparatus 100 is stretched or not based on the detected result obtained at a bend sensor and a pressure sensor provided on the detecting unit 120.

Accordingly, if a stretching manipulation is input to the flexible apparatus 100, referring to FIGS. 32A and 32B, the flexible apparatus 100 is stretched in accordance with the stretching manipulation. Accordingly, the bend sensor is stretched and outputs a resistance value corresponding to the degree to which it has been extended. As a result, the control unit 130 detects pressure at a plurality of areas, and upon detecting a resistance value from a bend sensor arranged among the plurality of pressure-detecting areas, may determine that a stretching manipulation is input.

The control unit 130 may determine whether a single stretching manipulation is input or whether an overall stretching manipulation is input by referring to a pattern of resistance values of the bend sensor previously stored in the flexible apparatus 100.

That is, the flexible apparatus 100 may store, in advance, a pattern of resistance values output from the bend sensor when a single stretching manipulation is made and when an overall stretching manipulation is made with respect to the flexible apparatus 100. The flexible apparatus 100 may store the pattern of resistance values corresponding to the respective stretching manipulations based on locations of the plurality of areas where the pressure is exerted, and the exerted pressures.

Accordingly, the control unit 130 may determine whether the stretching manipulation input to the flexible apparatus 100 is a single stretching manipulation or an overall stretching manipulation by using the pattern of the resistance values which may be matched with a resistance value output from the bend sensor.

Meanwhile, the control unit 130 may determine whether a single stretching manipulation is input or an overall stretching manipulation is input based on a result of a detection by an acceleration sensor provided at the detecting unit 120. If a single stretching manipulation is input, the flexible apparatus 100 extends in one direction, while the flexible apparatus 100 extends in both directions if an overall stretching manipulation is input. Accordingly, using a detected result by the acceleration sensor provided at the respective edge areas of the flexible apparatus 100, the control unit 130 may determine that a single stretching manipulation is input if one of a plurality of pressure-detecting areas is moved, while determining that an overall stretching manipulation is input if a plurality of pressure-detecting areas are moved.

IF the flexible apparatus 100 includes a flat type display unit 110 (FIG. 32C) or if the flexible apparatus 100 having the display unit 110 is implemented as a bangle type (FIG. 32D), the control unit 130 may determine whether or not a stretching manipulation is input by the method illustrated in FIGS. 5 to 12. The detecting method is explained above in detail with reference to FIGS. 5 to 12 and will not be explained additionally for the sake of brevity.

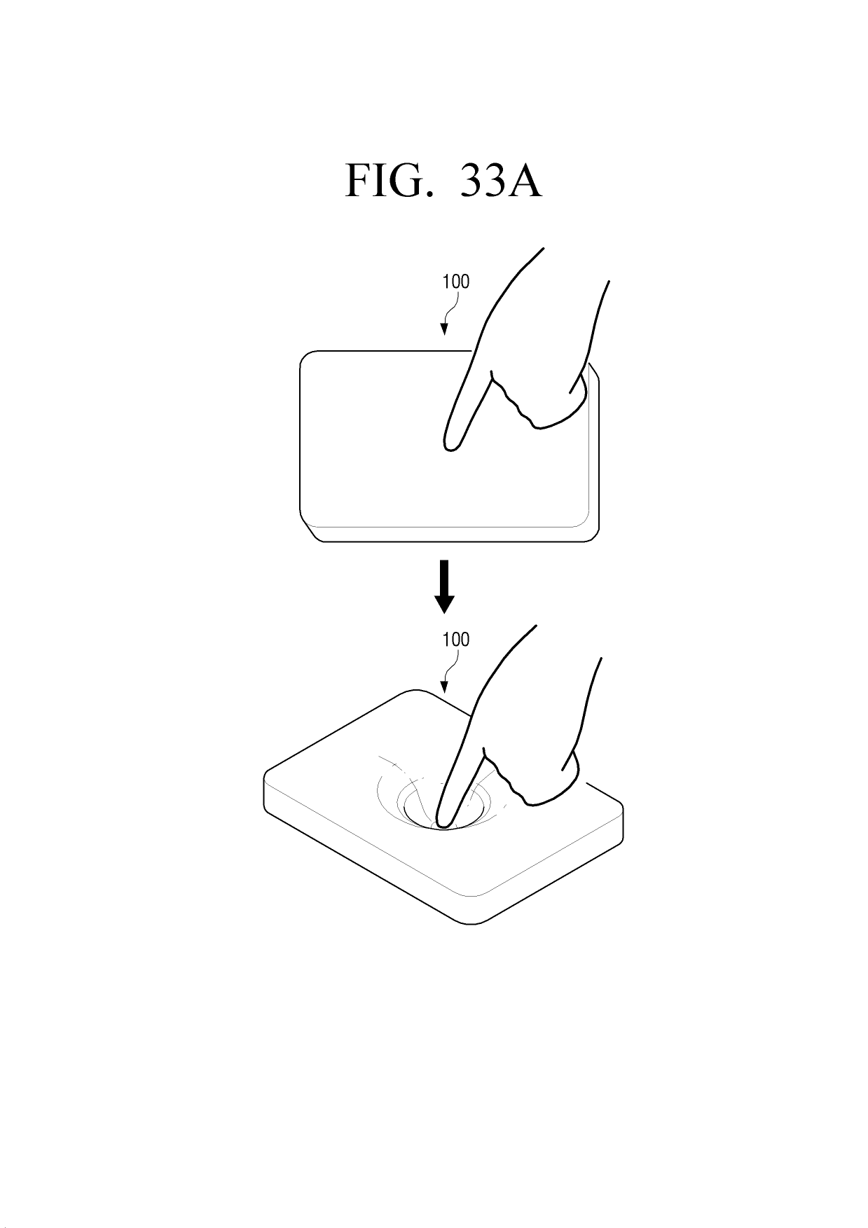

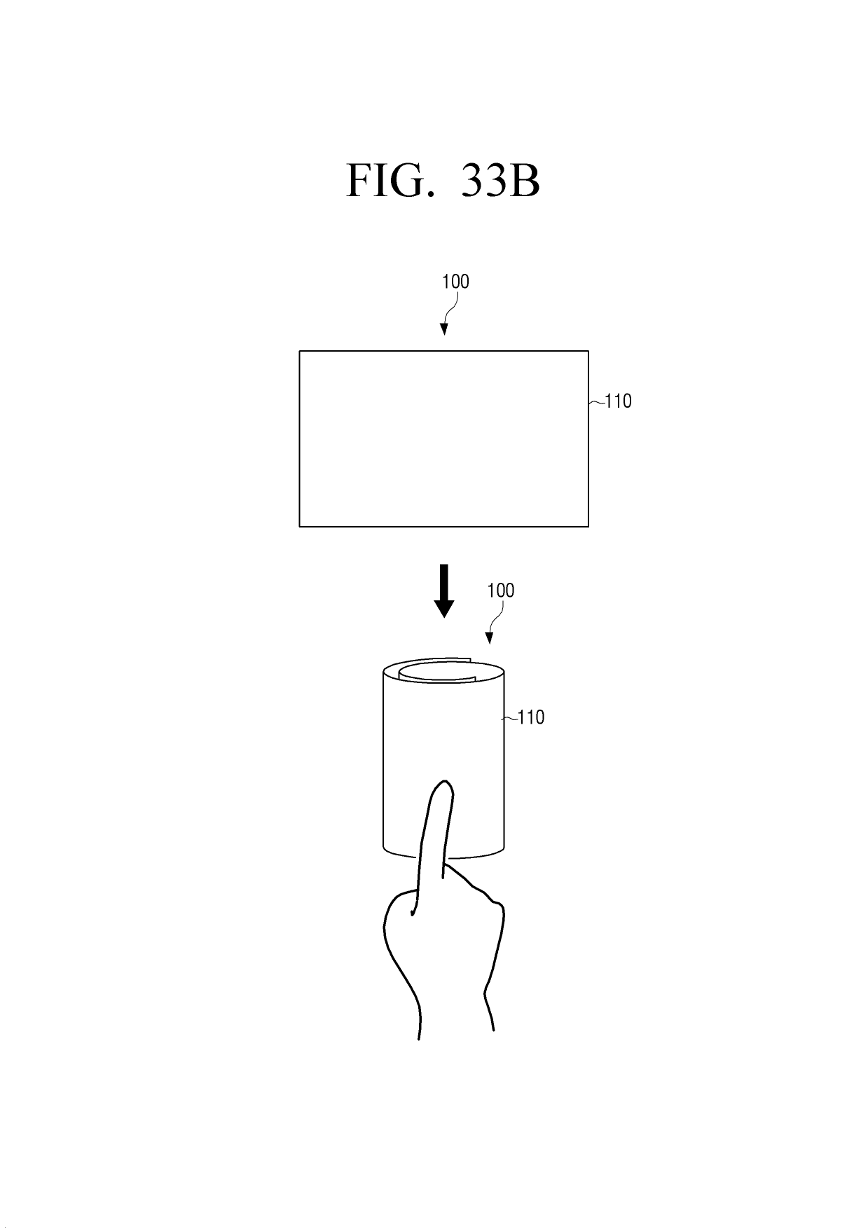

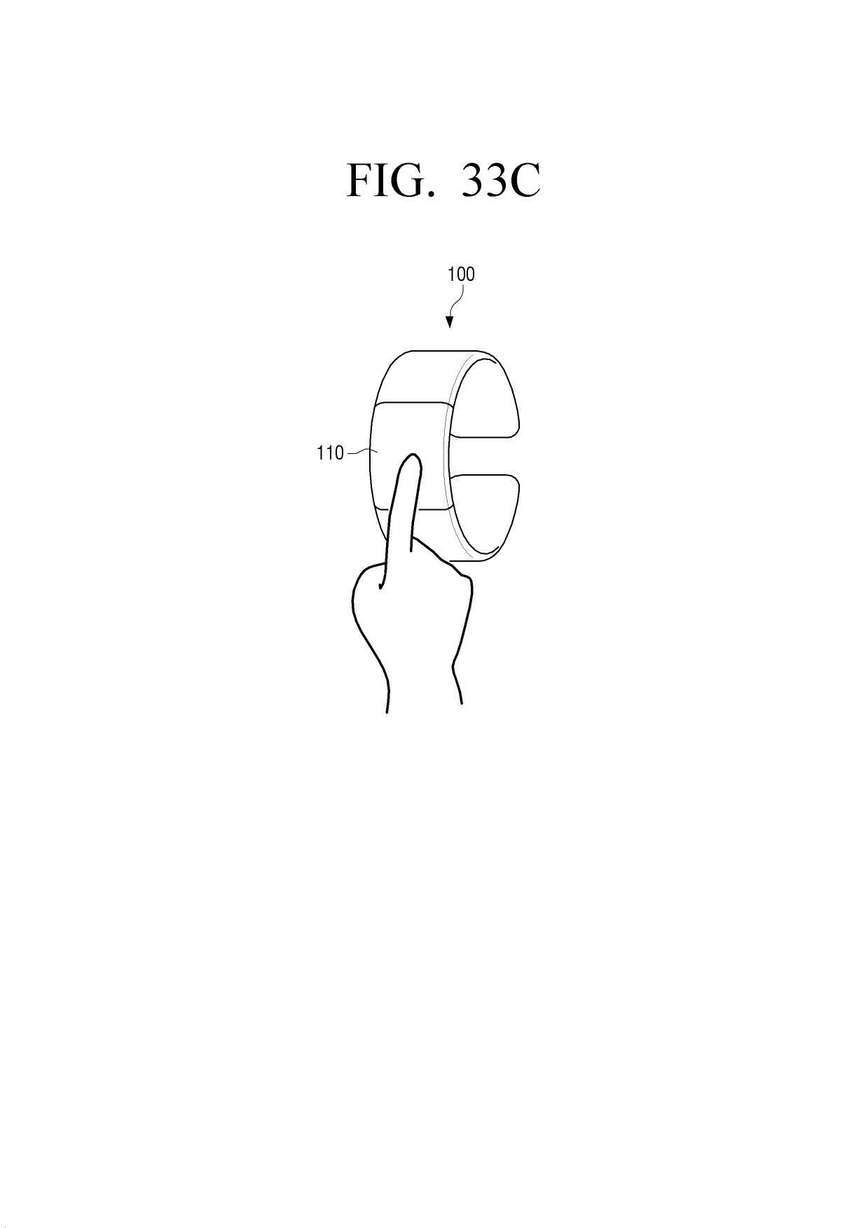

FIGS. 33A-33C are provided to explain methods for detecting a pushing manipulation input to the flexible apparatus 100. The term “pushing manipulation” as used herein may refer to a user's manipulation made by pushing the flexible apparatus 100 with the user's fingertip or with a stylus. The control unit 130 may determine that a pushing manipulation is input to the flexible apparatus 100 based on the result of a detection by the pressure sensor or the bend sensor provided in the detecting unit 120.

For example, referring to FIG. 33A, if the flexible apparatus 100 is implemented in an integrated form which does not have a function of displaying a screen, the flexible apparatus 100 may be pushed inward at a predetermined portion in response to a pushing manipulation and then may return to original state.

Accordingly, upon detecting a pressure exceeding a preset degree at one area of the flexible apparatus 100, the control unit 130 may determine that a pushing manipulation is input. The term “preset degree of pressure” may refer to a pressure that can deform one area of the flexible apparatus 100 to a concaved form and this may be set depending on the material or shape of the flexible apparatus 100. The control unit 130 may determine that a pushing manipulation is input when detecting a pressure exceeding the preset degree for more than a preset time.

Because the area pushed by the user is made to be concave, the bend sensor arranged at the pushed area is extended accordingly. Accordingly, the control unit 130 may determine that a pushing manipulation is input if a bend sensor arranged at a certain area outputs a resistance value larger than that output in an original state.

If the flexible apparatus 100 has a flat type display unit 110 as illustrated in FIG. 33B, the control unit 130 may determine that a pushing manipulation is input when detecting a pressure exceeding a preset degree at one area of the display unit 110 in a state in which the flexible apparatus 100 is in a rolled state. Again, the control unit 130 may determine that a pushing manipulation is input when detecting a pressure exceeding a preset degree for more than a preset time.

The term “rolled state” as used herein refers to a state in which the display unit 110 is rolled up. For example, it may be called the “rolled state” when bending exceeding a predetermined angle is detected over more than a predetermined area. Further, it may also be called the “rolled state” when the cross section of the display unit 110 in the bent state is close to the shape of a circle.

While a few definitions of the term “rolled state” have been provided above, one will understand that different definitions are applicable depending on the type, size, weight and characteristics of the flexible apparatus 100. For example, if the flexible apparatus 100 is flexible enough to bend until two opposite ends meet, the term “rolled state” will then be when a front end and a rear end of the flexible apparatus 100 are brought into contact with each other due to bending movement.

The detecting unit 120 may detect the rolling characteristic of the display unit 110 using a bend sensor. The display unit 110 may be rolled up with respect to one axis, and this axis (i.e., rolling axis) may be a line that is extended through the center of the circle formed by the display surface. The term “rolling characteristic” as used herein may refer to at least one of radius of cross section, size of exposed area, location and shape. The radius of cross section may be an average of a radius of an innermost surface in rolled state and a radius of an outermost surface in rolled state, or the radius of cross section may be a radius of the outermost surface in rolled state. Further, if there are a plurality of rolled areas on the display unit 110, the detecting unit 120 may detect the rolling characteristic that corresponds to the plurality of rolled areas, respectively.

Accordingly, the detecting unit 120 may include a bend sensor or a strain gauge. That is, because the display unit 110 in a rolled state has an area bent to a predetermined curvature, forces that are approximate to each other are exerted on the bend sensors or the strain gauges within a predetermined range. Accordingly, the control unit 130 may determine that the display unit 110 is rolled up when the resistance values output from the bend sensors or the strain gauges are approximate to each other within a predetermined range that is greater than a preset value.

The control unit 130 may calculate a radius of a cross section of the display unit 110 in rolled state based on the detected result of the detecting unit 120. The radius of cross section may be an average of a radius of an innermost surface in rolled state and a radius of an outermost surface in rolled state, or the radius of cross section may be a radius of the outermost surface in rolled state.

Because the radius of the cross section is formed as the display unit 110 is rolled up, the length of the radius of the cross section is influenced by the degree of rolling. That is, the radius of cross section decreases as the degree of rolling increases, and the radius of cross section increases as the degree of rolling decreases.

Accordingly, the flexible apparatus 100 may previously store the radius of cross section corresponding to each of degree of rolling, and calculate the radius of cross section in rolled state by detecting a radius of cross section that matches the resistance value output from the bend sensor or the strain gauge when the display unit 110 is in rolled state.

The display unit 110 has a property that, once the display unit 110 is deformed by the externally-exerted force, the display unit 110 tends to return to a flat state due to the elasticity thereof. Accordingly, the flexible apparatus 100 may maintain the display unit 110 in rolled state by using an actuator (not illustrated).

For example, the actuator (not illustrated) may be implemented as a plurality of polymer films arranged on the display unit 110. The polymer films may be dielectric elastomers from the silicone or urethane families. Electrodes are applied on opposite sides of the polymer film and change forms in accordance with a potential difference of a voltage applied to the respective electrodes. For example, if a predetermined voltage is applied on the polymer film, the upper portion of the polymer film may be constricted while the lower portion may be extended. Accordingly, once the display unit 110 is rolled, the control unit 130 may maintain the display unit 110 in rolled state by applying a voltage on the polymer film arranged on the rolled area.

Meanwhile, if the flexible apparatus 100 having the display unit 110 is implemented as a bangle type (FIG. 33C), the control unit 130 may determine that a pushing manipulation is input, when detecting a pressure exceeding a preset degree at one area of the flexible apparatus 100. The control unit 130 may determine that a pushing manipulation is input when detecting a pressure exceeding a preset degree for more than a preset time period.

The control unit 130 may also determine that a pushing manipulation is input, if detecting a pressure exceeding a preset degree at a preset area of the bangle type flexible apparatus 100. The preset area may be an upper or a lower area of the bangle type flexible apparatus 100.

Meanwhile, the control unit 130 may determine pushing manipulation to the flexible apparatus 100 based on the result of detection at a touch sensor provided on the detecting unit 120. Referring to FIGS. 33B and 33C, if the flexible apparatus 100 includes a display screen, the control unit 130 may determine that a pushing manipulation is input when detecting an input of a touch manipulation with respect to one area on the display screen. In this case, the control unit 130 may determine that a pushing manipulation is input, when detecting an input of a touch manipulation for more than a preset time period.

For example, referring to FIG. 33B, the control unit 130 may determine that a pushing manipulation is input, when a touch manipulation is made with respect to one area on the exposed display screen of the display unit 110 in rolled state.

On the other hand, referring to FIG. 33C, if a touch manipulation is made with respect to one area on the bangle type display screen, the control unit 130 may determine that a pushing manipulation is input. In this case, the control unit 130 may determine that a pushing manipulation is input, if a touch manipulation is made with respect to a preset area of the display unit 110. The term “preset area” as used herein may refer to an upper or a lower area of the bangle type display screen.

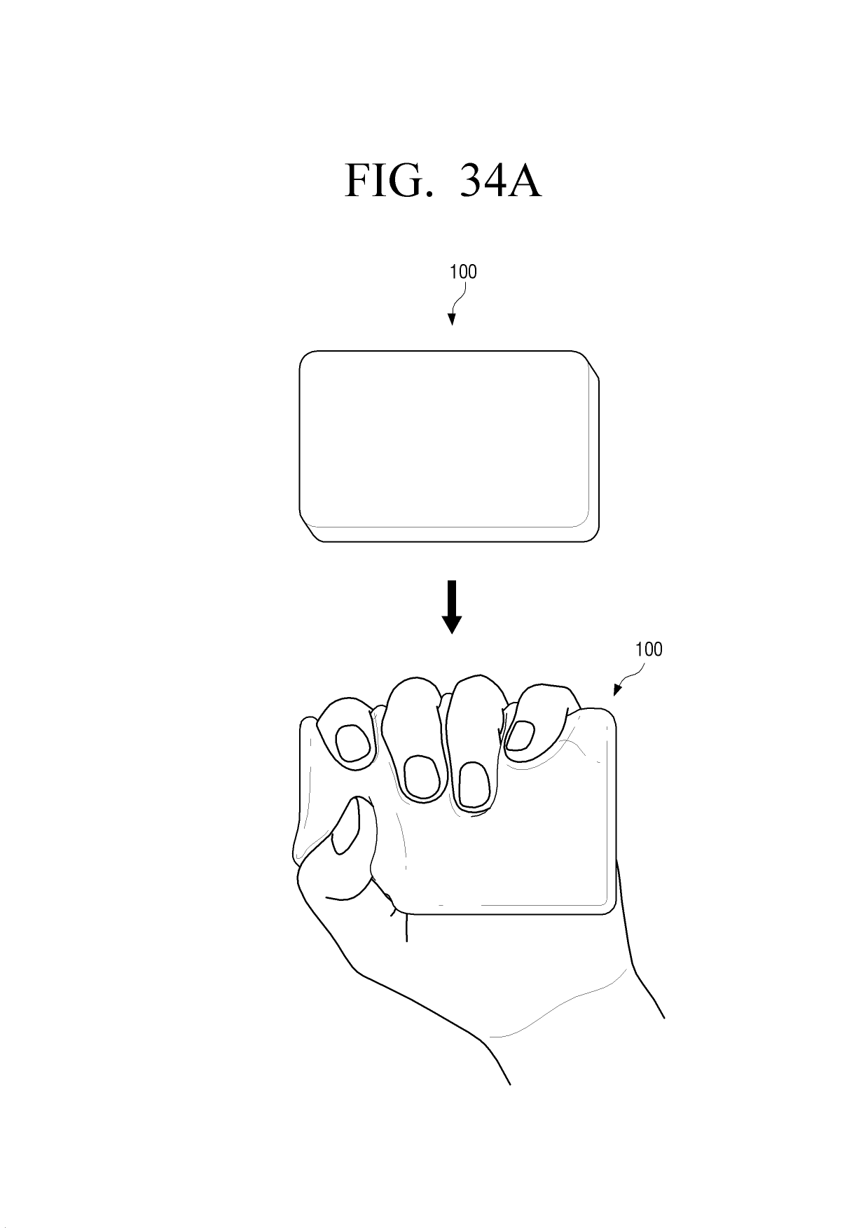

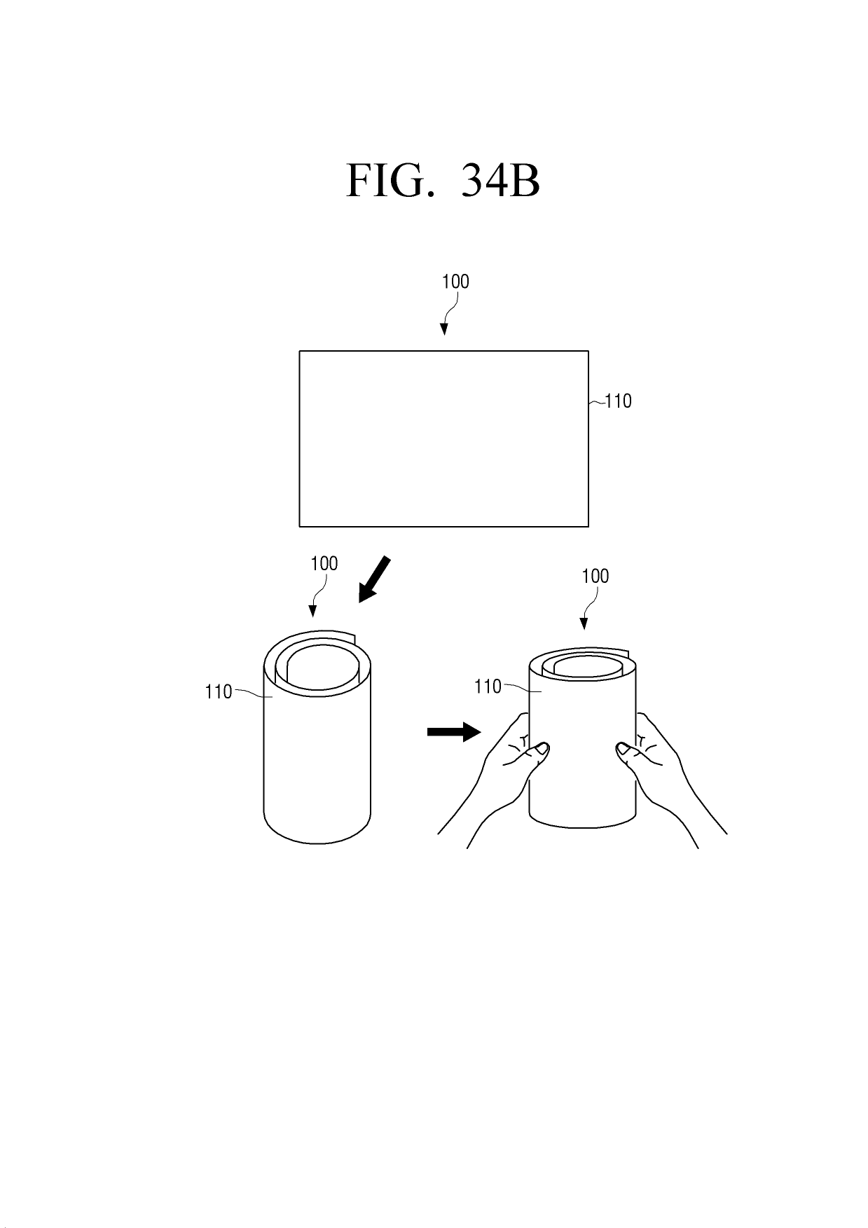

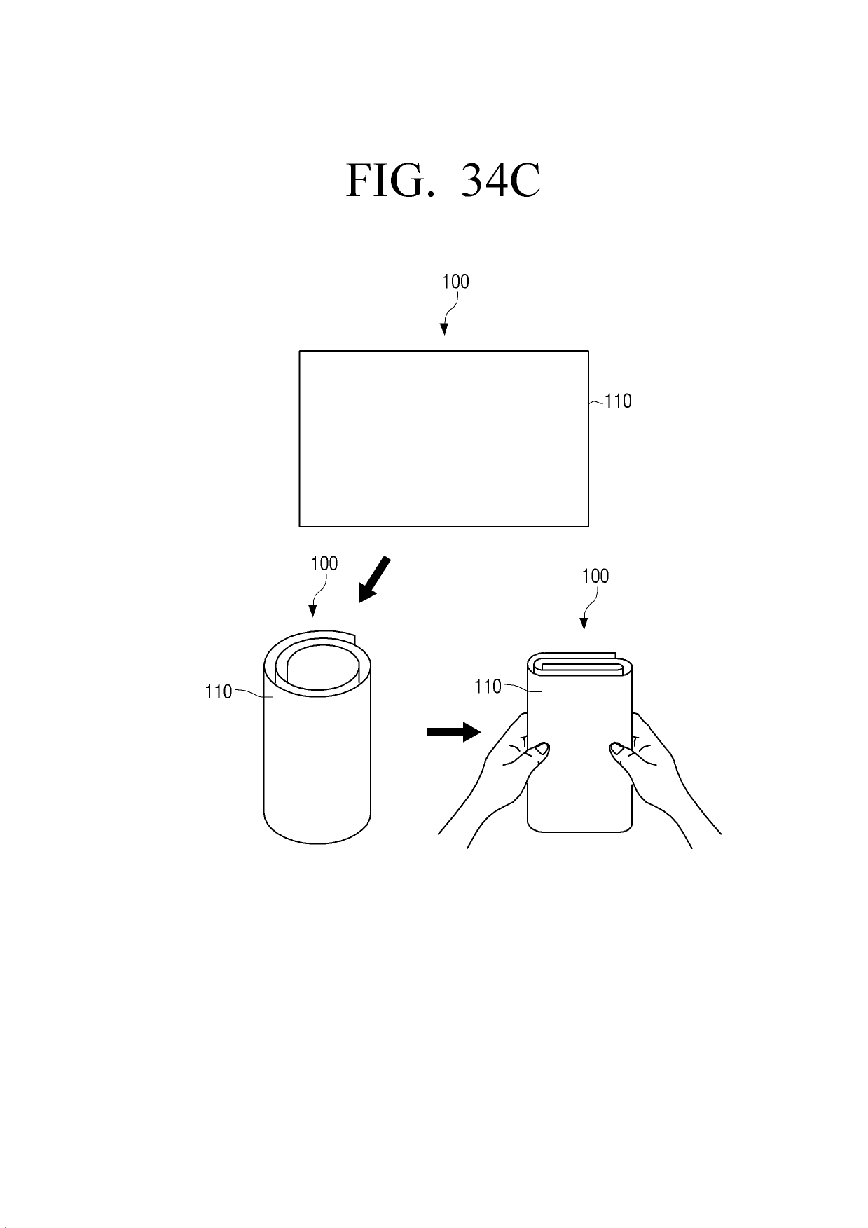

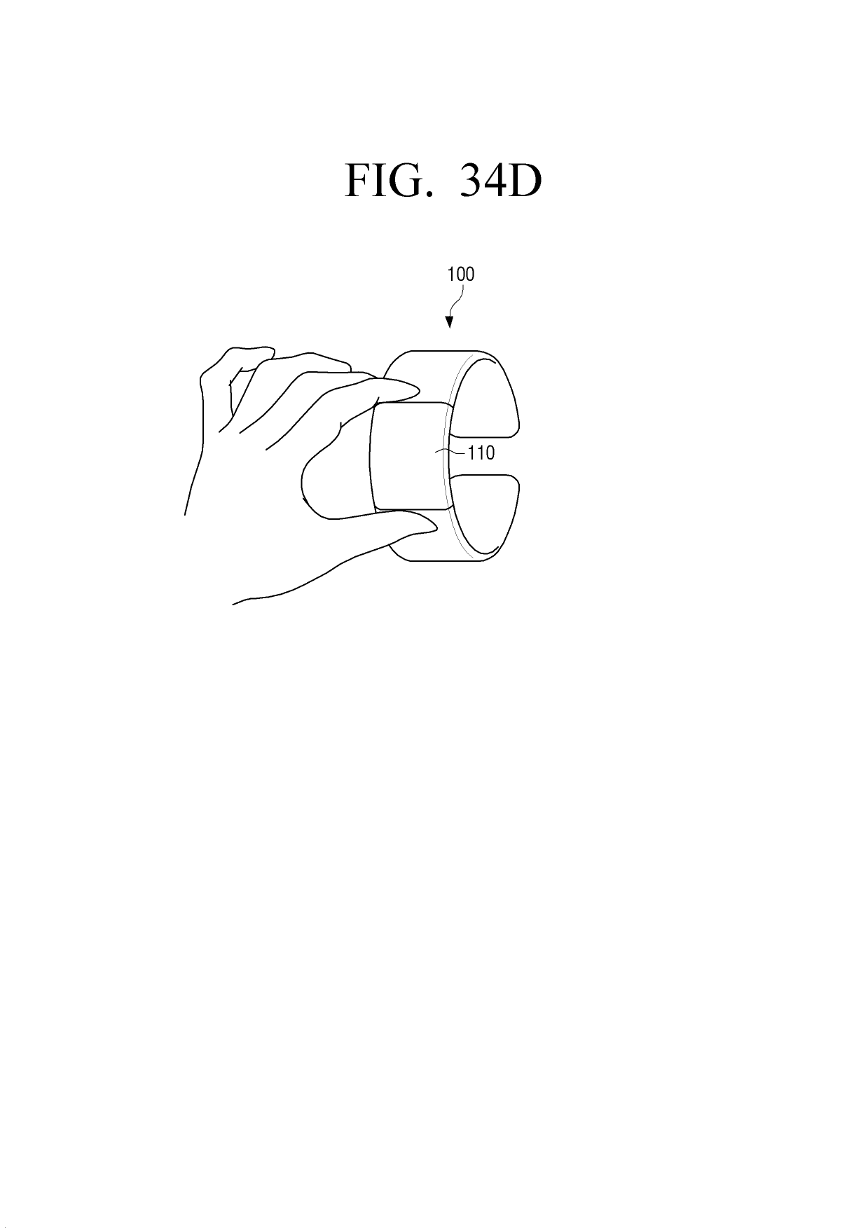

Meanwhile, FIGS. 34A-34C are views provided to explain methods for detecting a squashing manipulation input to the flexible apparatus 100. The squashing manipulation may include a motion of a user who presses a plurality of areas of the flexible apparatus 100 using one or both hands.

For example, referring to FIG. 34A, if the flexible apparatus 100 is implemented as a solid figure which does not have the function of displaying a screen, the control unit 130 may determine that a squashing manipulation is input with respect to the flexible apparatus 100 based on the result of a detection made by a bend sensor and a pressure sensor provided on the detecting unit 120.

To be specific, if a squashing manipulation is input to the flexible apparatus 100, pressure is exerted on a plurality of areas of the flexible apparatus 100 so that the respective areas under pressure are pressed inward in a concave fashion. As a result, the concaved areas are under the highest pressure, and the bend sensors arranged around the concaved areas are extended. Accordingly, the control unit 130 detects more than a preset pressure at the plurality of areas and may determine that a squashing manipulation is input when detecting a greater resistance value than that of the original state from the bend sensors arranged around the respective pressure-detecting areas.

On the other hand, the control unit 130 may determine a squashing manipulation with respect to the flexible apparatus 100 using a result of detection at the bend sensors only. The flexible apparatus 100 may store in advance a pattern of resistance values output from the bend sensors around the respective areas where the pressure is exerted when a squashing manipulation is made. Accordingly, the control unit 130 may determine that a squashing manipulation is input if a resistance value output from the bend sensors arranged around the respective pressure-exerted areas matches the preset resistance value pattern.

Referring to FIGS. 34B and 34C, if the flexible apparatus 100 has a flat type display unit 110, the control unit 130 may determine that a squashing manipulation is input when the shape of a cross section of the display unit 110 is varied in a state that the flexible apparatus 100 is rolled up.

For example, referring to FIG. 34B, if the cross section of the display unit 110 in rolled state changes from a substantially circular shape to a substantially oval shape, the control unit 130 may determine that a squashing manipulation is input. In other words, the control unit 130 may determine that a squashing manipulation is input to the flexible apparatus 100 when the bend sensors, which have output approximate resistance values within a range exceeding a preset value, now output differently so that some output greater resistance values within a predetermined range and the others output smaller resistance values within a predetermined range.

That is, when the cross section of the display unit 110 changes from a substantially circular shape to a substantially oval shape, some areas of the display unit 110 are further bent and the remaining areas are less bent than when the cross section is substantially circular. Accordingly, the resistance values output from the bend sensors are varied, and the control unit 130 may determine whether or not a squashing manipulation is input based on such changes in the resistance values output from the bend sensors.

In another example, referring to FIG. 34C, the control unit 130 may determine that a squashing manipulation is input when some areas of the display unit 110 have a curvature while the other areas are substantially planar in a state that the cross section of the display unit 110 in rolled state is substantially circular. In other words, the control unit 130 may determine that a squashing manipulation is input to the flexible apparatus 100 when the bend sensors, which have output approximate resistance values within a preset range that is greater than a preset value, now output differently so that some output greater resistance values than the previous resistance values within a predetermined range, while the others output resistance values similar to those at in original state (i.e., flat state).

That is, after the display unit 110 is rolled so that the cross section becomes substantially circular, some areas of the display unit 110 are further bent than when the cross section is substantially circular, while the other areas are changed to be substantially planar, thereby causing the bend sensors to output different resistance values. As a result, the control unit 130 may determine whether or not a squashing manipulation is input based on such changes in the resistance values output from the bend sensors.

Meanwhile, referring to FIG. 34D, if the flexible apparatus 100 having the display unit 110 is implemented as a bangle type, the control unit 130 may determine a squashing manipulation based on the result of detection at the pressure sensor provided at the detecting unit 120. To be specific, the control unit 130 may determine that a squashing manipulation is input, when detecting more than a preset pressure at a plurality of areas of the flexible apparatus 100. In this example, the control unit 130 may determine that a squashing manipulation is input, when detecting more than the preset pressure at the plurality of areas for more than a preset time period.

Further, the control unit 130 may determine that a squashing manipulation when detecting more than a preset pressure at a plurality of preset areas of the bangle-type flexible apparatus 100. The term “preset areas” as used herein may refer to upper and lower areas of the bangle-type flexible apparatus 100.

The control unit 130 may determine a squashing manipulation to the flexible apparatus 100 based on the result of detection made by the touch sensor provided on the detecting unit 120. That is, referring to FIGS. 34C and 34D, if the flexible apparatus 100 has a display screen, the control unit 130 may determine that a squashing manipulation is determined, if a touch manipulation is input with more than a preset force on the display screen. In this case, the control unit 130 may determine that a squashing manipulation is input, when the touch manipulation is input with more than a preset force for more than a preset time.

For example, referring to FIGS. 34B and 34C, the control unit 130 may determine that a squashing manipulation is input when a touch manipulation is made on the exposed display screen of the display unit 110 in rolled state with more than a preset force.

On the other hand, referring to FIG. 34D, the control unit 130 may determine that a squashing manipulation is input, when the touch manipulation is made on a plurality of areas on the bangle-type display screen with more than a preset force. The term “plurality of areas” as used herein may refer to upper or lower areas of the display unit 110.

Meanwhile, the control unit 130 in the above embodiment determines that a squashing manipulation is input when a touch manipulation is input with more than a preset force, for the sake of distinguishing from when it is determined that a pushing manipulation is input.

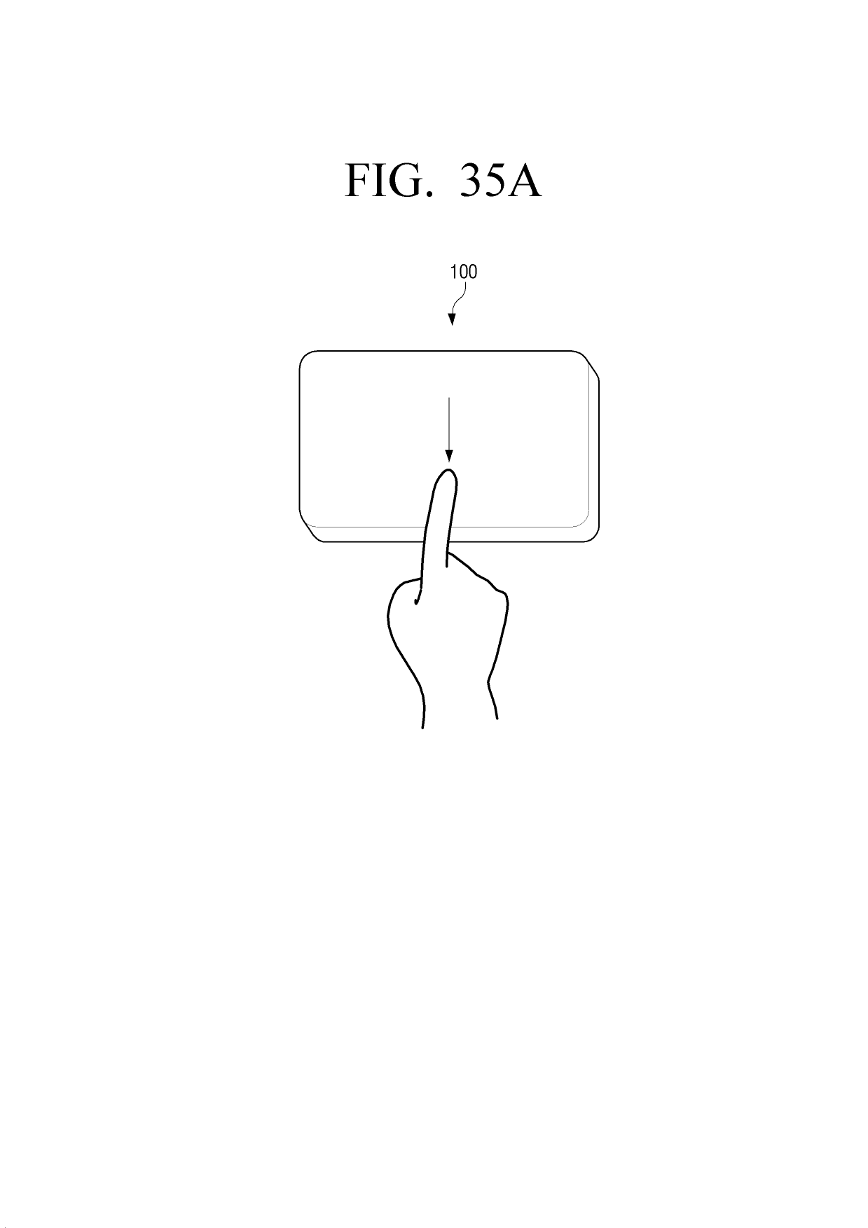

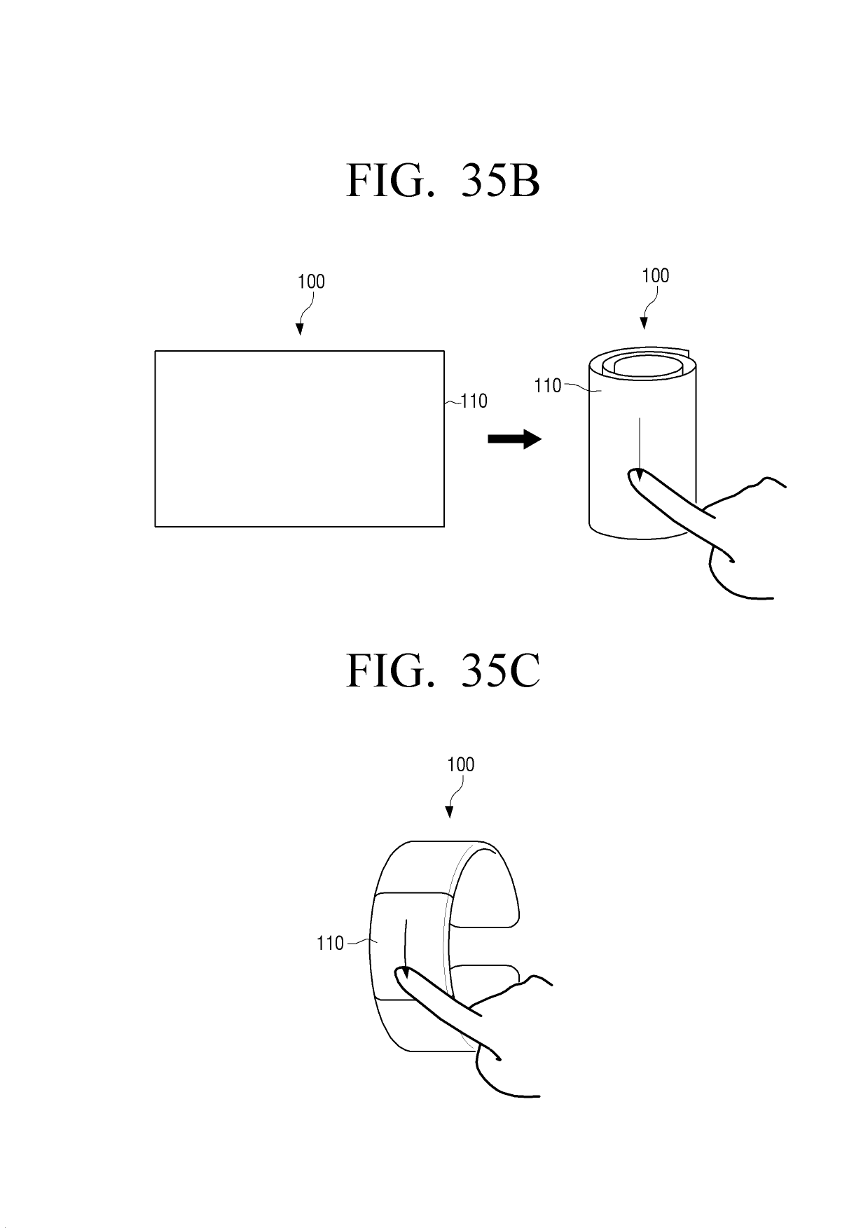

Meanwhile, FIGS. 35A-35C are views provided to explain methods for detecting a stroking or petting manipulation input to the flexible apparatus 100. The stroking or petting may include a user's motion of rubbing the flexible apparatus 100 with his or her finger or palm.

For example, referring to FIG. 35A, if the flexible apparatus 100 is implemented as a solid figure which does not have the function of displaying a screen, the control unit 130 may determine that a stroking or petting manipulation is input, if less than a preset pressure is detected and then areas where pressure is detected are moved by more than a preset distance. The control unit 130 may determine that a stroking or petting manipulation is input, if the above-explained motion repeats a plurality of times so that areas are moved by more than a preset distance in a state of detecting pressure. The term “preset pressure” as used herein may refer to a pressure that can deform an area of the flexible apparatus 100 to a concaved state and this may be set in consideration of the material or shape of the flexible apparatus 100.

Referring to FIG. 35B, if the flexible apparatus 100 includes a flat type display unit 110, the control unit 130 may determine a stroking or petting manipulation with respect to the flexible apparatus 100 using a result of detection made by a touch sensor provided on the detecting unit 120.

To be specific, the control unit 130 may determine a stroking or petting manipulation is input, if detecting: a rolling of the display unit 110; touching of the display unit 110; and moving of the touched areas by more than a preset distance in a state in which the touch is maintained. The control unit 130 may determine that a stroking or petting manipulation is input, if the above-explained motion repeats so that the touch areas are moved by more than a preset distance in a state in which the touch is maintained.

Further, the control unit 130 may determine a stroking or petting manipulation using the result of detection made by a pressure sensor provided on the detecting unit 120. To be specific, the control unit 130 may determine a stroking or petting manipulation is input, if detecting: a rolling of the display unit 110; detecting of more than a preset pressure on the flexible apparatus 100; and a plurality of repeated occurrences of successive moving of the pressure-detected areas by more than a preset distance.

Meanwhile, referring to FIG. 35C, if the flexible apparatus 100 is implemented as a bangle type which includes the display unit 110, the control unit 130 may determine a stroking or petting manipulation with respect to the flexible apparatus 100 using a result of detection made at a touch sensor provided at the detecting unit 120.

That is, the control unit 130 may determine a stroking or petting manipulation is input, if touching of the display unit 110 is followed by movement of the touched area by more than a preset distance in a state in which the touch is maintained. The control unit 130 may determine a stroking or petting manipulation is input, if the above-explained motion repeats so that there is a plurality of repeating occurrences of moving of the touch areas by more than a preset distance in a state in which the touch is maintained.

That is, the control unit 130 may determine a stroking or petting manipulation is input, if detecting more than a preset pressure on the flexible apparatus 100 is followed by successive moving of the pressure-detected areas by more than a preset distance. Again, the control unit 130 may determine a stroking or petting manipulation is input, if the above-explained motion repeats so that there is a plurality of repeating occurrences of moving of the pressure-detected areas by more than a preset distance in a state in which the touch is maintained.

Further, the control unit 130 may determine a stroking or petting manipulation is input using a gyro sensor provided at the detecting unit 120. That is, the control unit 130 may determine a stroking or petting manipulation is input, if the flexible apparatus 100 itself is rotated without having any change in the pressure-exerted areas, after more than a preset pressure is detected on the flexible apparatus 100. In other words, in a state that some areas of the flexible apparatus 100 are pressed, the control unit 130 may determine a stroking or petting manipulation is input, if the flexible apparatus 100 itself is rotated without having any change in the pressed areas.

In various embodiments explained above, the control unit 130 may determine inputting of various types of user manipulations including stretching, pushing, squashing and stroking or petting, using results of sensing obtained by the detecting unit 120.

The control unit 130 may count a number of times the user's manipulation is input.

That is, after the flexible apparatus 100 is deformed in response to a first input including stretching, pushing, squashing or stroking or petting and then returned to original state, the control unit 130 may count a total number of times the user's manipulation has been input, by counting only the user's manipulations which are repeatedly input following the first input. For example, the control unit 130 may count “1” when the user's manipulation is initially input, and count “2” when the user's manipulation is input once again after the flexible apparatus 100 is returned to the original state from the deformed state. That is, the control unit 130 may not count as repeats the number of times the user's manipulation is input if the repeated manipulation is input if the repeated inputs occur before the deformed flexible apparatus 100 is returned to the original state.

Further, the control unit 130 may count the number of times the user's manipulation is input by counting only the user's manipulations which are input before a preset time elapses since the previous manipulation such as stretching, pushing, squashing or stroking or petting was input. That is, the control unit 130 may not count the user's manipulation as repeated if the user's manipulation is input when a preset time elapses since the input of the user's manipulation.

The control unit 130 may control so that an operation is performed in response to the user's manipulation as input. To be specific, the control unit 130 may detect a command corresponding to the user's manipulation from the storage unit 140, generate a control signal corresponding to the detected command and transmit the generated control signal to the display apparatus 200 via the communicating unit 150.

The display apparatus 200 may perform a corresponding operation when the control signal is received. The display apparatus 200 may operate differently depending on the function available at the time at which the user's manipulation, such as stretching, pushing, squashing or stroking or petting, is input.

The function implemented at the display apparatus 200 according to the user's manipulation input to the flexible apparatus 100 will be explained in greater detail below with reference to the accompanying drawings.

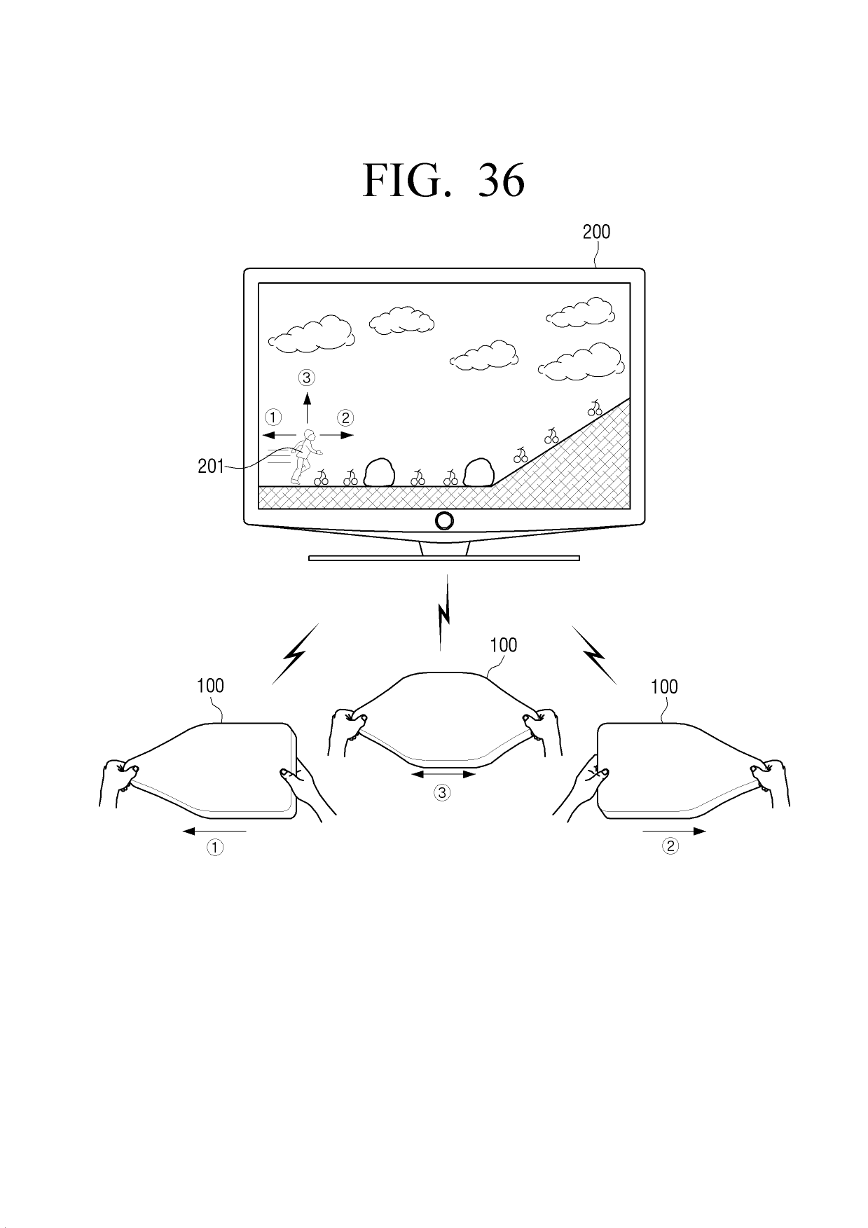

FIGS. 36 to 42 are views provided to explain operations implemented at the display apparatus in response to various user manipulations according to one or more exemplary embodiments.

In response to inputting a stretching manipulation, the flexible apparatus 100 may transmit a control signal corresponding to the stretching manipulation to the display apparatus 200, and the display apparatus 200 may perform a corresponding function according to the control signal.

the stretching manipulation may include an overall stretching manipulation or a single stretching manipulation. Accordingly, the flexible apparatus 100 may transmit information to the display apparatus 200 regarding whether the input stretching manipulation is an overall stretching manipulation or a single stretching manipulation. The flexible apparatus 100 may also transmit to the display apparatus 200 information regarding a direction of the input stretching manipulation. For example, the flexible apparatus 100 may transmit to the display apparatus 200 information regarding whether the input overall stretching manipulation is made in a horizontal direction or a vertical direction, and also send the display apparatus 200 information regarding whether the input single stretching manipulation is made in leftward, rightward, upward or downward direction.

Accordingly, the display apparatus 200 may perform a function corresponding to the type of the stretching manipulation input to the flexible apparatus 100. For example, the display apparatus 200 may perform the functions illustrated in FIGS. 13 to 27.

Furthermore, the display apparatus 200 may control various other functions including moving of a GUI element (e.g., highlighting or cursor) to select a menu or an icon.

For example, referring to FIG. 36, it is assumed that a stretching manipulation is input to the flexible apparatus 100 in a state in which a game screen is displayed on the display apparatus 200. In this case, the display apparatus 200 may move a specific object 201 displayed on the game screen and display the same, based on the control signal received from the flexible apparatus 100.

To be specific, the display apparatus 200 may move the specific object 201 displayed on the game screen according to a direction in which the flexible apparatus 100 is stretched. For example, if a single stretching manipulation is input in a leftward direction to the flexible apparatus 100 (\textcircled{1}), the display apparatus 200 moves the specific object 201 on the game screen in the leftward direction (\textcircled{1}), while if the single stretching manipulation is input in a rightward direction to the flexible apparatus 100 (\textcircled{2}), the display apparatus 200 may move the specific object 201 on the game screen in the leftward direction (\textcircled{2}). Further, if an overall stretching manipulation is input to the flexible apparatus 100 (\textcircled{3}), the display apparatus 200 may cause the specific object 201 on the game screen to perform a specific action (e.g., jumping \textcircled{3}).

While specific examples are written above, one will understand that these are only for illustrative purposes. Accordingly, the object displayed on the game screen may be variably moved according to the type of the input stretching manipulation and the direction of the input stretching manipulation.

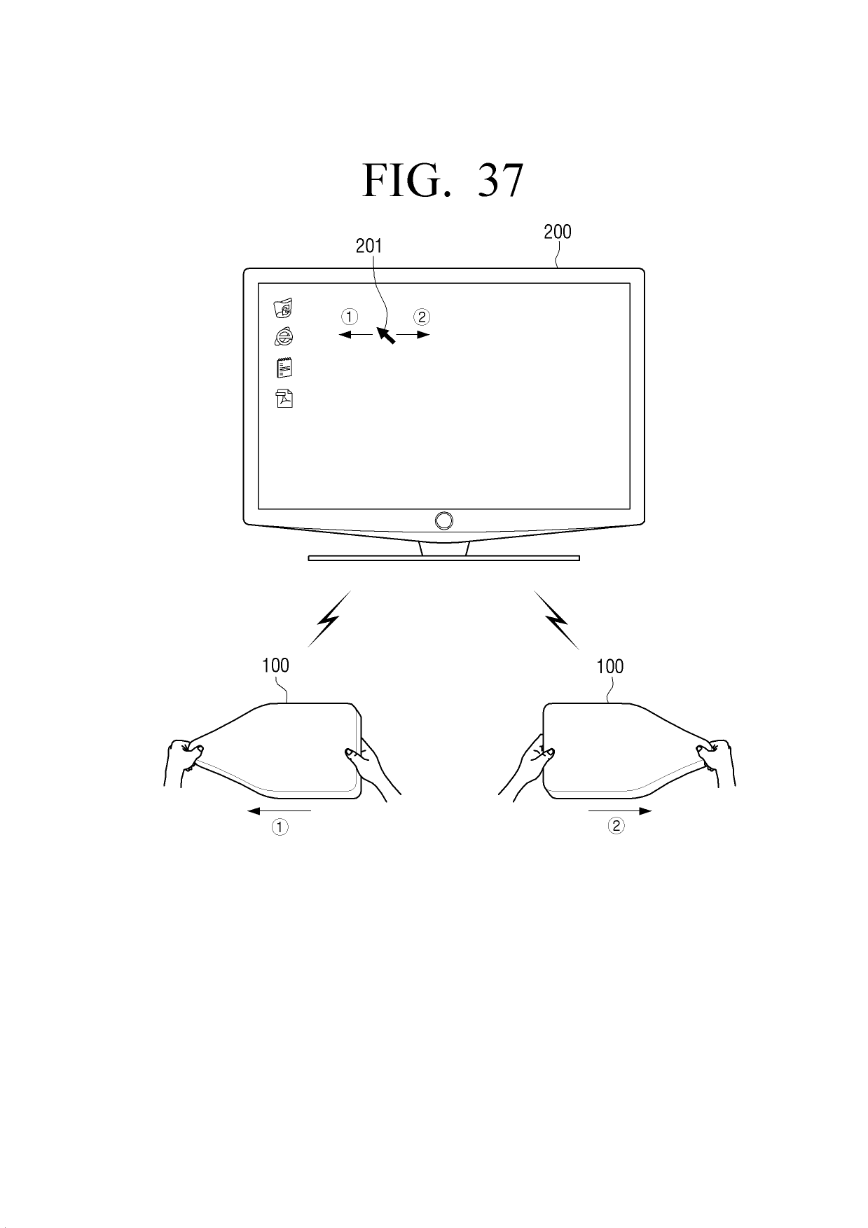

In another exemplary embodiment, referring to FIG. 37, it is assumed that a stretching manipulation is input to the flexible apparatus 100 in a state in which a home screen is displayed on the display apparatus 200. In this example, the display apparatus 200 may move a cursor 202 displayed on the home screen and display the same based on a control signal received from the flexible apparatus 100.

To be specific, the display apparatus 200 may move the cursor 202 displayed on the home screen according to a direction in which the flexible apparatus 100 is stretched. For example, if a single stretching manipulation is input in a leftward direction to the flexible apparatus 100 (\textcircled{1}), the display apparatus 200 may move the cursor 202 on the home screen in the leftward direction, while if a single stretching manipulation is input in a rightward direction to the flexible apparatus 200 (\textcircled{2}), the display apparatus 200 may move the cursor 202 on the home screen in the rightward direction (\textcircled{2}). Although not illustrates, if a single stretching manipulation is input in an upward or downward direction to the flexible apparatus 100, the display apparatus 200 may move the cursor 202 on the home screen in upward or downward directions.

Although it is assumed that the cursor is displayed on the home screen, this is only for illustrative purposes. Accordingly, the moving of the cursor displayed on various screens including UI screen or menus screen as well as home screen may be controlled according to the stretching manipulation input to the flexible apparatus 100.

Further, although it is explained that the cursor is moved, this is only for illustrative purposes. Accordingly, other objects, such as highlighting, displayed on the home screen, UI screen or menu screen may be controlled according to a stretching manipulation input to the flexible apparatus 100. Accordingly, the movement of various GUI elements to select a menu or an icon may be controlled according to a stretching manipulation input to the flexible apparatus 100.

The flexible apparatus 100 in one exemplary embodiment may transmit to the display apparatus 200 information about a degree of stretching, and the display apparatus 200 may perform a function corresponding to the transmitted information.

For example, the flexible apparatus 100 may determine a level of stretching of the flexible apparatus 100 based on a plurality of levels, by referring to the pressure exerted during inputting of a stretching manipulation or to the degrees that the bend sensors are stretched by the pressure of the stretching manipulation, and may transmit information about the determined level to the display apparatus 200.

The display apparatus 200 may move the cursor or the highlighting faster or move a specific object on the game screen faster, when the degree of stretching of the flexible apparatus 100 is greater. Likewise, the display apparatus 200 may move the cursor or the highlighting slower or move a specific object on the game screen slower, when the degree of stretching of the flexible apparatus 100 is smaller.

Accordingly, users may control the operation of the display apparatus 200 according to the degree of stretching.

When a pushing manipulation is input, the flexible apparatus 100 may transmit a control signal corresponding to the pushing manipulation to the display apparatus 200, and the display apparatus 200 may perform a function according to the control signal.

For example, the display apparatus 200 may perform a function including executing an application according to selecting of a menu or an icon.

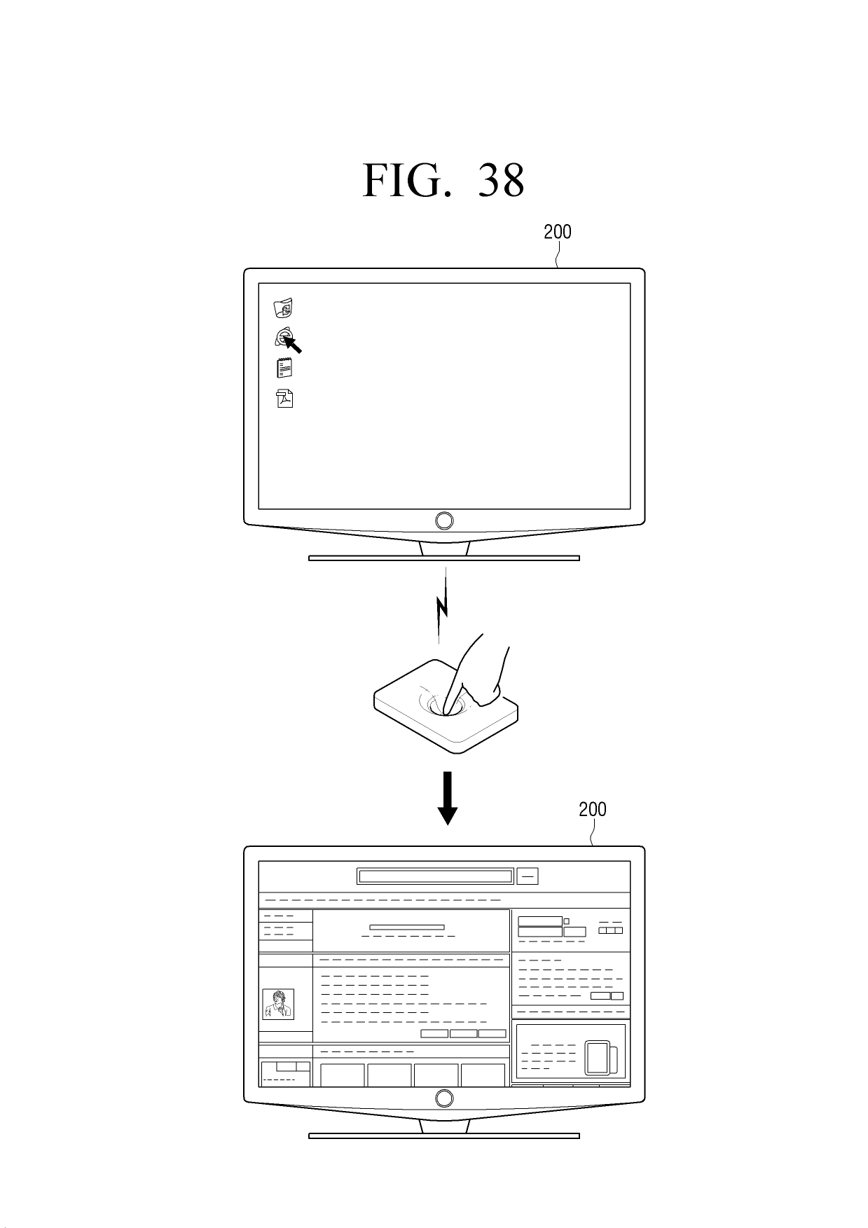

For example, it is assumed that a pushing manipulation is input to the flexible apparatus 100 in a state in which the home screen is displayed on the display apparatus 200. In this example, the display apparatus 200 may display an application executing screen by executing an application corresponding to an icon on which the cursor is placed on the home screen. That is, referring to FIG. 38, if a control signal corresponding to a pushing manipulation is received from the flexible apparatus 100 in a state in which the cursor 203 is placed on an internet icon, the display apparatus 200 may execute an application for internet access, and display a webpage screen received from an external server (not illustrated).

Although an icon is selected by the cursor in an embodiment explained above, this is only for illustrative purposes. Accordingly, if a pushing manipulation is input to the flexible apparatus 100 in a state in which highlighting, instead of the cursor, is placed on the icon, an application corresponding to the highlighted icon may be executed.

Further, although an icon displayed on the home screen is selected according to the embodiment explained above, this is only for illustrative purposes. Accordingly, a menu on which a cursor or a highlighting is placed on a UI screen or a menu screen may be executed according to a pushing manipulation.

When a squashing manipulation is input to the flexible apparatus 100, the flexible apparatus 100 may transmit a control signal corresponding to the squashing manipulation to the display apparatus 200 and the display apparatus 200 may perform a function according to the transmitted control signal.

For example, the display apparatus 200 may perform volume adjustment, scrolling or many other functions.

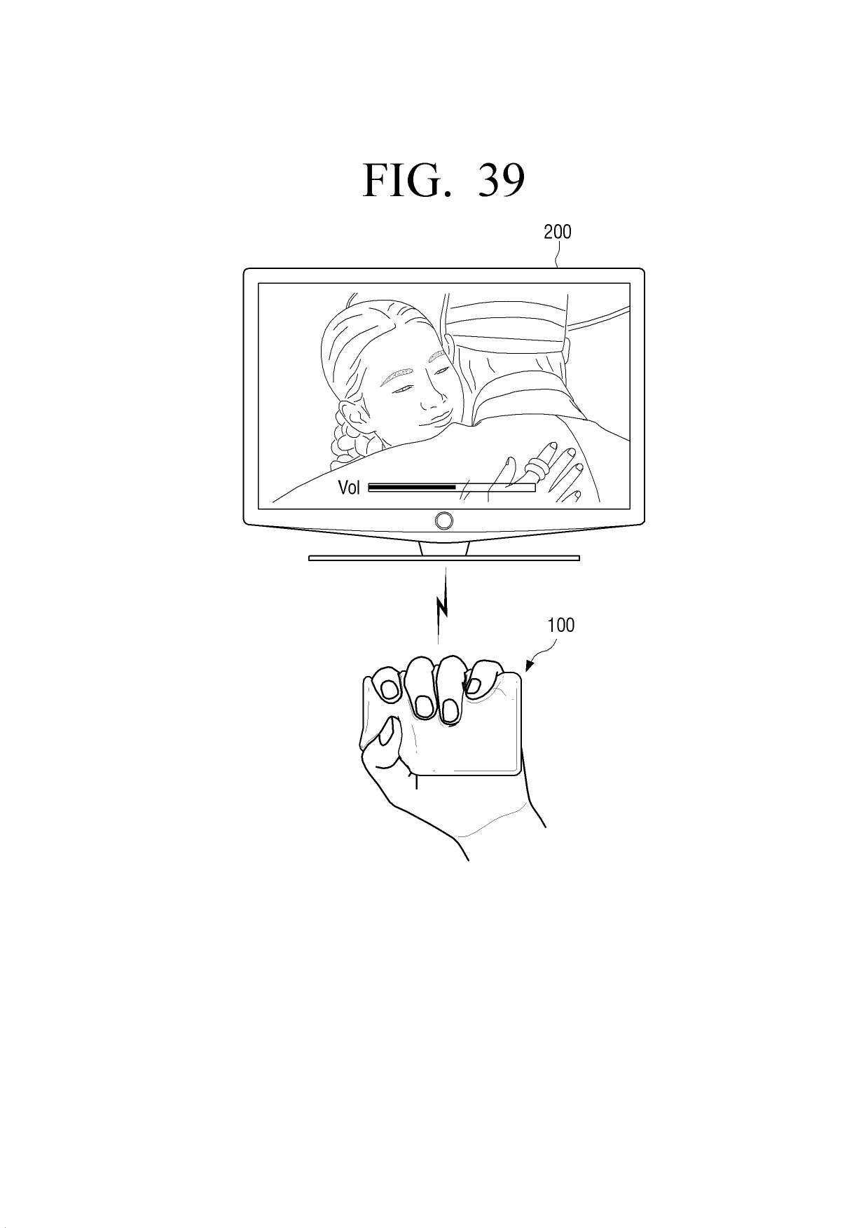

For example, it is assumed that a squashing manipulation is input to the flexible apparatus 100 in a state in which a specific channel is tuned so that a broadcast is displayed on the display apparatus 200. In this example, referring to FIG. 39, the display apparatus 200 may increase or decrease a volume of output audio.

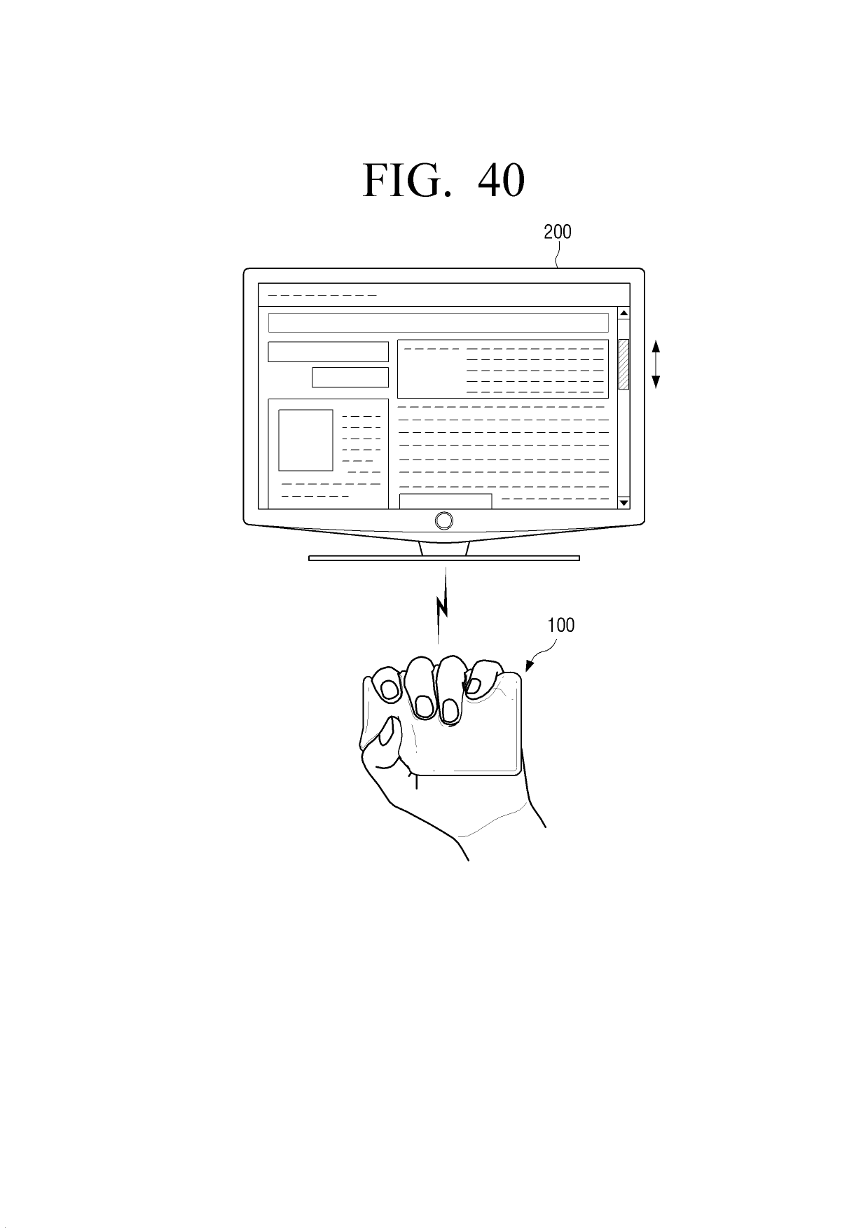

In another example, it is assumed that a squashing manipulation is input to the flexible apparatus 100 in a state in which the display apparatus 200 displays a webpage screen. Referring to FIG. 40, the display apparatus 200 may scroll the webpage screen and display upper or lower portion of the currently-displayed webpage screen.

In specific embodiments explained above, the flexible apparatus 100 may transmit to the display apparatus 200 information regarding degree and direction of squashing the flexible apparatus 100, and the display apparatus 200 may perform a function corresponding to the transmitted information.

For example, the flexible apparatus 100 may determine a level of squashing of the flexible apparatus 100 based on a plurality of levels, by referring to the degree the bend sensors are extended by the pressure of the squashing manipulation or the degree the bend sensors are extended according to the squashing manipulation, and transmit information about the determined level to the display apparatus 200.

The display apparatus 200 may change volume or scroll faster, when the degree of squashing of the flexible apparatus 100 is greater. Likewise, the display apparatus 200 may change volume or scroll slower, when the degree of squashing of the flexible apparatus 100 is smaller.

Accordingly, users may control the operation of the display apparatus 200 according to the degree of squashing

In another example, the flexible apparatus 100 may transmit to the display apparatus 200 information about a direction in which the flexible apparatus 100 is squashed. To this end, the detecting unit 120 may detect, through a gravity sensor, in which direction the flexible apparatus 100 is located. However, this is only one example. Accordingly, the detecting unit 120 may include various sensors to detect the direction of the flexible apparatus 100.

Accordingly, the display apparatus 200 may increase a volume of a currently-output audio or scroll a currently-displayed webpage to an upper portion, if a squashing manipulation is input to the flexible apparatus 100 which is made in the direction of gravity (i.e., placed in a vertical direction). Likewise, the display apparatus 200 may decrease a volume of a currently-output audio or scroll a currently-displayed webpage to the lower portion, if a squashing manipulation is input to the flexible apparatus 100 which is disposed horizontally (i.e., placed in a horizontal direction).

As a result, users may control the operation of the display apparatus 200 according to a direction of squashing.

Meanwhile, when a stroking or petting manipulation is input, the flexible apparatus 100 may transmit a corresponding control signal to the display apparatus 200 and the display apparatus 200 may perform a function according to the transmitted control signal.

For example, the display apparatus 200 may perform a function such as a channel change or a content change.

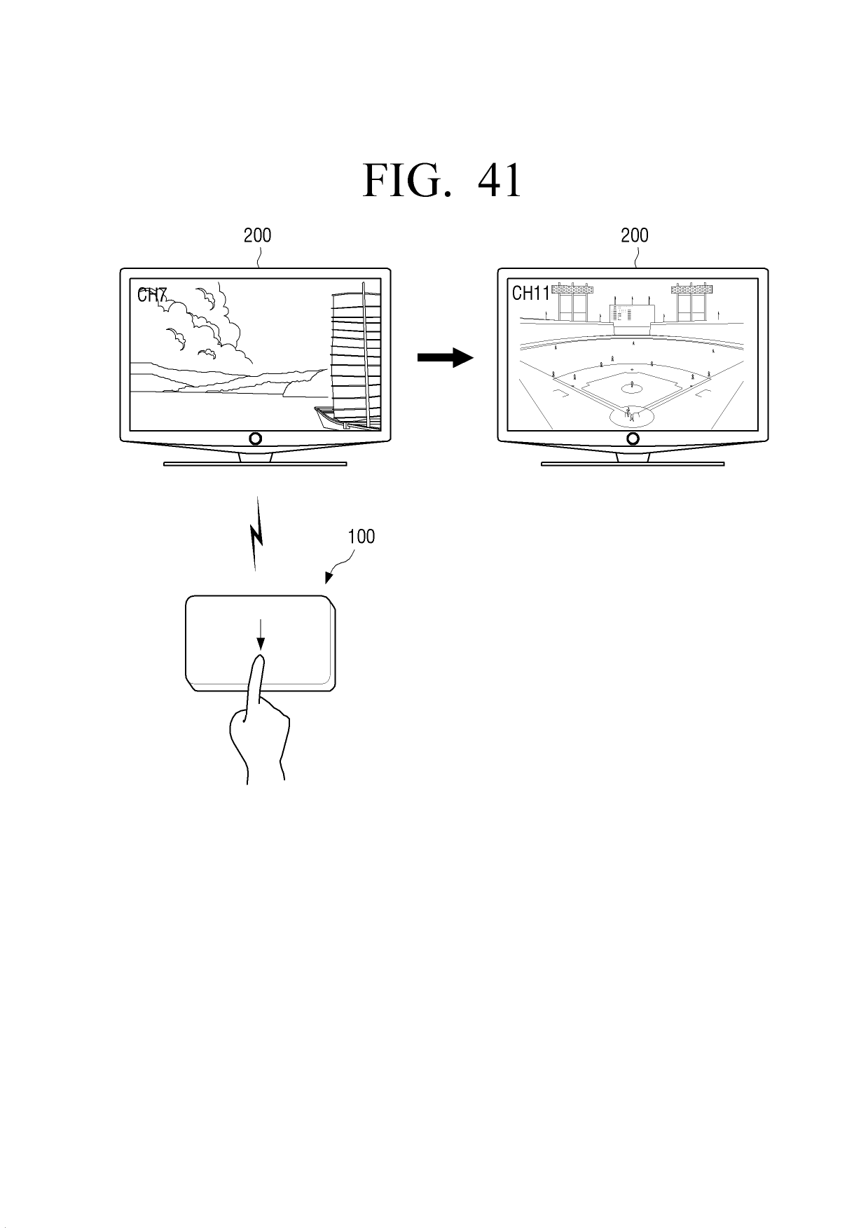

For example, it is assumed that a stroking or petting manipulation is input to the flexible apparatus 100 in a state in which a specific channel is tuned and a broadcast is displayed on the display apparatus 200. Referring to FIG. 41, the display apparatus 200 may perform channel change from the current channel to the next or previous channel.

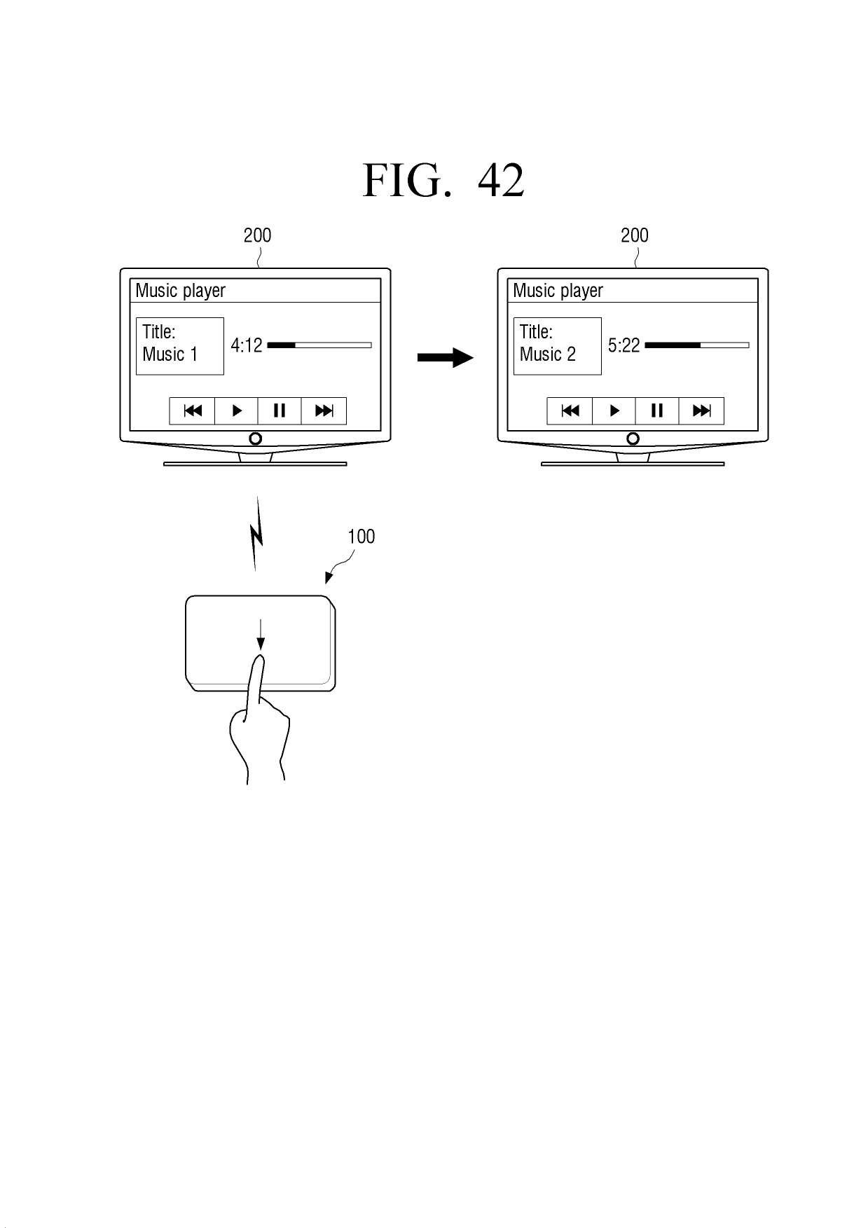

In another example, it is assumed that a stroking or petting manipulation is input to the flexible apparatus 100 in a state in which content is being played back on the display apparatus 200. The content may include music, images or video. Referring to FIG. 42, the display apparatus 200 may perform content change from the currently-played content to the next or previous content.

In specific embodiments explained above, the flexible apparatus 100 may transmit to the display apparatus 200 information about a degree and a direction of squashing of the flexible apparatus 100, and the display apparatus 200 may perform a function corresponding to the transmitted information.

For example, the flexible apparatus 100 may determine a pressure exerted during the inputting of stroking or petting, determine a level of stroking or petting the flexible apparatus 100 based on a plurality of levels, and transmit the information about the determined level to the display apparatus 200. Accordingly, the display apparatus 200 may change channels or contents faster, as a greater pressure is exerted on the flexible apparatus 100 by the stroking or petting manipulation. Likewise, the display apparatus 200 may change channels or contents slower, as a smaller pressure is exerted on the flexible apparatus 100 by the stroking or petting manipulation.

In another exemplary embodiment, the flexible apparatus 100 may transmit to the display apparatus 200 information about a direction in which the pressure exerted during inputting of the stroking or petting is moved, and the display apparatus 200 may determine the direction in which stroking or petting manipulation is made with respect to the flexible apparatus 100 based on the information regarding the direction of movement received from the flexible apparatus 100.

Accordingly, if it is determined that a stroking or petting manipulation is made in a downward direction with respect to the flexible apparatus 100, the display apparatus 200 may tune to a channel preceding the current channel and display the same, or play back content preceding the currently-playing content. Likewise, if determining that a stroking or petting manipulation is made in an upward direction with respect to the flexible apparatus 100, the display apparatus 200 may tune to a channel after the current channel and display the same, or play back content after the currently-playing content.

In the specific embodiments explained above, the function of the display apparatus 200 is executed according to a user's manipulation which is input to the flexible apparatus 100 without a function of displaying a screen. However, this is only for illustrative purposes. Accordingly, the function of the display apparatus 200 may be controlled according to the user's manipulation as input, even when the flexible apparatus 100 includes a flat type display unit 110 or implemented as a bangle type. Meanwhile, the method of detecting user's manipulation such as stretching, pushing, squashing and stroking or petting when the flexible apparatus 100 includes a flat type display unit 110 or implemented as a bangle type, is explained above with reference to FIGS. 32 to 35.

Further, the function of the display apparatus 200 may be controlled in accordance with the user's manipulation input to the flexible apparatus 100 as explained above in the described exemplary embodiments. However, in another exemplary embodiment, the flexible apparatus 100 may itself perform a function corresponding to the user's manipulation as input.

If the flexible apparatus 100 specifically includes a flat type display unit 110 or is implemented as a bangle type, the control unit 130 may control so that a function corresponding to the user's manipulation such as stretching, pushing, squashing and stroking or petting is performed.

That is, the control unit 130 may move a GUI element displayed on a screen in accordance with the stretching manipulation, when the stretching manipulation is input. Accordingly, the control unit 130 may move the GUI element according to a direction the stretching manipulation is made.

For example, the control unit 130 may move a cursor or a highlighting in a leftward direction when a single stretching manipulation is input in the leftward direction, while the control unit 130 may move a cursor or a highlighting in a rightward direction when a single stretching manipulation is input in the rightward direction. In another exemplary embodiment, the control unit 130 may move an object displayed on a game screen in a leftward direction when a single stretching manipulation is input in the leftward direction, while the control unit 130 may move an object displayed on a game screen in a rightward direction when a single stretching manipulation is input in the rightward direction.

The control unit 130 may change the speed of moving the GUI element depending on the degree of stretching of the flexible apparatus 100. In the specific examples explained above, the control unit 130 may increase the speed of moving the highlighting or object as the degree of stretching increases, while the control unit 130 may decrease the speed of moving the highlighting or object as the degree of stretching decreases.

Furthermore, the control unit 130 may perform the functions illustrated in FIGS. 13 to 27 when the stretching manipulation is input. These functions are not repeatedly explained below, but the reference is instead made to the explanation provided above with reference to FIGS. 13 to 27.

The control unit 130 may also perform volume adjustment, scrolling or many other functions in response to a squashing manipulation.

The control unit 130 may change a speed of adjusting the volume or a speed of scrolling according to degree and direction of squashing. For example, the control unit 130 may perform volume adjustment or scrolling faster as the degree of squashing increases, or perform volume adjustment or scrolling slower as the degree of squashing decreases.

To be specific, if the flexible apparatus 100 includes a flat type display unit 110, the control unit 130 may control the speed and direction of scrolling based on the degree and location of the bending of the display unit 110 in rolled state. For example, the control unit 130 may control based on the result of detection made at the detecting unit 120 so that the scrolling is performed faster as the degree of bending of the display unit 110 in rolled state increases, and the scrolling is performed slower as the degree of bending of the display unit 110 in rolled state decreases. Further, based on the result of detection made at the detecting unit 120, the control unit 130 may scroll in upward direction, if the squashing manipulation is made above the center of the display unit 110, or scroll in downward direction, if the squashing manipulation is made below the center of the display unit 110.

Further, the control unit 130 may change the mode of the flexible apparatus 100 when a squashing manipulation is input. For example, if the flexible apparatus 100 includes a flat type display unit 110, the control unit 130 may change the current mode to vibration mode when the cross section of the display unit 110 in rolled state is change to substantially oval shape or partially changed to flat state according to the squashing manipulation, or release the vibrating mode when the display unit 110 in rolled state is deformed to the substantially circular shape.

Meanwhile, the control unit 130 may perform channel change, content change or many other functions in response to a stroking or petting manipulation as input. In this example, the control unit 130 may perform a function corresponding to information and direction of the stroking or petting manipulation.

For example, based on the result of detection made at the detecting unit 120, the control unit 130 may perform a channel change or a content change faster as a greater pressure is exerted in the inputting of the stroking or petting manipulation, or may perform channel change or content change slower as a smaller pressure is exerted in the inputting of the stroking or petting manipulation. Further, if determining based on the result of detection of the detecting unit 120 that the stroking or petting manipulation is made in a downward direction, the control unit 130 may tune to a channel preceding the currently-broadcasting channel and display the same, or play back content preceding the currently-played content. Likewise, if determining based on the result of detection of the detecting unit 120 that the stroking or petting manipulation is made in an upward direction, the control unit 130 may tune to a channel after the currently-broadcasting channel and display the same, or play back content after the currently-played content.

Meanwhile, in the embodiment explained above, channel change or content change is determined in accordance with a direction of the stroking or petting. However, this is only for illustrative purposes. That is, the control unit 130 may control channel change or content change according to the pressure exerted during inputting of stroking or petting manipulation. That is, the control unit 130 may tune to a channel preceding the currently-broadcasting channel and display the same when less than a preset pressure is exerted, while the control unit may tune to a channel after the currently-broadcasting channel and display the same when more than a preset pressure is exerted.

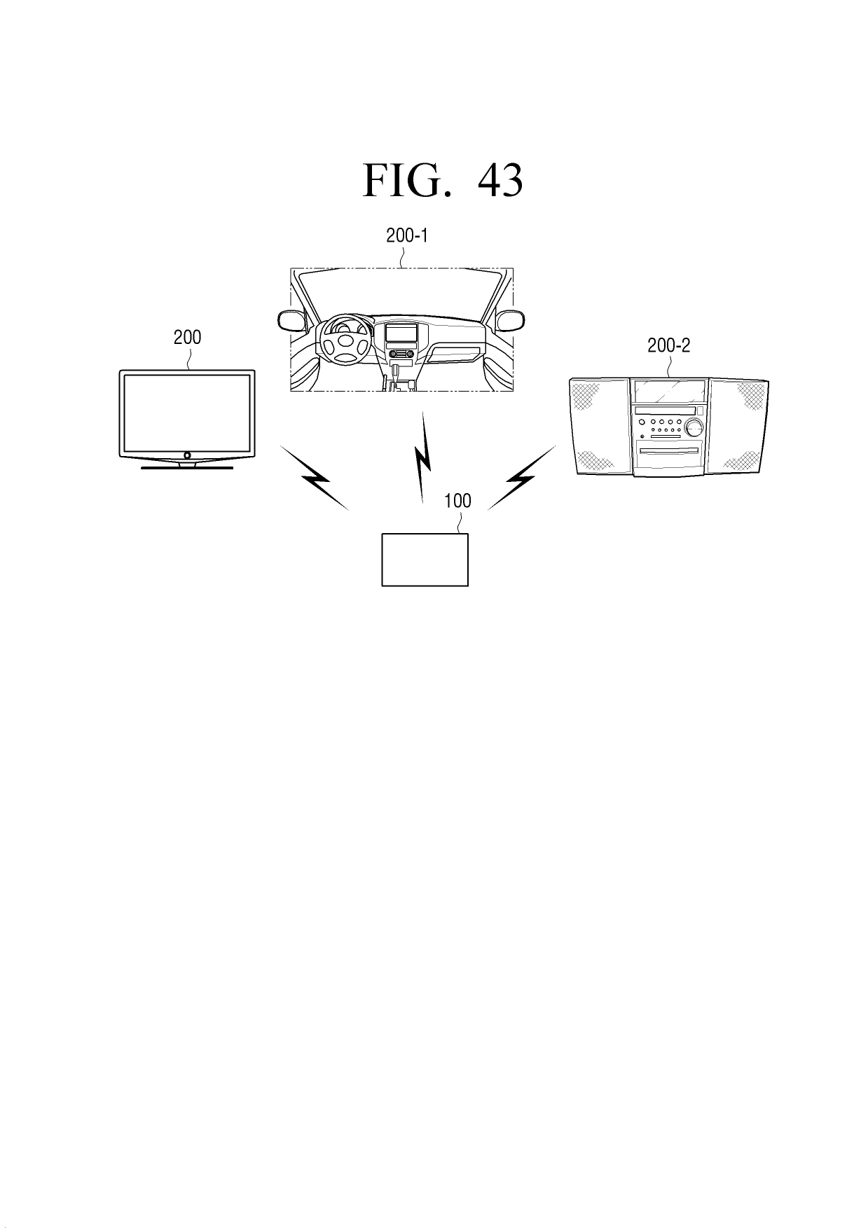

FIG. 43 is a view illustrating a constitution of a flexible apparatus operating in association with an external display apparatus according to another exemplary embodiment.

Referring to FIG. 43, the flexible apparatus 100 may be implemented as an integrated remote controlling apparatus which is capable of controlling a plurality of external devices. For example, the flexible apparatus 100 may be implemented in a form to control not only the display apparatus 200, but also a plurality of external devices including a vehicle 200-1 or an audio device 200-2. Meanwhile, the function of controlling a plurality of devices may be implemented according to the same principles as that of a conventional integrated remote control; thus, a detailed explanation thereof will be omitted for the sake of brevity.

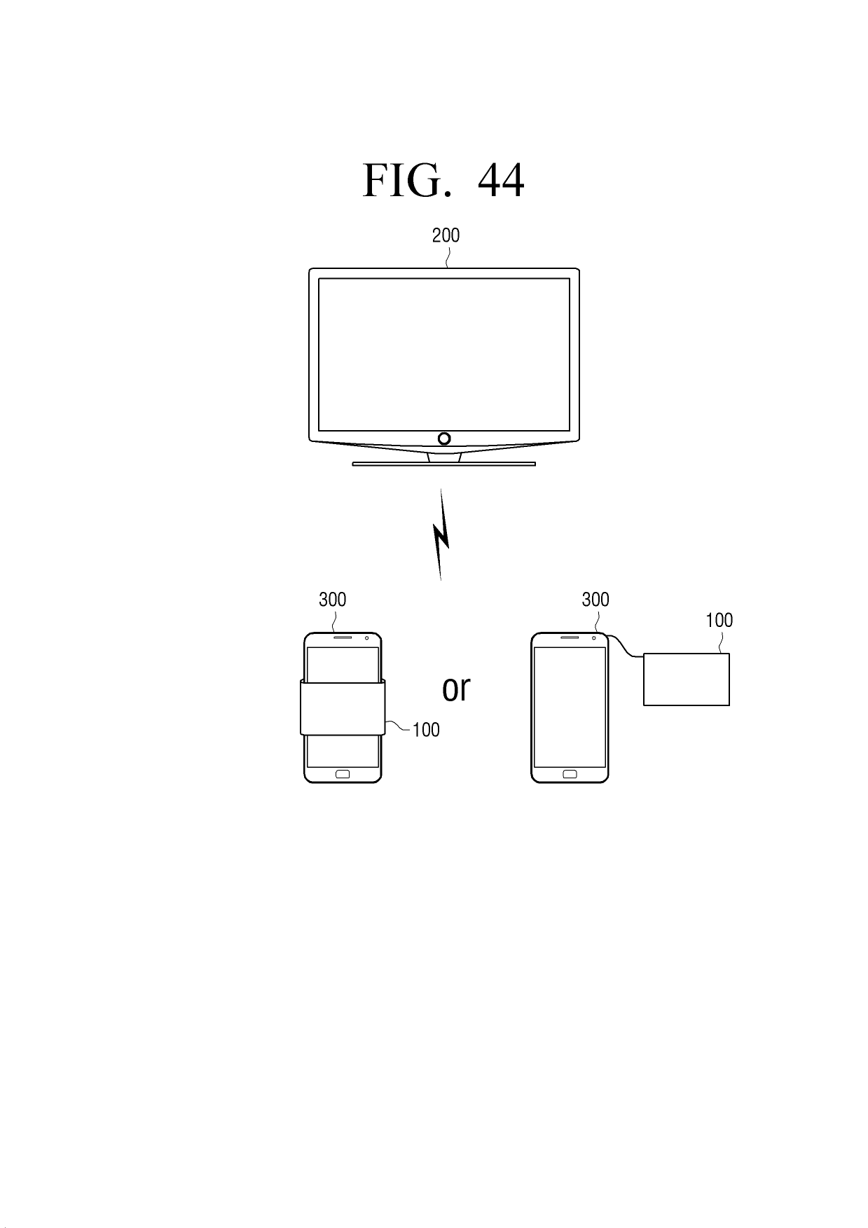

FIG. 44 is a view provided to explain a method of operating a flexible apparatus according to another exemplary embodiment.

Referring to FIG. 44, the flexible apparatus 100 may be implemented in a form that is connected to an external device 300, such as a smartphone, to control other external display apparatus 200. For example, the flexible apparatus 100 may be implemented in a form having a low performance CPU to provide low computing function, or provide basic performance to simply support communication with an external device. In this example, the flexible apparatus 100 may utilize the computing function of the high performance external device 300 such as a smartphone, to operate as a remote controlling apparatus to control the external display apparatus 200. The flexible apparatus 100 may be connected to the external device 300 via pins, etc.

The flexible apparatus 100 may be implemented in any of various forms. For example, as explained above, the flexible apparatus 100 may be implemented in a band shape, a sheet shape, or the like, in addition to a form that does not have a function of displaying a screen or a bangle type.

Further, the flexible apparatus 100 may be utilized in a wide range of fields. For example, the flexible apparatus 100 is applicable to logistics, sports or accessories. For the purpose of use in logistics or sports field, the flexible apparatus 100 may be worn on clothes or as an armband. Further, for the purpose of use in accessories, the flexible apparatus 100 may be attached to bags or mobile phones to be used.

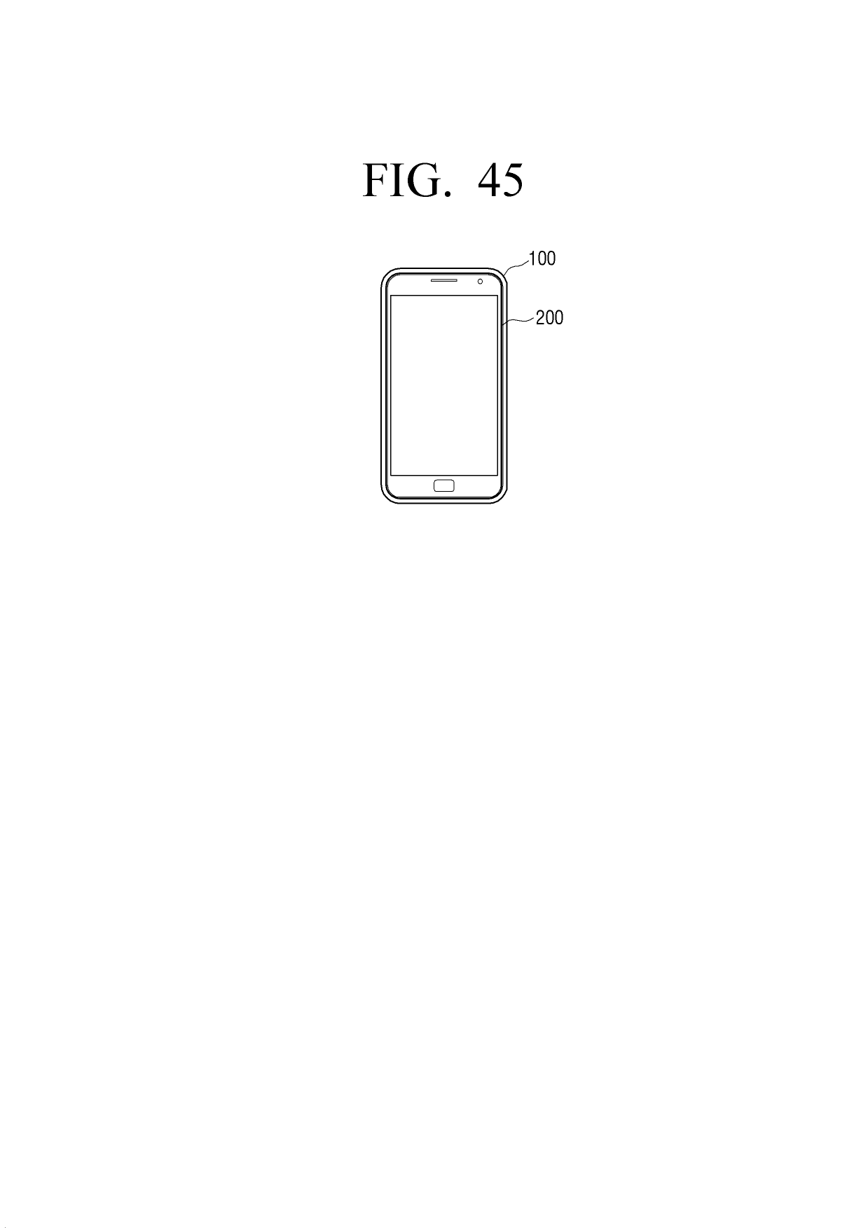

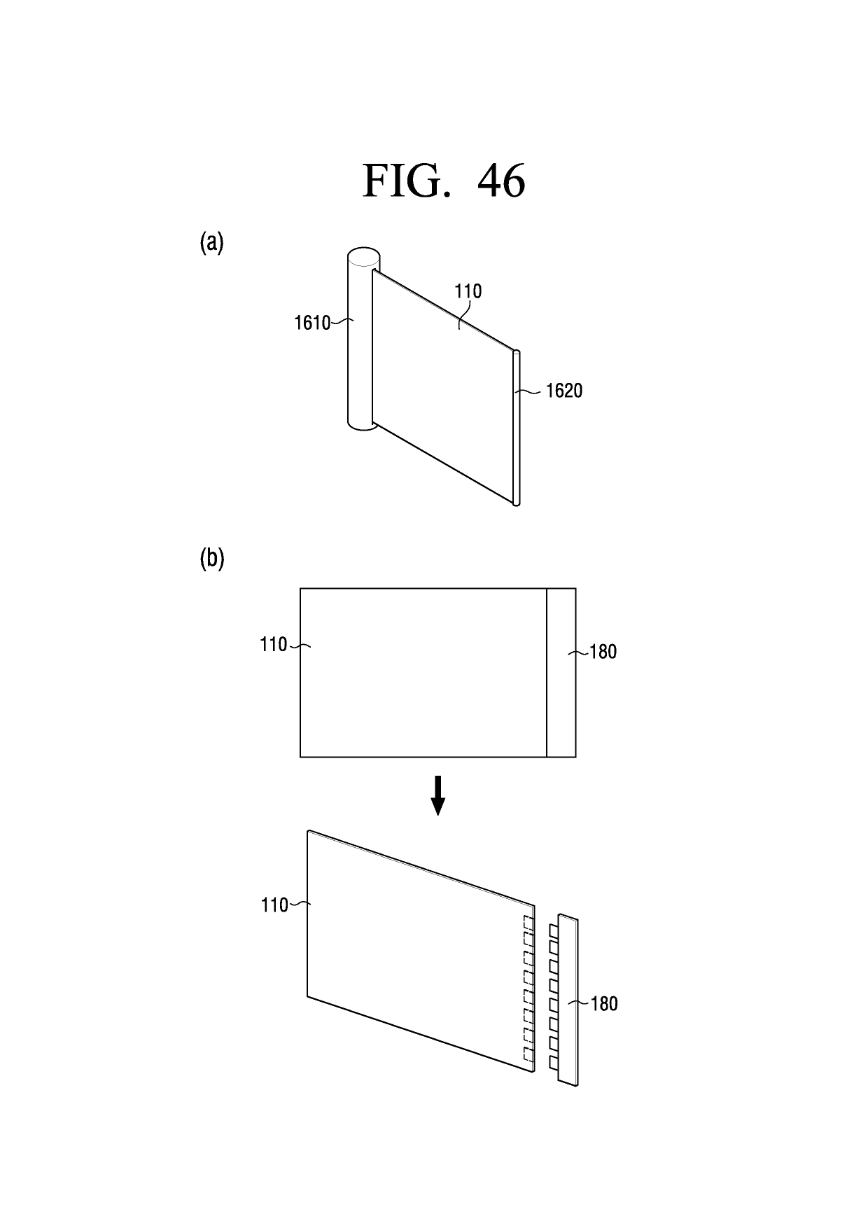

FIG. 45 is a view provided to explain an example of the flexible apparatus according to an exemplary embodiment.

Referring to FIG. 45, when the display apparatus 200 controlled according to the flexible apparatus 100 is implemented as a smartphone, the flexible apparatus 100 may be formed to wrap around the display apparatus 200 to maximize its aesthetic effect and also protect the display apparatus 200 from external shock. As explained above, the flexible apparatus 100 may detect the user's manipulation including stretching, pushing, squashing or stroking or petting and accordingly control the display apparatus 200 to operate according to the user's manipulation.

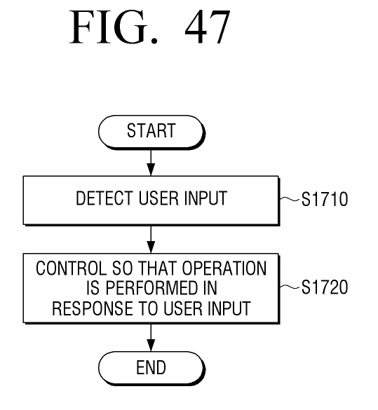

FIGS. 47A-47B provide views illustrating examples of flexible apparatuses according to exemplary embodiments. FIG. 47A particularly illustrates an example in which the flexible apparatus includes a flat type display unit 110, in which the display unit 110 has a flexible property as explained above.

FIG. 47A illustrates a flexible apparatus embedded in a main body according to an exemplary embodiment.

Referring to FIG. 47A, the flexible apparatus 100 may include a main body 1610, a display unit 110 and a grip unit 1620.

The main body 1610 plays the role of a casing that holds therein the display unit 110. If the flexible apparatus 100 includes various elements therein as the one illustrated in FIG. 28, the elements other than the display unit 100 and some sensors may be mounted on the main body 1610. The main body 1610 includes a rotating roller around which the display unit 110 can be rolled. Accordingly, the display unit 110 may be rolled about a rotating roller to be received in the main body 1610.

If the user grips and pulls the grip unit 1620, the rotating roller rotates opposite to the direction of rolling so that rolling is released. As a result, the display unit 110 is exposed outside the main body 1610. The rotating roller may include a stopper. Accordingly, if the user pulls the grip unit 1620 by more than a preset distance, rotation of the rotating roller is stopped due to presence of the stopper, and the display unit 110 may be fixed. Accordingly, the user may execute various functions using the display unit 110 exposed outside the main body 1610. Meanwhile, if the user presses a button to release the stopper, the stopper is released and the rotating roller is rotated in a reverse direction so that the display unit 110 is rolled back into the main body 1610. The stopper may have a switch form to stop the operation of the gear provided to rotate the rotating roller. The rotating roller and the stopper may utilize the structures conventionally used in general rolling structure assembly, and accordingly, detailed explanation thereof will be omitted for the sake of brevity.

The main body 1610 may include a power unit 180. The power unit 180 may be implemented in various form including a battery connection on which disposable battery is mounted, a secondary battery which is rechargeable by a user for a plurality of times, or a solar battery which generates power by utilizing solar heat. If a secondary battery is implemented, the user may connect the main body 1610 to an external power source by a line to charge the power unit 180.

FIG. 47A illustrates a cylindrical main body 1610. However, the main body 1610 may be implemented in a rectangular shape or other polygonal shapes. Further, the display unit 110 may be exposed outside from the main body 1610 in the embodiment explained above. However, in another exemplary embodiments, the display unit 110 may be implemented as a form that surrounds the outside of the main body or in any of many other shapes.

FIG. 47B is a view of a flexible apparatus to or from which the power unit 180 can be attached or detached. Referring to FIG. 47B, the power unit 180 may be provided on an edge of one side of the flexible apparatus in an attachable and detachable manner.

The power unit 180 may be formed from a flexible material to be bent along with the display unit 110. To be specific, the power unit 180 may include a cathode capacitor, a positive electrode, an electrolyte, a negative electrode and an anode capacitor and a cladding portion covering the same.

For example, the capacitor may be formed from alloy with good elasticity such as TiNi group, pure metals such as copper or aluminum, conductive material such as carbon-coated pure metal, carbon, or carbon fiber, or conductive polymer such as polypyrrole.

The negative electrode may be formed from non-metals such as lithium, sodium, zinc, magnesium, cadmium, hydrogen storage alloy, or lead, and negative electrode material such as polymer electrode material such as organic sulfur.

The positive electrode may be formed from sulfur and metallic sulfide, lithium transition metal oxide such as LiCoO₂, or positive electrode material such as polymer electrode such as SOCl₂, MnO₂, Ag₂O, Cl₂, NiCl₂, NiOOH. The electrolyte may be formed in gel type using PED, PVdF, PMMA, PVAC.

The cladding portion may be formed from a general polymer resin. For example, PVC, HDPE or epoxy resin may be used. Additionally, any material may be used as the cladding portion as long as the material ensures that breakage of the seal type battery is prevented while allowing freedom of bending or folding.

The positive and negative electrodes within the power unit 180 may include connectors to electrically connect to outside.

Referring to FIG. 47B, the connector protrudes from the power unit 180 and the display unit 110 includes opening corresponding to the location, size and shape of the connector. Accordingly, upon engagement of the connector and the opening, the power unit 180 is connected to the display unit 110. The connector of the power unit 180 may be connected to a power connect pad (not illustrated) inside the flexible apparatus 100 to supply electricity.

In the embodiment illustrated in FIG. 47B, the power unit 180 may be attached to or detached from an edge of one side of the flexible apparatus 100. However, this is only for illustrative purposes. Accordingly, the location and shape of the power unit 180 may vary depending on the characteristics of the product. For example, if the flexible apparatus 100 has a predetermined thickness, the power unit 180 may be mounted on the rear surface of the flexible apparatus 100.

FIG. 47 is a flowchart provided to explain a control method of a flexible apparatus according to an exemplary embodiment.

At S1710, a user's input to the flexible apparatus is detected.

At S1720, upon detecting the user's input, the apparatus is controlled so that the operation corresponding to the user's input is performed. The flexible apparatus may control the display apparatus to perform an operation corresponding to the user's input, or the flexible apparatus itself may operate according to the user's input.

Meanwhile, the user's input may include stretching, pushing, squashing, stroking or petting or any of many other user manipulations, and the flexible apparatus may be controlled to perform one or more operations according to the respective user manipulations.

Because the method for detecting user manipulations such as stretching, pushing, squashing or stroking or petting, and operations performed according to the respective user inputs are explained above, these will not be explained again for sake of brevity.

Further, a program for executing the control method according to an exemplary embodiment in sequence may be stored and provided on a non-transitory computer readable medium.

The non-transitory computer readable medium may refer to a medium which is capable of storing data semi-permanently and reading the data by a device, rather than a medium such as a register, cache, or memory which stores the data for a short period of time. To be specific, the applications or programs explained above may be stored on the non-transitory computer readable medium and provided, and the non-transitory computer readable medium may include a CD, a DVD, a hard disk, a Blu-ray disk, a USB, a memory card, or a ROM.

The foregoing embodiments and advantages are merely exemplary and are not to be construed as limiting the present inventive concept. The present teaching can be readily applied to other types of apparatuses. Also, the description of the exemplary embodiments of the present inventive concept is intended to be illustrative, and not to limit the scope of the claims, and many alternatives, modifications, and variations will be apparent to those skilled in the art.

What is claimed is:

1. A flexible apparatus comprising:
a display unit comprising a screen;
a detecting unit which detects a user input, the user input comprising a stretching of the display unit; and
a control unit which receives information regarding the user input from the detecting unit and controls the display unit to perform an operation corresponding to user input.

2. The flexible apparatus of claim 1, wherein
the detecting unit comprises one or more sensors which detect a user input comprising a user's grip with the flexible apparatus and one or more sensors which detect a user input comprising a user's touch, wherein a touch area is an area in which the user's touch is detected, and
the control unit determines that a single stretching manipulation is made, when the user's grip is detected at a single area of the display unit and a touch area due to the user's touch is moved.

3. The flexible apparatus of claim 1, wherein
the detecting unit comprises a plurality of strain gauges disposed adjacent to an edge of the flexible apparatus, wherein the plurality of strain gauges detect tension, and
the control unit determines that a single stretching manipulation is made, when a tension is detected by one of the plurality of strain sensors.

4. The flexible apparatus of claim 2, wherein,
when the control unit determines that the single stretching manipulation is made, the control unit controls the display unit to move one or more objects displayed on the screen in a direction in which the single stretching manipulation is made, to remove the one or more objects from a first side of the screen, and adds one or more new objects to the screen from a second side of the screen, to move the one or more new objects in the direction in which the single stretching manipulation is made and to display the one or more new objects on the screen.

5. The flexible apparatus of claim 1, wherein
the detecting unit comprises one or more sensors which detect a user input comprising a user's grip and one or more sensors which detect an input comprising a user's touch, wherein a touch area is an area in which the user's touch is detected, and
the control unit determines that an overall stretching manipulation is made, when a first touch area and a second touch area are detected and move in opposite directions.

6. The flexible apparatus of claim 1, wherein
the detecting unit comprises a plurality of strain gauges disposed adjacent to an edge area of the flexible apparatus, wherein the plurality of strain gauges detect tension, and
the control unit determines that an overall stretching manipulation is made, when a tension is detected by two or more of the plurality of strain gauges.

7. The flexible apparatus of claim 5, wherein, when the control unit determines that the overall stretching manipulation is made, the control unit controls the display unit to change a mode of the screen.

8. The flexible apparatus of claim 5, wherein, when the control unit determines that the overall stretching manipulation is made, the control unit controls the display unit to change changes a display form of an object displayed on the screen.

9. The flexible apparatus of claim 5, wherein, when the control unit determines that the overall stretching manipulation is made, the control unit controls the display unit to enlarge one or more objects displayed on the screen based on a preset ratio.

10. The flexible apparatus of claim 5, wherein, when the control unit determines that the overall stretching manipulation is made, the control unit controls the display unit to divide one or more objects displayed on the screen into a first half and a second half according to a direction of the overall stretching manipulation, to gradually separate first half and the second half from each other, to remove the first half and the second half off a first side of the screen and a second side of the screen, respectively, and to display one or more new objects in an area formed between the first half and the second half.

11. A method of controlling a flexible apparatus having a display unit, the method comprising:
detecting a user input, the user input comprising a stretching of the display unit; and
performing an operation corresponding to the user input.

12. The control method of claim 11, wherein the detecting comprises:
detecting a user input comprising a user's grip and detecting a user input comprising a user's touch, wherein a touch area is an area in which the user's touch is detected, and
determining that a single stretching manipulation is made, when the user's grip is detected at a single area of the display and a touch area due to the user's touch is moved.

13. The control method of claim 11, wherein the detecting comprises determining that an overall stretching manipulation is made, when a tension is detected at one of a plurality of strain gauges disposed adjacent to an edge area of the flexible apparatus.

14. The control method of claim 12, wherein the performing the operation comprises, when the single stretching manipulation is made, moving one or more objects displayed on the screen in a direction in which the single stretching manipulation is made, removing the one or more objects from a first side of the screen, adding one or more new objects to the screen from a second side of the screen, moving the one or more new objects screen in the direction in which the single stretching manipulation is made, and displaying the one or more new objects on the screen.

15. The control method of claim 11, wherein the detecting comprises:
detecting a user input comprising user's grip and detecting a user input comprising a user's touch, wherein a touch area is an area in which the user's touch is detected, and
determining that an overall stretching manipulation is made, when a first touch area and a second touch area are detected and move in opposite directions.

16. The control method of claim 11, wherein the detecting comprises determining that an overall stretching manipulation is made, when a tension is detected at at least two of a plurality of strain gauges disposed adjacent to an edge area of the flexible apparatus.

17. The control method of claim 15, wherein the performing comprises changing a mode of the screen when the overall stretching manipulation is made.

18. The control method of claim 15, wherein the performing comprises changing a display form of an object displayed on the screen when the overall stretching manipulation is made.

19. The control method of claim 15, wherein the performing comprises enlarging one or more objects displayed on the screen based on a preset ratio, when the overall stretching manipulation is made.

20. The control method of claim 15, wherein, when the overall stretching manipulation is made, the performing comprises dividing one or more objects displayed on the screen into a first half and a second half according to a direction of the overall stretching manipulation, gradually separating the first half from and the second half from each other, removing the first half and the second half off a first side of the screen and a second side of the screen, respectively, and displaying one or more new objects on an area formed between the first half and the second half.
